(19) United States
(12) Patent Application Publication
(10) Pub. No.: US 2011/0119371 A1
(43) Pub. Date: May 19, 2011

(54) DEVICE DATA MANAGEMENT SYSTEM

(76) Inventors: Yasufumi Toshima, Cupertino, CA (US); Kazuhiro Kawai, Tokyo (JP)

(21) Appl. No.: 12/673,236

(22) PCT Filed: Aug. 11, 2008
(86) PCT No.: PCT/JP2008/064433

§ 371 Date: Feb. 3, 2011

(30) Foreign Application Priority Data
Aug. 14, 2007 (JP) 2007-211267

(51) Int. Cl. G06F 15/16

(52) U.S. Cl. 709/224

(57) ABSTRACT

[Problems] To provide a device data management system which monitors connection with an external device other than user computers constituting a network.

[Means for Solving Problems] The system (10) includes: networks (16A-16D) formed by a plurality of user computers (11A-11C, 14A-14C) and device monitoring servers (15A-15D); data relay servers (17A, 17B) which receive various data associated with the computers (11A-11C, 14A-14C) from the servers (15A-15D); and a data management computer (18) which obtains various data from the servers (17A, 17B). The device monitoring servers (15A-15D) have transmission means used when an unregistered computer in which an operation data management application is not installed is connected to the networks (16A-16D), so as to transmit the unregistered computer connection data on the computer to the data relay servers (17A, 17B). The data management server (18) has output means which outputs the unregistered computer connection data obtained from the data relay servers (17A, 17B) to the respective networks (16A-16D).

### TECHNICAL FIELD

The present invention relates to a device data management system that acquires various kinds of data of each network constituting device forming a network and collectively manages the acquired data for each network.

### BACKGROUND ART

A network security system in which a network user detects an unauthorized intruder to a server via the Internet and notifies the Internet service provider of the intrusion and also traces the unauthorized intruder in cooperation with the service provider is known (see Patent Document 1). This system is formed from a monitoring terminal that detects unauthorized access using the Internet and makes a notification of such access and a center terminal that identifies an access source of the unauthorized access after receiving the notification from the monitoring terminal and notifies network users of information about the identified access source.

The monitoring terminal is connected to a computer system held by network users and the center terminal is connected to a computer system held by the Internet service provider. The monitoring terminal stores a log of access to a user-side server connected to the Internet, detects unauthorized access to the user-side server by analyzing the log, and notifies the center terminal of detection of unauthorized access together with the stored log. Based on information of the notified log, the center terminal identifies a server as an access source of the unauthorized access and notifies the monitoring terminal of the users of information about the server as the access source.
Patent Document 1: Japanese Patent Application Laid-Open No. 2005-128919

### DISCLOSURE OF THE INVENTION

According to the system disclosed by Patent Document 1, there is no need for a network user to identify a server as an access source of unauthorized access and user's time and effort is reduced correspondingly. However, if an external device other than network constituting devices forming a network is brought in from outside and the external device is connected to the network, this system has no means for detecting the connection and thus, the external device can be connected to the network without any restriction. Therefore, connection of an external device whose connection to the network is unqualified cannot be prevented and an act of storing various kinds of data in the network in an external device and running away with the external device cannot be prevented from occurring. Moreover, the system cannot grasp operation states of permitted operations and those of refused operations in network constituting devices and therefore, it is very difficult to prevent illegal acts such as falsification of data and data corruption by network users.

An object of the present invention is to provide a device data management system capable of monitoring for connection of an external device other than network constituting devices forming a network. Another object of the present invention is to provide a device data management system capable of monitoring operation states of permitted operations and refused operations of network constituting devices forming a network and preventing illegal acts by network users.

The present invention to solve the above problem is a device data management system having a plurality of networks formed from a plurality of network constituting devices and device monitoring apparatuses to monitor these network constituting devices in chronological order, a data relay apparatus that receives various kinds of data on each network constituting device from the device monitoring apparatuses, and a data management apparatus that acquires the various kinds of data from the data relay apparatus, wherein the network constituting device has an operation data management application that causes the network constituting device to send permitted operation data to the device monitoring apparatus when the network constituting device performs an operation permitted thereto and causes the network constituting device to send refused operation data to the device monitoring apparatus when the network constituting device attempts to perform a refused operation other than permitted operations installed thereon, the device monitoring apparatus includes an unregistered device detection means for detecting a connection of an unregistered device to the network when the unregistered device on which the operation data management application is not installed is connected to the network and an unregistered device connection data transmission means for transmitting unregistered device connection data acquired of the unregistered device to the data relay apparatus, and the data management apparatus includes an unregistered device connection data storage means for storing the unregistered device connection data acquired from the data relay apparatus by dividing the data for each network and an unregistered device connection data output means for outputting the unregistered device connection data by dividing the data for each network.

As an example of the present invention, the device monitoring apparatus includes a permitted operation data collection means for collecting the permitted operation data sent from the network constituting devices in the chronological order and a permitted operation data transmission means for sending the collected permitted operation data to the data relay apparatus and the data management apparatus includes a first permitted operation data storage means for storing the permitted operation data acquired from the data relay apparatus by dividing the data for each network and a first permitted operation data output means for outputting the permitted operation data by dividing the data for each network.

As another example of the present invention, the data management apparatus includes a second permitted operation data storage means for storing the permitted operation data acquired from the data relay apparatus by dividing the data for each network constituting device and a second permitted operation data output means for outputting the permitted operation data by dividing the data for each network constituting device.

As another example of the present invention, the device monitoring server includes a refused operation data collection means for collecting refused operation data sent from the network constituting devices in the chronological order and a refused operation data transmission means for sending the collected refused operation data to the data relay apparatus and the data management apparatus includes a first refused operation data storage means for storing the refused operation data acquired from the data relay apparatus by dividing the data for each network and a first refused operation data output means for outputting the refused operation data by dividing the data for each network.

As another example of the present invention, the data management apparatus includes a second refused operation data storage means for storing the refused operation data acquired from the data relay apparatus by dividing the data for each network constituting device and a second refused operation data output means for outputting the refused operation data by dividing the data for each network constituting device.

As another example of the present invention, the data management apparatus includes a specific device exclusion means for excluding a specific device from the unregistered devices and when the specific device excluded from the unregistered devices is connected to the network, the device monitoring apparatus does not detect the specific device as an unregistered device.

As another example of the present invention, the data management apparatus includes a first transmission interval change means for changing a transmission interval of the unregistered device connection data sent from the device monitoring apparatus to the data relay apparatus for each network.

As another example of the present invention, the data management apparatus includes a second transmission interval change means for changing the transmission interval of the permitted operation data and the refused operation data sent from the device monitoring apparatus to the data relay apparatus for each network.

As another example of the present invention, the data management apparatus includes a data transmission destination change means for changing a transmission destination of the unregistered device connection data, the permitted operation data, and the refused operation data sent from the device monitoring apparatus from one data relay apparatus to the other.

As another example of the present invention, the data management apparatus includes a storage capacity monitoring means for monitoring storage capacities of the data relay apparatuses in the chronological order and a storage capacity exceeded data output means for outputting storage capacity exceeded data notifying that the storage capacity of the data relay apparatus is exceeded when a permissible range of the storage capacity of the data relay apparatus is exceeded.

As another example of the present invention, the device data management system comprises a firewall set up between the network and the data management apparatus, wherein the data management apparatus includes a log data storage means for storing log data of the firewall sent from the firewall by dividing the data for each network and a log data output means for outputting the log data by dividing the data for each network.

As another example of the present invention, an operation permitted to the network constituting apparatus is permitted application usage in which the network constituting apparatus uses a permitted application whose use in the network constituting apparatus is permitted and the permitted operation data is usage history data of the permitted application in the network constituting apparatus.

As another example of the present invention, an operation permitted to the network constituting apparatus is external usage in which the network constituting apparatus is used in an external environment outside the network formed by the network constituting apparatuses and the permitted operation data is external usage history data when the network constituting apparatus is used in the external environment.

As another example of the present invention, an operation permitted to the network constituting apparatus is extra-specified time usage in which the network constituting apparatus is used outside specified times and the permitted operation data is extra-specified time usage history data when the network constituting apparatus is used outside the specified times.

As another example of the present invention, an operation permitted to the network constituting apparatus is e-mail transmission in which an e-mail is sent via the network constituting apparatus and the permitted operation data is e-mail transmission history data when an e-mail is sent from the network constituting apparatus.

As another example of the present invention, an operation permitted to the network constituting apparatus is Web site access in which a predetermined Web site is accessed via the network constituting apparatus and the permitted operation data is Web site access history data when the network constituting apparatus accesses the predetermined Web site.

As another example of the present invention, an operation permitted to the network constituting apparatus is external network access in which a predetermined external network is accessed via the network constituting apparatus and the permitted operation data is external network access history data when the network constituting apparatus accesses the predetermined external network.

As another example of the present invention, operations permitted to the network constituting apparatus are application installation in which the permitted application is installed on the network constituting apparatus and application uninstallation in which the permitted application is uninstalled from the network constituting apparatus and the permitted operation data is application installation data when the permitted application is installed on the network constituting apparatus and application uninstallation data when the permitted application is uninstalled from the network constituting apparatus.

As another example of the present invention, a refused operation to the network constituting apparatus is a data taking-out operation in which taking-out prohibited data is taken out from the network constituting apparatus and the refused operation data is taking-out act history data when an attempt is made to take out taking-out prohibited data from the network constituting apparatus.

As another example of the present invention, a refused operation to the network constituting apparatus is a data printing operation in which print prohibited data is printed from the network constituting apparatus and the refused operation data is printing act history data when an attempt is made to print the print prohibited data from the network constituting apparatus.

As another example of the present invention, a refused operation to the network constituting apparatus is a refused application access operation in which a refused application whose use is prohibited is accessed and the refused operation data is refused application access history data when the network constituting apparatus accesses the refused application.

As another example of the present invention, the data management apparatus includes a permitted application alteration means for adding, changing, or deleting the permitted application and a refused application alteration means for adding, changing, or deleting the refused application.

According to a device data management system according to the present invention, if an unregistered device on which no operation data management application is installed is connected to a network, unregistered device connection data thereof is sent from a device monitoring apparatus to a data relay apparatus and a data management apparatus manages the unregistered device connection data acquired from the data relay apparatus by dividing the data for each network and therefore, connection of unregistered devices to the networks can be grasped and monitored collectively for each network. Even if an unregistered device other than network constituting devices forming a network is brought in and connected to the network, the device data management system can detect such a connection for each network so that unrestricted connection of unregistered devices to a network can collectively be controlled for each network. The device data management system can prevent connection to a network of an unregistered device whose connection is unqualified from network to network and also prevent an illegal taking-out act in which various kinds of data in a network is taken out of the network by storing data in an unregistered device before such an act occurs.

In a device data management system that manages permitted operation data of network constituting devices forming each network by dividing the data for each network, the system administrator can grasp and monitor operation states of permitted operations of network constituting devices via a data management apparatus for each network by the permitted operation data of network constituting devices forming each network being managed collectively in a unified fashion by the data management apparatus for each network. If, for example, a plurality of network constituting devices forms a network for each branch office, a head office control department can grasp and monitor operation states of permitted operations of network constituting devices from branch office to branch office by permitted operation data of network constituting devices in each branch office being acquired by a data management apparatus installed in the head office control department so that the head office control department can reliably manage permitted operations in each branch office.

In a device data management system that manages permitted operation data of network constituting devices forming each network by dividing the data for each network constituting device, the system administrator can grasp and monitor operation states of permitted operations of network constituting devices via a data management apparatus for each network constituting device by the permitted operation data of network constituting devices forming each network being managed collectively in a unified fashion by the data management apparatus for each network constituting device. If, for example, a plurality of network constituting devices forms a network for each branch office, a head office control department can grasp and monitor operation states of permitted operations of network constituting devices from network constituting device to network constituting device by permitted operation data of each network constituting device being acquired by a data management apparatus installed in the head office control department so that the head office control department can reliably manage permitted operations of each network constituting device.

In a device data management system that manages refused operation data of network constituting devices forming each network by dividing the data for each network, the system administrator can grasp and monitor operation states of permitted operations of network constituting devices via a data management apparatus for each network and control refused operations from network to network by the refused operation data of network constituting devices forming each network being managed collectively in a unified fashion by the data management apparatus for each network. If, for example, a plurality of network constituting devices forms a network for each branch office, a head office control department can grasp and monitor operation states of refused operations of network constituting devices from branch office to branch office by refused operation data of network constituting devices in each branch office being acquired by a data management apparatus installed in the head office control department so that the head office control department can reliably manage refused operations in each branch office.

In a device data management system that manages refused operation data of network constituting devices forming each network by dividing the data for each network constituting device, the system administrator can grasp and monitor operation states of refused operations of network constituting devices via a data management apparatus for each network constituting device by the refused operation data of network constituting devices forming each network being managed collectively in a unified fashion by the data management apparatus for each network constituting device. If, for example, a plurality of network constituting devices forms a network for each branch office, a head office control department can grasp and monitor operation states of refused operations of network constituting devices from network constituting device to network constituting device by refused operation data of each network constituting device being acquired by a data management apparatus installed in the head office control department so that the head office control department can reliably manage refused operations of each network constituting device.

A device data management system capable of excluding, among unregistered devices, a specific device from the unregistered devices can permit, when it becomes necessary to allow a specific device among unregistered devices on which an operation data transmission application is not installed to connect to a network, the specific device to connect to the network via a data management apparatus so that necessity of connection of the specific computer to the network can be handled easily and swiftly. If a specific device necessary to connect to a network is detected as an unregistered device, it becomes necessary to distinguish the specific computer from the unregistered computer, the device data management system does not detect the specific device as an unregistered device and therefore, inconvenience of distinguishing the specific computer from the unregistered computer can be avoided.

A device data management system capable of changing a transmission interval of unregistered device connection data sent from a device monitoring apparatus to a data relay apparatus for each network can freely set and change the transmission interval of unregistered device connection data by the device monitoring apparatus via a data management apparatus for each network and therefore, the transmission interval can be set differently for each network in accordance with network configuration conditions such as the device configuration and the number of devices in each network so that the optimal transmission interval can be set for each network.

A device data management system capable of changing the transmission interval of permitted operation data and refused operation data sent from a device monitoring apparatus to a data relay apparatus for each network can freely set and change the transmission interval of permitted operation data and refused operation data by the device monitoring apparatus via a data management apparatus for each network and therefore, the transmission interval can be set differently for each network in accordance with network configuration conditions such as the device configuration and the number of devices in each network so that the optimal transmission interval can be set for each network.

A device data management system capable of changing a transmission destination of unregistered device connection data, permitted operation data, and refused operation data sent from a device monitoring apparatus from one data relay apparatus to the other can freely select a proper data relay apparatus in accordance with network configuration conditions such as the storage capacity of each data relay apparatus and the device configuration and the number of devices of each network taken charge of by the data relay apparatus so that the storage capacity of the data relay server can be prevented from being exceeded and rejection of acceptance of data by the data relay server caused by the storage capacity thereof being exceeded can be prevented.

A device data management system in which a data management apparatus manages the storage capacity of a data relay apparatus in chronological order can prevent the storage capacity of the data relay server from being exceeded via the data management apparatus so that rejection of acceptance of each piece of data by the data relay server caused by the storage capacity thereof being exceeded can be prevented.

A device data management system that manages log data of a firewall by dividing the data for each network can grasp and monitor distribution of inappropriate data in the system for each network by managing the log data of inappropriate data sent from each network constituting device for each network so that diffusion of inappropriate data in the system can be controlled. If, for example, a plurality of network constituting devices forms a network for each branch office, a head office control department can grasp and monitor inappropriate data sent from each network constituting device from branch office to branch office by sending log data of inappropriate data sent from these network constituting devices from the firewall to a data management apparatus established in a head office control department so that the head office control department can control diffusion of inappropriate data sent from each branch office.

In a device data management system whose permitted operation data is usage history data of permitted applications by network constituting devices, the system administrator can grasp and monitor usage states of applications in each network or by each network constituting device via a data management apparatus by the usage history data of permitted applications by network constituting devices being managed collectively in a unified fashion by the data management apparatus for each network or each network constituting device so that unrestricted use of permitted applications by network constituting devices can be controlled.

In a device data management system whose permitted operation data is external usage history data when a network constituting device is used in an external environment, the system administrator can grasp and monitor external usage states of network constituting devices in each network or each network constituting device via a data management apparatus by the external usage history data of network constituting devices being managed collectively in a unified fashion by the data management apparatus for each network or each network constituting device so that illegal acts such as taking-out of important data or confidential data without permission, falsification thereof and, corruption thereof by network users can be controlled. The system administrator can correctly grasp distribution routes and outflow routes of various kinds of data and inflow routes of various kinds of data by using the external usage history data and therefore, the device data management system can control illegal acts by network users so that a secure network can reliably be constructed.

In a device data management system whose permitted operation data is extra-specified time usage history data when a network constituting device is used outside specified times, the system administrator can grasp and monitor extra-specified time usage states of network constituting devices in each network or each network constituting device via a data management apparatus by the extra-specified time usage history data of network constituting devices being managed collectively in a unified fashion by the data management apparatus for each network or each network constituting device so that illegal acts such as taking-out of important data or confidential data without permission, falsification thereof and, corruption thereof by network users can be controlled. The system administrator can correctly grasp distribution routes and outflow routes of various kinds of data and inflow routes of various kinds of data by using the extra-specified time usage history data and therefore, the device data management system can control illegal acts by network users so that a secure network can reliably be constructed.

In a device data management system whose permitted operation data is e-mail transmission history data when an e-mail is transmitted from a network constituting device, the system administrator can grasp and monitor e-mail transmission states of network constituting devices in each network or each network constituting device via a data management apparatus by the e-mail transmission history data of network constituting devices being managed collectively in a unified fashion by the data management apparatus for each network or each network constituting device so that transmission without permission or illegal transmission of important data and confidential data by network users can be controlled. The system administrator can correctly grasp transmission without permission or illegal transmission of various kinds of data by using the e-mail transmission history data and therefore, the device data management system can control illegal acts by network users so that a secure network can reliably be constructed.

In a device data management system whose permitted operation data is Web site access history data when a network constituting device accesses a predetermined Web site, the system administrator can grasp and monitor Web site access states of network constituting devices in each network or each network constituting device via a data management apparatus by the Web site access history data of network constituting devices being managed collectively in a unified fashion by the data management apparatus for each network or each network constituting device so that access acts to inappropriate Web sites by network users can be controlled. The system administrator can correctly grasp access acts to inappropriate Web sites by using the Web site access history data and therefore, the device data management system can control illegal acts by network users so that a secure network can reliably be constructed.

In a device data management system whose permitted operation data is external network access history data when a network constituting device accesses a predetermined external network, the system administrator can grasp and monitor external network access states of network constituting devices in each network or each network constituting device via a data management apparatus by the external network access history data of network constituting devices being managed collectively in a unified fashion by the data management apparatus for each network or each network constituting device so that inappropriate external network access acts by network users can be controlled. The system administrator can correctly grasp inappropriate external network access acts by using the external network access history data and therefore, the device data management system can control illegal acts by network users so that a secure network can reliably be constructed.

In a device data management system whose permitted operation data is installation data when a permitted application is installed on a constituting device or uninstallation data when a permitted application is uninstalled from a constituting device, the system administrator can grasp and monitor installation states or uninstallation states of applications in each network or each network constituting device via a data management apparatus by the installation data or uninstallation data of applications on network constituting devices being managed collectively in a unified fashion by the data management apparatus for each network or each network constituting device so that installation acts of unnecessary applications for network constituting devices can be controlled and also unauthorized uninstallation of applications from network constituting devices can be controlled.

In a device data management system whose refused operation data is taking-out act history data when an attempt is made to take out taking-out prohibited data from a network constituting device, the system administrator can grasp and monitor taking-out acts of taking-out prohibited data in each network or each network constituting device via a data management apparatus by the taking-out act history data of network constituting devices being managed collectively in a unified fashion by the data management apparatus for each network or each network constituting device so that taking-out acts of taking-out prohibited data by network users can be controlled. The system administrator can correctly grasp taking-out acts of taking-out prohibited data by using the taking-out act history data and therefore, the device data management system can control illegal acts by network users so that secure network can reliably be constructed.

In a device data management system whose refused operation data is printing act history data when an attempt is made to print printing prohibited data from a network constituting device, the system administrator can grasp and monitor printing acts of printing prohibited data in each network or each network constituting device via a data management apparatus by the printing act history data of network constituting devices being managed collectively in a unified fashion by the data management apparatus for each network or each network constituting device so that printing acts of printing prohibited data by network users can be controlled. The system administrator can correctly grasp printing acts of printing prohibited data by using the printing act history data and therefore, the device data management system can control illegal acts by network users so that a secure network can reliably be constructed.

In a device data management system whose refused operation data is refused application access history data when a network constituting device accesses a refused application, the system administrator can grasp and monitor access acts to refused applications in each network or each network constituting device via a data management apparatus by the refused application access history data of network constituting devices being managed collectively in a unified fashion by the data management apparatus for each network or each network constituting device so that access acts to refused applications by network users can be controlled. The system administrator can correctly grasp access acts to refused applications by using the refused application access history data and therefore, the device data management system can control illegal acts by network users so that a secure network can reliably be constructed.

In a device data management system capable of altering a permitted application and also a refused application, permitted applications can freely be altered when necessary and therefore, an application newly permitted to use can be added to allow network constituting devices to use the application and an application refused to use can be changed from a permitted application to a refused application to prohibit network constituting devices from using the application. Further, permitted applications can be tidied up by deleting unnecessary applications from permitted applications. The device data management system can freely alter refused applications when necessary and therefore, an application that will not be used for the foreseeable future may be added as a refused application so that when it becomes necessary to use the application, the application is changed from a refused application to a permitted application to permit network constituting devices to use the application. Further, refused applications can be tidied up by deleting unnecessary applications from refused applications.

### BRIEF DESCRIPTION OF THE DRAWINGS

FIG. 1 is a block diagram of a device data management system shown as an example thereof.

FIG. 2 is a diagram of networks in which an unregistered computer and a specific computer are connected.

FIG. 3 is a diagram exemplifying a display screen of an authentication procedure displayed in a display of a device monitoring server or data management computer.

FIG. 4 is a diagram exemplifying user computer facility information.

FIG. 5 is a diagram exemplifying a list of applications.

FIG. 6 is a diagram exemplifying network connection data of the unregistered computer.

FIG. 7 is a diagram exemplifying the network connection data of the unregistered computer.

FIG. 8 is a diagram exemplifying an unregistered computer exclusion setting screen.

FIG. 9 is a diagram exemplifying a change screen of unregistered computer connection data transmission interval settings.

FIG. 10 is a diagram exemplifying a transmission interval setting change screen of various kinds of operation data.

FIG. 11 is a diagram exemplifying a transmission destination change screen of various kinds of data.

FIG. 12 is a diagram exemplifying data relay server facility information.

FIG. 13 is a diagram exemplifying log data of a firewall.

FIG. 14 is a diagram exemplifying usage history data of applications.

FIG. 15 is a diagram exemplifying the usage history data of applications.

FIG. 16 is a diagram exemplifying access history data.

FIG. 17 is a diagram exemplifying the access history data.

FIG. 18 is a diagram exemplifying a setting screen of adding, changing, or deleting applications.

FIG. 19 is a diagram exemplifying the setting screen of adding, changing, or deleting refused applications.

FIG. 20 is a diagram exemplifying application installation states.

FIG. 21 is a diagram showing content of installed applications.

FIG. 22 is a diagram exemplifying application uninstallation states.

FIG. 23 is a diagram showing content of uninstalled applications.

FIG. 24 is a diagram exemplifying printing history data.

FIG. 25 is a diagram exemplifying the printing history data.

FIG. 26 is a diagram exemplifying file access history data.

FIG. 27 is a diagram exemplifying the file access history data.

FIG. 28 is a diagram exemplifying external usage history data.

FIG. 29 is a diagram exemplifying the external usage history data.

FIG. 30 is a diagram exemplifying extra-specified time usage history data.

FIG. 31 is a diagram exemplifying the extra-specified time usage history data.

FIG. 32 is a diagram exemplifying taking-out act data.

FIG. 33 is a diagram exemplifying the taking-out act data.

FIG. 34 is a diagram exemplifying printing act data.

FIG. 35 is a diagram exemplifying the printing act data.

FIG. 36 is a diagram exemplifying e-mail transmission data.

FIG. 37 is a diagram exemplifying the e-mail transmission data.

FIG. 38 is a diagram exemplifying web site access data.

FIG. 39 is a diagram exemplifying the web site access data.

FIG. 40 is a diagram exemplifying external network access data.

FIG. 41 is a diagram exemplifying the external network access data.

### EXPLANATIONS OF LETTERS OR NUMERALS

10 Device data management system
11A-C User computer (network constituting device)
12A-C User computer (network constituting device)
13A-C User computer (network constituting device)
14A-C User computer (network constituting device)
15A-D Device monitoring server (device monitoring apparatus)
16A-D Network
17A, B Data relay server
18 Data management computer (data management apparatus)
19 Firewall
20 Internet
21 Unregistered computer (unregistered device)
22 Specific computer (specific device)
23 Display

### BEST MODE FOR CARRYING OUT THE INVENTION

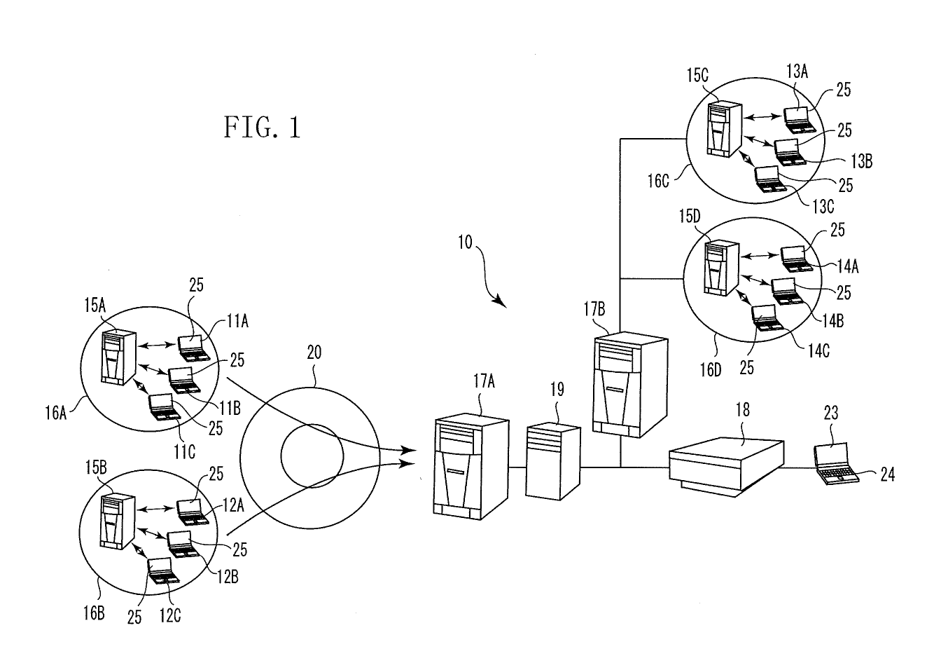

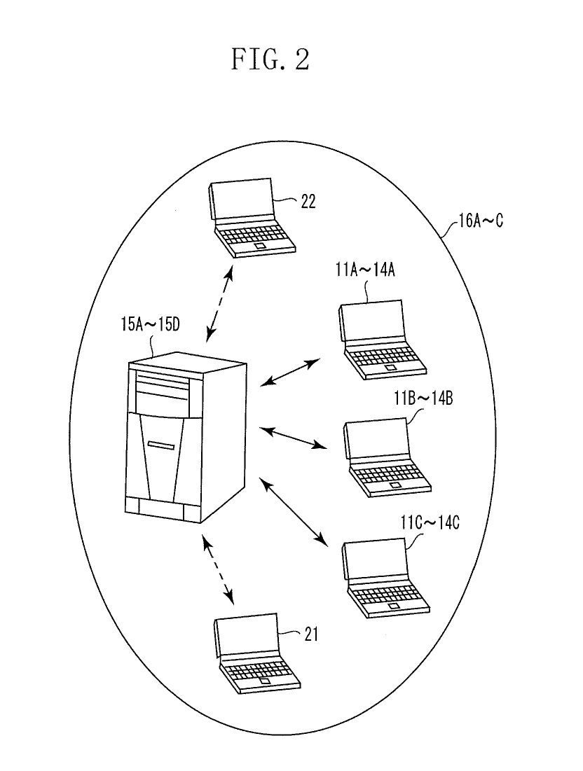

A detailed description of a device data management system according to the present invention with reference to attached drawings will be as follows: FIG. 1 is a block diagram of a device data management system 10 shown as an example thereof FIG. 2 is a diagram of networks 16A to 16D in which an unregistered computer 21 (unregistered device) and a specific computer 22 (specific device) are connected (logged in). In FIG. 2, connection of the unregistered computer 21 to the networks 16A to 16D is indicated by a chain double-dashed line and connection of the specific computer 22 to the networks 16A to 16D is indicated by a dashed line.

The device data management system 10 is composed of a plurality of the networks 16A to 16D formed from a plurality of user computers 11A to 11C, 12A to 12C, 13A to 13C, and 14A to 14C (network constituting devices) managed and stored by each user and device monitoring servers 15A to 15D (device monitoring apparatuses) to monitor the user computers 11A to 11C, 12A to 12C, 13A to 13C, and 14A to 14C in chronological order, data relay servers 17A/17B (data relay apparatuses) that temporarily hold various kinds of data transmitted from each of the device monitoring servers 15A to 15D forming each of the networks 16A to 16D, and a data management computer 18 (data management apparatus) that acquires various kinds of data stored in the data relay servers 17A/17B therefrom. A firewall 19 is installed between the data relay servers 17A/17B and the data management computer 18.

The servers 15A and 15B of the device monitoring servers 15A to 15D are connected to the data relay servers 17A/17B via an Internet 20. The servers 15C and 15D of the device monitoring servers 15A to 15D are connected to the data relay servers 17A/17B via an interface (by wire or by radio). As shown in FIG. 2, the unregistered computer 21 is connected (logged in) to each of the networks 16A to 16D and the specific computer 22 excluded from the unregistered computer 21 may be connected (logged in). The four networks 16A to 16D are illustrated in FIG. 1, but the number of networks is not specifically limited. Moreover, the three user computers 11A to 11C, 12A to 12C, 13A to 13C, and 14A to 14C are illustrated in FIG. 1 for each of the networks 16A to 16D respectively, but the number of user computers is not specifically limited and one firewall 19 is illustrated in FIG. 1, but the number of firewalls is not specifically limited. One unregistered computer 21 and one specific computer 22 are illustrated in FIG. 2, but the number of these computers is not specifically limited.

Though not illustrated, a group of servers such as a DNS server to set an association between a host name and an IP address to be assigned to the host name, a Web server necessary to release a homepage, a database server to provide a function that receives requests from other user computers or other servers and reads/writes carious kinds of data, a mail server for transmitting/receiving e-mails, and a document server to enable a search of data by storing all data of created sentences, images and the like is connected to the networks 16A to 16D. The system 10 can support all existing network connection methods such as a bus-type network, star-type network, peer-to-peer network, and ring-type network.

The user computers 11A to 11C, 12A to 12C, 13A to 13C, and 14A to 14C each have a central processing unit and a memory and have a large-capacity hard disk mounted thereon. Though not illustrated, printers, scanners, external hard disks are connected to these computers 11A to 11C, 12A to 12C, 13A to 13C, and 14A to 14C via an interface. An existing removable disk such as Memory Stick, IC recorder, PDA, and mobile phone can removably be connected to the computers 11A to 11C, 12A to 12C, 13A to 13C, and 14A to 14C so that various kinds of data can be exchanged between the computers 11A to 11C, 12A to 12C, 13A to 13C, and 14A to 14C and the removable disk. Each of the user computers 11A to 11C, 12A to 12C, 13A to 13C, and 14A to 14C has a transmitting/receiving function of e-mails. Each of the user computers 11A to 11C, 12A to 12C, 13A to 13C, and 14A to 14C can access a predetermined Web site to log in to the site and access a predetermined external network to log in to the network.

The user computers 11A to 11C, 12A to 12C, 13A to 13C, and 14A to 14C have an operation data management application (agent application) that causes the computers 11A to 11C, 12A to 12C, 13A to 13C, and 14A to 14C to transmit data on a permitted operation when the computers 11A to 11C, 12A to 12C, 13A to 13C, and 14A to 14C perform the operation permitted thereto to the device monitoring servers 15A to 15D and causes the computers 11A to 11C, 12A to 12C, 13A to 13C, and 14A to 14C to transmit data on a refused operation when the computers 11A to 11C, 12A to 12C, 13A to 13C, and 14A to 14C attempt to perform a refused operation other than permitted operation to the device monitoring servers 15A to 15D installed thereon. The operation data management application is installed not only on the computers 11A to 11C, 12A to 12C, 13A to 13C, and 14A to 14C, but also on the device monitoring servers 15A to 15D to cause the device monitoring servers 15A to 15D to execute each means described later. Incidentally, the operation data management application is installed on neither the unregistered computer 21 nor the specific computer 22.

The device monitoring servers 15A to 15D are computers having a central processing unit and a memory and have a large-capacity hard disk mounted thereon. Though not illustrated, displays, keyboards, printers, scanners, and external hard disks are connected to the device monitoring servers 15A to 15D via an interface. The device monitoring servers 15A to 15D monitor for connection of the unregistered computer 21 or the specific computer 22 to the networks 16A to 16D endlessly in chronological order and also monitor usage states and operation states of the user computers 11A to 11C, 12A to 12C, 13A to 13C, and 14A to 14C logged in to each of the networks 16A to 16D endlessly in chronological order. Further, the device monitoring servers 15A to 15D manage applications to be installed on the user computers 11A to 11C, 12A to 12C, 13A to 13C, and 14A to 14C, applications to be uninstalled from the user computers 11A to 11C, 12A to 12C, 13A to 13C, and 14A to 14C, operating times of the user computers 11A to 11C, 12A to 12C, 13A to 13C, and 14A to 14C, data printing on the user computers 11A to 11C, 12A to 12C, 13A to 13C, and 14A to 14C, and file access on the user computers 11A to 11C, 12A to 12C, 13A to 13C, and 14A to 14C. The device monitoring servers 15A to 15D fetch various commands transmitted from the data management computer 18 at predetermined intervals from the data relay servers 17A/17B and follow the acquired commands. The device monitoring servers 15A to 15D activate a device data management application stored in an instruction file of the memory based on control by the operating system and execute each means according to the activated application.

(Network Configuration Monitoring)

The device monitoring servers 15A to 15D monitor the network configuration of the networks 16A to 16D endlessly in chronological order. Various kinds of data of the network configuration include hardware data forming each of the networks 16A to 16D, network topology data of hardware, hardware data of the user computers 11A to 11C, 12A to 12C, 13A to 13C, and 14A to 14C, and application data installed on the user computers 11A to 11C, 12A to 12C, 13A to 13C, and 14A to 14C. The device monitoring servers 15A to 15D store the above network configuration data together with dates/times of data confirmation (means for collecting network configuration data). If hardware, a network topology, an application or the like is changed, the device monitoring servers 15A to 15D rewrite network configuration data stored in a hard disk and store the latest data after the change and the rewrite date/time in the hard disk. However, the network configuration data before being rewritten is not deleted and remains stored in the hard disk of the device monitoring servers 15A to 15D.

The device monitoring servers 15A to 15D attach network identification data (such as the network name, network identification number and the like) to identify network configuration data by dividing the data for each of the networks 16A to 16D to the network configuration data and also attach user computer identification data (such as the computer name, workgroup/domain, MAC address, IP address, and user computer identification number) to identify each of the user computers 11A to 11C, 12A to 12C, 13A to 13C, and 14A to 14C to the network configuration data. The device monitoring servers 15A to 15D encrypt network data, network identification data, user computer identification data, and date/time of data confirmation (means for encrypting network configuration data) and periodically send the encrypted network configuration data, network identification data, user computer identification data, and date/time of data confirmation to the data relay server (means for sending network configuration data).

(Unregistered Computer Detection)

The device monitoring servers 15A to 15D monitor for connection of the unregistered computer 21 to the networks 16A to 16D endlessly in chronological order. As shown by the chain double-dashed line in FIG. 2, when the unregistered computer 21 on which no operation data management application is installed is connected to the networks 16A to 16D, the device monitoring servers 15A to 15D detect the connection of the unregistered computer 21 to the networks 16A to 16D (means for detecting an unregistered device) and also collect unregistered computer connection data of the unregistered computer 21 in chronological order and stores the collected unregistered computer connection data in a hard disk (means for collecting unregistered device connection data). The device monitoring servers 15A to 15D attach network identification data to identify the unregistered computer connection data by dividing the data for each of the networks 16A to 16D to the unregistered computer connection data, encrypt the unregistered computer connection data and network identification data (means for encrypting unregistered device connection data), and periodically send the encrypted unregistered computer connection data and network identification data to the relay server (means for sending unregistered device connection data).

The device monitoring servers 15A to 15D have user computer identification data (such as the computer name, workgroup/domain, MAC address, IP address, and user computer identification number) of the user computers 11A to 11C, 12A to 12C, 13A to 13C, and 14A to 14C and specific computer identification data (such as the computer name, workgroup/domain, MAC address, IP address, and user computer identification number) stored in the memory thereof in advance. If a new computer is connected to the networks 16A to 16D, the device monitoring servers 15A to 15D detect computer identification data (such as the computer name, workgroup/domain, MAC address, IP address, and user computer identification number) of the connected computer and compare the detected computer identification data with user computer identification data stored in the memory. If, as a result of comparison of the data, the detected computer identification data and the user computer identification data stored in the memory match, the device monitoring servers 15A to 15D judge that the connected computer is, instead of an unregistered computer, one of the user computers 11A to 11C, 12A to 12C, 13A to 13C, and 14A to 14C and allows the computer to log in to the networks 16A to 16D. Conversely, if, as a result of comparison of the data, the detected computer identification data and the user computer identification data stored in the memory do not match, the device monitoring servers 15A to 15D judge that the connected computer is the unregistered computer 21 and store unregistered computer connection data in a hard disk and also send the encrypted unregistered computer connection data to the data relay servers 17A/17B.

As shown by the dashed line in FIG. 2, when the specific computer 22 is connected to the networks 16A to 16D, the device monitoring servers 15A to 15D detect specific computer identification data (such as the computer name, workgroup/domain, MAC address, IP address, and user computer identification number) of the connected specific computer 22 and compares the detected specific computer identification data with specific computer identification data (such as the computer name, workgroup/domain, MAC address, IP address, and user computer identification number) stored in the memory. If, as a result of comparison of the data, the detected specific computer identification data and the specific computer identification data stored in the memory match, the device monitoring servers 15A to 15D judge that the connected computer is the specific computer 22 and do not detect the computer as an unregistered computer.

(Usage History Monitoring)

The device monitoring servers 15A to 15D monitor application usage states of the user computers 11A to 11C, 12A to 12C, 13A to 13C, and 14A to 14C logged in to the networks 16A to 16D endlessly in chronological order. When each of the user computers 11A to 11C, 12A to 12C, 13A to 13C, and 14A to 14C uses an application, the device monitoring servers 15A to 15D collect usage history data of the application from the user computers 11A to 11C, 12A to 12C, 13A to 13C, and 14A to 14C and store the collected usage history data (means for collecting usage history data (means for collecting permitted operation data)). If the user computers 11A to 11C, 12A to 12C, 13A to 13C, and 14A to 14C activate an application installed thereon and use the application, usage history data of the application is sent (output) from the user computers 11A to 11C, 12A to 12C, 13A to 13C, and 14A to 14C to the device monitoring servers 15A to 15D and the usage history data is stored in the hard disk of the device monitoring servers 15A to 15D in chronological order.

The device monitoring servers 15A to 15D attach network identification data to identify usage history data received from the user computers 11A to 11C, 12A to 12C, 13A to 130, and 14A to 14C by dividing the data for each of the networks 16A to 16D to the usage history data and also attach user computer identification data to identify the usage history data by dividing the data for each of the user computers 11A to 11C, 12A to 12C, 13A to 13C, and 14A to 14C to the usage history data. The device monitoring servers 15A to 15D encrypt the usage history data, network identification data, and user computer identification data (means for encrypting usage history data) and periodically send the encrypted usage history data, network identification data, and user computer identification data to the data relay servers 17A/17B (means for sending usage history data (means for sending permitted operation data)).

(Access History Monitoring)

The device monitoring servers 15A to 15D monitor access states to refused applications of the user computers 11A to 11C, 12A to 12C, 13A to 13C, and 14A to 14C logged in to the networks 16A to 16D endlessly in chronological order. If a refused application is installed on the user computers 11A to 11C, 12A to 12C, 13A to 13C, and 14A to 14C, the device monitoring servers 15A to 15D collect access history data to the refused application from the pertinent computer and store the collected access history data (means for collecting access history data (means for collecting refused operation data)). When the user computers 11A to 11C, 12A to 12C, 13A to 13C, and 14A to 14C start installation of a predetermined application, application identification data (such as the application name and application identification number) that identifies the application is output from the computer to the device monitoring servers 15A to 15D. The device monitoring servers 15A to 15D compare the application identification data output from the user computers 11A to 11C, 12A to 12C, 13A to 13C, and 14A to 14C with permitted application identification data (such as the application name and permitted application identification number) and refused application identification data (such as the application name and refused application identification number) stored in the memory. If the application identification data is refused application identification data (installation not allowed), the device monitoring servers 15A to 15D output a refusal of installation of the application to the user computers 11A to 11C, 12A to 12C, 13A to 13C, and 14A to 14C. When the user computers 11A to 11C, 12A to 12C, 13A to 13C, and 14A to 14C receives the refusal of installation, access history data thereof is sent (output) from the user computers 11A to 11C, 12A to 12C, 13A to 13C, and 14A to 14C to the device monitoring servers 15A to 15D and the access history data is stored in the hard disk of the device monitoring servers 15A to 15D in chronological order.

The device monitoring servers 15A to 15D attach network identification data to identify access history data received from the user computers 11A to 11C, 12A to 12C, 13A to 13C, and 14A to 14C by dividing the data for each of the networks 16A to 16D to the access history data and also attach user computer identification data to identify the access history data by dividing the data for each of the user computers 11A to 11C, 12A to 12C, 13A to 13C, and 14A to 14C to the access history data. The device monitoring servers 15A to 15D encrypt the access history data, network identification data, and user computer identification data (means for encrypting access history data) and periodically send the encrypted access history data, network identification data, and user computer identification data to the data relay servers 17A/17B (means for sending access history data (means for sending refused operation data)).

(Installation Monitoring)

The device monitoring servers 15A to 15D monitor installation states of applications of the user computers 11A to 11C, 12A to 12C, 13A to 13C, and 14A to 14C logged in to the networks 16A to 16D endlessly in chronological order. If a permitted application is installed on the user computers 11A to 11C, 12A to 12C, 13A to 13C, and 14A to 14C, the device monitoring servers 15A to 15D collect installation data of the application from the pertinent computer and store the collected installation data (means for collecting installation data (means for permitted operation data)). The device monitoring servers 15A to 15D compare the application identification data sent (output) from the user computers 11A to 11C, 12A to 12C, 13A to 13C, and 14A to 14C with permitted application identification data and refused application identification data stored in the hard disk. If the application identification data is permitted application identification data (installation allowed), the device monitoring servers 15A to 15D install the application on the user computers 11A to 11C, 12A to 12C, 13A to 13C, and 14A to 14C. When installation of the application is complete, installation data thereof is sent (output) from the user computers 11A to 11C, 12A to 12C, 13A to 13C, and 14A to 14C to the device monitoring servers 15A to 15D and the installation data is stored in the hard disk of the device monitoring servers 15A to 15D in chronological order.

The device monitoring servers 15A to 15D attach network identification data to identify installation data received from the user computers 11A to 11C, 12A to 12C, 13A to 13C, and 14A to 14C by dividing the data for each of the networks 16A to 16D to the installation data and also attach user computer identification data to identify the installation data by dividing the data for each of the user computers 11A to 11C, 12A to 12C, 13A to 13C, and 14A to 14C to the installation data. The device monitoring servers 15A to 15D encrypt the installation data, network identification data, and user computer identification data (means for encrypting installation data) and periodically send the encrypted installation data, network identification data, and user computer identification data to the data relay servers 17A/17B (means for sending installation data (means for sending permitted operation data)).

(Uninstallation Monitoring)

The device monitoring servers 15A to 15D monitor uninstallation of applications from the user computers 11A to 11C, 12A to 12C, 13A to 13C, and 14A to 14C logged in to the networks 16A to 16D endlessly in chronological order. If an application is uninstalled from the user computers 11A to 11C, 12A to 12C, 13A to 13C, and 14A to 14C, the device monitoring servers 15A to 15D collect uninstallation data of the application from the pertinent computer and store the collected uninstallation data (means for collecting uninstallation data (means for permitted operation data)). When the user computers 11A to 11C, 12A to 12C, 13A to 13C, and 14A to 14C start uninstallation of a predetermined application, application identification data (such as the application name and application identification number) that identifies the application is sent (output) from the computer to the device monitoring servers 15A to 15D. The device monitoring servers 15A to 15D compare the application identification data output from the user computers 11A to 11C, 12A to 12C, 13A to 13C, and 14A to 14C with uninstallation permitted application identification data (such as the application name and permitted application identification number) and uninstallation refused application identification data (such as the application name and refused application identification number) stored in the hard disk. If the application identification data is uninstallation permitted application identification data (uninstallation allowed), the device monitoring servers 15A to 15D uninstall the application from the user computers 11A to 11C, 12A to 12C, 13A to 13C, and 14A to 14C. When uninstallation of the application is complete, uninstallation data thereof is sent (output) from the user computers 11A to 11C, 12A to 12C, 13A to 13C, and 14A to 14C to the device monitoring servers 15A to 15D and the uninstallation data is stored in the hard disk of the device monitoring servers 15A to 15D in chronological order.

If the application identification data is uninstallation refused application identification data (uninstallation refused), the device monitoring servers 15A to 15D output a refusal of uninstallation of the application to the user computers 11A to 11C, 12A to 12C, 13A to 13C, and 14A to 14C. When the user computers 11A to 11C, 12A to 12C, 13A to 13C, and 14A to 14C receive the refusal of uninstallation, uninstallation data thereof is sent (output) from the user computers 11A to 11C, 12A to 12C, 13A to 13C, and 14A to 14C to the device monitoring servers 15A to 15D and the uninstallation data is stored in the hard disk of the device monitoring servers 15A to 15D in chronological order. The device monitoring servers 15A to 15D attach network identification data to identify uninstallation data received from the user computers 11A to 11C, 12A to 12C, 13A to 13C, and 14A to 14C by dividing the data for each of the networks 16A to 16D to the uninstallation data and also attach user computer identification data to identify the uninstallation data by dividing the data for each of the user computers 11A to 11C, 12A to 12C, 13A to 13C, and 14A to 14C to the uninstallation data. The device monitoring servers 15A to 15D encrypt the uninstallation data, network identification data, and user computer identification data (means for encrypting uninstallation data) and periodically send the encrypted uninstallation data, network identification data, and user computer identification data to the data relay servers 17A/17B (means for sending uninstallation data (means for sending permitted operation data)).

(Printing History Monitoring)

The device monitoring servers 15A to 15D monitor printing states of the user computers 11A to 11C, 12A to 12C, 13A to 13C, and 14A to 14C logged in to the networks 16A to 16D endlessly in chronological order. If data from the user computers 11A to 11C, 12A to 12C, 13A to 13C, and 14A to 14C is printed, the device monitoring servers 15A to 15D collect printing history data from the pertinent computer and store the collected printing history data (means for collecting printing history data (means for collecting permitted operation data)). When the user computers 11A to 11C, 12A to 12C, 13A to 13C, and 14A to 14C print predetermined data by a printer connected thereto, printing history data thereof is sent (output) from the user computers 11A to 11C, 12A to 12C, 13A to 13C, and 14A to 14C to the device monitoring servers 15A to 15D and the printing history data is stored in the hard disk of the device monitoring servers 15A to 15D in chronological order.

The device monitoring servers 15A to 15D attach network identification data to identify printing history data received from the user computers 11A to 11C, 12A to 12C, 13A to 13C, and 14A to 14C by dividing the data for each of the networks 16A to 16D to the printing history data and also attach user computer identification data to identify the printing history data by dividing the data for each of the user computers 11A to 11C, 12A to 12C, 13A to 13C, and 14A to 14C to the printing history data. The device monitoring servers 15A to 15D encrypt the printing history data, network identification data, and user computer identification data (means for encrypting printing history data) and periodically send the encrypted printing history data, network identification data, and user computer identification data to the data relay servers 17A/17B (means for sending printing history data (means for sending permitted operation data)).

(File Access Monitoring)

The device monitoring servers 15A to 15D monitor file access states of the user computers 11A to 11C, 12A to 12C, 13A to 13C, and 14A to 14C logged in to the networks 16A to 16D endlessly in chronological order. If the user computers 11A to 11C, 12A to 12C, 13A to 13C, and 14A to 14C access a predetermined file, the device monitoring servers 15A to 15D collect file access data from the pertinent computer in chronological order and store the collected file access data (means for collecting file access data (means for collecting refused operation data)). When the user computers 11A to 11C, 12A to 12C, 13A to 13C, and 14A to 14C access a file stored in the memory or hard disk, file access data thereof is sent (output) from the user computers 11A to 11C, 12A to 12C, 13A to 13C, and 14A to 14C to the device monitoring servers 15A to 15D and the file access data is stored in the hard disk of the device monitoring servers 15A to 15D in chronological order.

The device monitoring servers 15A to 15D attach network identification data to identify file access data received from the user computers 11A to 11C, 12A to 12C, 13A to 13C, and 14A to 14C by dividing the data for each of the networks 16A to 16D to the file access data and also attach user computer identification data to identify the file access data by dividing the data for each of the user computers 11A to 11C, 12A to 12C, 13A to 13C, and 14A to 14C to the file access data. The device monitoring servers 15A to 15D encrypt the file access data, network identification data, and user computer identification data (means for encrypting file access data) and periodically send the encrypted file access data, network identification data, and user computer identification data to the data relay servers 17A/17B (means for sending file access data (means for sending permitted operation data)).

(External Usage History Monitoring)

The device monitoring servers 15A to 15D monitor usage of the user computers 11A to 11C, 12A to 12C, 13A to 13C, and 14A to 14C outside the networks 16A to 16D endlessly in chronological order. If a computer is used in an external environment outside the networks 16A to 16D formed by the user computers 11A to 11C, 12A to 12C, 13A to 13C, and 14A to 14C, the device monitoring servers 15A to 15D collect external usage history data thereof and store the collected external usage history data (means for collecting external usage history data (means for collecting permitted operation data)). The user computers 11A to 11C, 12A to 12C, 13A to 13C, and 14A to 14C send (output) user computer identification data (such as the computer name, workgroup/domain, MAC address, IP address, and user computer identification number) to identify each computer at regular intervals (in minutes such as three-minute or five-minute intervals or in hours such as one-hour or two-hour intervals) to the device monitoring servers 15A to 15D. If user computer identification data sent from the user computers 11A to 11C, 12A to 12C, 13A to 13C, and 14A to 14C at equal intervals stops even once, the device monitoring servers 15A to 15D judge that the pertinent computer has dropped out of the networks 16A to 16D and if user computer identification data is output again from the computer at regular intervals, the device monitoring servers 15A to 15D judge that the computer has been reconnected to the networks 16A to 16D and judge that the computer was used in an external environment. When a judgment of the user computers 11A to 11C, 12A to 12C, 13A to 13C, and 14A to 14C being used in an external environment is made, the device monitoring servers 15A to 15D cause the pertinent computer to send (output) external usage history data. The external usage history data is stored in the hard disk of the device monitoring servers 15A to 15D in chronological order.

The device monitoring servers 15A to 15D attach network identification data to identify external usage history data received from the user computers 11A to 11C, 12A to 12C, 13A to 13C, and 14A to 14C by dividing the data for each of the networks 16A to 16D to the external usage history data and also attach user computer identification data to identify the external usage history data by dividing the data for each of the user computers 11A to 11C, 12A to 12C, 13A to 13C, and 14A to 14C to the external usage history data. The device monitoring servers 15A to 15D encrypt the external usage history data, network identification data, and user computer identification data (means for encrypting external usage history data) and periodically send the encrypted external usage history data, network identification data, and user computer identification data to the data relay servers 17A/17B (means for sending external usage history data (means for sending permitted operation data)).

(Extra-Specified Time Usage History Monitoring)

The device monitoring servers 15A to 15D monitor usage of the user computers 11A to 11C, 12A to 12C, 13A to 13C, and 14A to 14C outside specified times endlessly in chronological order. If the user computers 11A to 11C, 12A to 12C, 13A to 13C, and 14A to 14C are used outside specified times, the device monitoring servers 15A to 15D collect extra-specified time usage data from the pertinent computer and store the collected extra-specified time usage data (means for collecting extra-specified time usage data (means for collecting permitted operation data)). The memory of the device monitoring servers 15A to 15D has specified times (usable times) of each of the user computers 11A to 11C, 12A to 12C, 13A to 13C, and 14A to 14C stored therein by being associated with user computer identification data. The device monitoring servers 15A to 15D identify times of user computer identification data sent (output) from the user computers 11A to 11C, 12A to 12C, 13A to 13C, and 14A to 14C at regular intervals by a timer function thereof to judge whether usage of the user computers 11A to 11C, 12A to 12C, 13A to 13C, and 14A to 14C is within specified times or outside specified times. When a judgment of usage of the user computers 11A to 11C, 12A to 12C, 13A to 13C, and 14A to 14C outside specified times is made, the device monitoring servers 15A to 15D cause the pertinent computer to output extra-specified time usage history data outside specified times. The extra-specified time usage history data is stored in the hard disk of the device monitoring servers 15A to 15D in chronological order.

The device monitoring servers 15A to 15D attach network identification data to identify extra-specified time usage history data received from the user computers 11A to 11C, 12A to 12C, 13A to 13C, and 14A to 14C by dividing the data for each of the networks 16A to 16D to the extra-specified time usage history data and also attach user computer identification data to identify the extra-specified time usage history data by dividing the data for each of the user computers 11A to 11C, 12A to 12C, 13A to 13C, and 14A to 14C to the extra-specified time usage history data. The device monitoring servers 15A to 15D encrypt the extra-specified time usage history data, network identification data, and user computer identification data (means for encrypting extra-specified time usage history data) and periodically send the encrypted extra-specified time usage history data, network identification data, and user computer identification data to the data relay servers 17A/17B (means for sending extra-specified time usage history data (means for sending permitted operation data)).

(Taking-Out Act Monitoring)

The device monitoring servers 15A to 15D monitor for a taking-out act of data whose taking-out is prohibited from the user computers 11A to 11C, 12A to 12C, 13A to 13C, and 14A to 14C endlessly in chronological order. If an attempt is made to take out data whose taking-out is prohibited from the user computers 11A to 11C, 12A to 12C, 13A to 13C, and 14A to 14C, the device monitoring servers 15A to 15D collect taking-out act data from the pertinent computer and store the collected taking-out act data (means for collecting taking-out act data (means for collecting refused operation data)). Methods to prohibit taking-out of data include a method of specifying a computer of the user computers 11A to 11C, 12A to 12C, 13A to 13C, and 14A to 14C to prohibit taking-out of data from the computer, a method of prohibiting a drive mounted on the user computers 11A to 11C, 12A to 12C, 13A to 13C, and 14A to 14C from copying data stored therein (prohibiting a drive from copying), a method of prohibiting a drive mounted on the user computers 11A to 11C, 12A to 12C, 13A to 13C, and 14A to 14C from writing, and a method of specifying specific data to prohibit copying of the data.

If an act of taking out data whose taking-out is prohibited and stored in the user computers 11A to 11C, 12A to 12C, 13A to 13C, and 14A to 14C is committed (data access or data copying in a computer), an act of copying from a drive from which copying is prohibited is committed, an act of writing to a drive to which writing is prohibited is committed, or an act of copying data whose copying is prohibited is committed, the device monitoring servers 15A to 15D judges such an act as an act of taking out data. When a judgment of a taking-out act is made, the device monitoring servers 15A to 15D display a message of prohibition of taking-out in a display 25 of the pertinent computer among the user computers 11A to 11C, 12A to 12C, 13A to 13C, and 14A to 14C and also send (output) taking-out act data to the computer among the user computers 11A to 11C, 12A to 12C, 13A to 13C, and 14A to 14C that committed an act of taking-out. The taking-out act data is stored in the hard disk of the device monitoring servers 15A to 15D in chronological order.

The device monitoring servers 15A to 15D attach network identification data to identify taking-out act data received from the user computers 11A to 11C, 12A to 12C, 13A to 13C, and 14A to 14C by dividing the data for each of the networks 16A to 16D to the taking-out act data and also attach user computer identification data to identify the taking-out act data by dividing the data for each of the user computers 11A to 11C, 12A to 12C, 13A to 13C, and 14A to 14C to the taking-out act data. The device monitoring servers 15A to 15D encrypt the taking-out act data, network identification data, and user computer identification data (means for encrypting taking-out act data) and periodically send the encrypted taking-out act data, network identification data, and user computer identification data to the data relay servers 17A/17B (means for sending taking-out act data (means for sending refused operation data)).

(Printing Act Monitoring)

The device monitoring servers 15A to 15D monitor for a printing act of data whose printing is prohibited from the user computers 11A to 11C, 12A to 12C, 13A to 13C, and 14A to 14C endlessly in chronological order. If an attempt is made to print printing prohibited data from the user computers 11A to 11C, 12A to 12C, 13A to 13C, and 14A to 14C, the device monitoring servers 15A to 15D collect printing act data from the pertinent computer and store the printing act data (means for collecting printing act data (means for collecting refused operation data)). Methods to prohibit printing of data include a method of specifying a computer of the user computers 11A to 11C, 12A to 12C, 13A to 13C, and 14A to 14C to prohibit the computer from printing data, a method of specifying a drive mounted on the user computers 11A to 11C, 12A to 12C, 13A to 13C, and 14A to 14C to prohibit the drive from printing data stored therein, and a method of specifying specific data to prohibit printing of the data.

If an act of printing from a computer whose printing is prohibited among the user computers 11A to 11C, 12A to 12C, 13A to 13C, and 14A to 14C is committed, an act of printing from a drive whose printing is prohibited is committed, or an act of printing of data whose printing is prohibited is committed, the device monitoring servers 15A to 15D judge such an act as an act of printing data whose printing is prohibited. When a judgment of an act of printing is made, the device monitoring servers 15A to 15D display a message of prohibition of printing in the display 25 of the pertinent computer among the user computers 11A to 11C, 12A to 12C, 13A to 13C, and 14A to 14C and also send (output) printing act data to the computer among the user computers 11A to 110, 12A to 12C, 13A to 13C, and 14A to 14C that committed an act of printing. The printing act data is stored in the hard disk of the device monitoring servers 15A to 15D in chronological order.

The device monitoring servers 15A to 15D attach network identification data to identify printing act data received from the user computers 11A to 11C, 12A to 12C, 13A to 13C, and 14A to 14C by dividing the data for each of the networks 16A to 16D to the printing act data and also attach user computer identification data to identify the printing act data by dividing the data for each of the user computers 11A to 11C, 12A to 12C, 13A to 13C, and 14A to 14C to the printing act data. The device monitoring servers 15A to 15D encrypt the printing act data, network identification data, and user computer identification data (means for encrypting printing act data) and periodically send the encrypted printing act data, network identification data, and user computer identification data to the data relay servers 17A/17B (means for sending printing act data (means for sending refused operation data)).

(E-Mail Transmission Monitoring)

The device monitoring servers 15A to 15D monitor e-mail transmission from the user computers 11A to 11C, 12A to 12C, 13A to 13C, and 14A to 14C endlessly in chronological order. If an e-mail is transmitted from the user computers 11A to 11C, 12A to 12C, 13A to 13C, and 14A to 14C, the device monitoring servers 15A to 15D collect e-mail transmission data from the pertinent computer and store the collected mail transmission data (means for collecting e-mail transmission data (means for collecting refused operation data)). If the user computers 11A to 11C, 12A to 12C, 13A to 13C, and 14A to 14C transmit an e-mail to the other user computers 11A to 11C, 12A to 12C, 13A to 13C, and 14A to 14C in the same networks 16A to 16D as those formed thereof, or the user computers 11A to 11C, 12A to 12C, 13A to 13C, and 14A to 14C transmit an e-mail to the outside the networks 16A to 16D formed thereof using the Internet 20, a mail transmission signal is sent (output) from the user computers 11A to 11C, 12A to 12C, 13A to 13C, and 14A to 14C to the device monitoring servers 15A to 15D. The device monitoring servers 15A to 15D detect e-mail transmission by a computer based on the mail transmission signal transmitted from the user computers 11A to 11C, 12A to 12C, 13A to 13C, and 14A to 14C. When e-mail transmission is detected, the device monitoring servers 15A to 15D sends (outputs) e-mail transmission data to the user computers 11A to 11C, 12A to 12C, 13A to 13C, and 14A to 14C that transmitted the e-mail. The e-mail transmission data is stored in the hard disk of the device monitoring servers 15A to 15D in chronological order.

The device monitoring servers 15A to 15D attach network identification data to identify e-mail transmission data received from the user computers 11A to 11C, 12A to 12C, 13A to 13C, and 14A to 14C by dividing the data for each of the networks 16A to 16D to the e-mail transmission data and also attach user computer identification data to identify the e-mail transmission data by dividing the data for each of the user computers 11A to 11C, 12A to 12C, 13A to 13C, and 14A to 14C to the e-mail transmission data. The device monitoring servers 15A to 15D encrypt the e-mail transmission data, network identification data, and user computer identification data (means for encrypting e-mail transmission data) and periodically send the encrypted e-mail transmission data, network identification data, and user computer identification data to the data relay servers 17A/17B (means for sending e-mail transmission data (means for sending refused operation data)).

(Web Site Monitoring)

The device monitoring servers 15A to 15D monitor access to a Web site from the user computers 11A to 11C, 12A to 12C, 13A to 13C, and 14A to 14C endlessly in chronological order. If the user computers 11A to 11C, 12A to 12C, 13A to 13C, and 14A to 14C access a Web site, the device monitoring servers 15A to 15D collect Web site access data from the pertinent computer and store the collected Web site access data (means for collecting Web site access data (means for collecting permitted operation data)). When the user computers 11A to 11C, 12A to 12C, 13A to 13C, and 14A to 14C access a Web site using the Internet 20, a Web site access signal is sent (output) from the user computers 11A to 11C, 12A to 12C, 13A to 13C, and 14A to 14C to the device monitoring servers 15A to 15D. The device monitoring servers 15A to 15D detect access to a Web site by the user computers 11A to 11C, 12A to 12C, 13A to 13C, and 14A to 14C based on the Web site access signal transmitted from the user computers 11A to 11C, 12A to 12C, 13A to 13C, and 14A to 14C. When access to a Web site is detected, the device monitoring servers 15A to 15D sends (outputs) Web site access data to the user computers 11A to 11C, 12A to 12C, 13A to 13C, and 14A to 14C that accessed the Web site. The Web site access data is stored in the hard disk of the device monitoring servers 15A to 15D in chronological order.

The device monitoring servers 15A to 15D attach network identification data to identify Web site access data received from the user computers 11A to 11C, 12A to 12C, 13A to 13C, and 14A to 14C by dividing the data for each of the networks 16A to 16D to the Web site access data and also attach user computer identification data to identify the Web site access data by dividing the data for each of the user computers 11A to 11C, 12A to 12C, 13A to 13C, and 14A to 14C to the Web site access data. The device monitoring servers 15A to 15D encrypt the Web site access data, network identification data, and user computer identification data (means for encrypting Web site access data) and periodically send the encrypted Web site access data, network identification data, and user computer identification data to the data relay servers 17A/17B (means for sending Web site access data (means for sending permitted operation data)).

(External Network Access Monitoring)

The device monitoring servers 15A to 15D monitor access to an external network from the user computers 11A to 11C, 12A to 12C, 13A to 13C, and 14A to 14C endlessly in chronological order. If the user computers 11A to 11C, 12A to 12C, 13A to 13C, and 14A to 14C access the external networks 16A to 16D outside a network formed of the user computers 11A to 11C, 12A to 12C, 13A to 13C, and 14A to 14C, the device monitoring servers 15A to 15D collect external network access data from the pertinent computer and store the collected external network access data (means for collecting external network access data (means for collecting permitted operation data)). When the user computers 11A to 110, 12A to 12C, 13A to 13C, and 14A to 14C access an external network using the Internet 20, an external network access signal is sent (output) to the device monitoring servers 15A to 15D. The device monitoring servers 15A to 15D detect access to an external network by the user computers 11A to 11C, 12A to 12C, 13A to 13C, and 14A to 14C based on the external network access signal transmitted from the user computers 11A to 11C, 12A to 12C, 13A to 13C, and 14A to 14C. When access to an external network is detected, the device monitoring servers 15A to 15D sends (outputs) external network access data to the user computers 11A to 11C, 12A to 12C, 13A to 13C, and 14A to 14C that accessed the external network. The external network access data is stored in the hard disk of the device monitoring servers 15A to 15D in chronological order.

The device monitoring servers 15A to 15D attach network identification data to identify external network access data received from the user computers 11A to 11C, 12A to 12C, 13A to 13C, and 14A to 14C by dividing the data for each of the networks 16A to 16D to the external network access data and also attach user computer identification data to identify the external network access data by dividing the data for each of the user computers 11A to 11C, 12A to 12C, 13A to 13C, and 14A to 14C to the external network access data. The device monitoring servers 15A to 15D encrypt the external network access data, network identification data, and user computer identification data (means for encrypting external network access data) and periodically send the encrypted external network access data, network identification data, and user computer identification data to the data relay servers 17A/17B (means for sending external network access data).

(Means for Sending Permitted Operation Data)

The interval at which the device monitoring servers 15A to 15D send various kinds of data to the data relay servers 17A/17B are in hours such as 6-hour or 12-hour intervals, in days such as 1-day or 2-day intervals, or in weeks such as 1-week or 3-week intervals. In the present embodiment, the device monitoring servers 15A to 15D add up various kinds of data for each day (every 24 hours) and send added data for one day to the data relay servers 17A/17B. The interval at which the device monitoring servers 15A to 15D send various kinds of data to the data relay servers 17A/17B are set by the data management computer 18 and the data management computer 18 can set the interval freely. The data relay servers 17A/17B store various kinds of data sent from the device monitoring servers 15A to 15D in a storage device such as a database and external hard disk.

(Log Data)

When the device monitoring servers 15A to 15D send various kinds of data to the data relay servers 17A/17B via the Internet 20 or the device monitoring servers 15A to 15D receive various kinds of data from the relay servers 17A/17B via the Internet 20, the firewall 19 stores log data (such as connection between the device monitoring servers 15A to 15D and the data relay servers 17A/17B, disconnection of the device monitoring servers 15A to 15D from the data relay servers 17A/17B, failures of the user computers 11A to 11C, 12A to 12C, 13A to 13C, and 14A to 14C or the device monitoring servers 15A to 15D, data restoration, illegal operation traces, and illegal intrusion traces) in the storage device thereof. The firewall 19 attach network identification data to identify log data by dividing the data for each of the networks 16A to 16D to the log data and also attach firewall identification data (such as the firewall name, IP address, URL, and firewall identification number) to identify the firewall 19 that sent the log data to the log data. The firewall 19 encrypts the log data, network identification data, and firewall identification data (means for encrypting log data) and then periodically sends the encrypted log data, network identification data, and firewall identification data to the data relay servers 17A/17B (means for sending log data).

The data management computer 18 has a central processing unit and a memory and has a large-capacity hard disk mounted thereon. A display 23 and a keyboard 24 are connected to the data management computer 18 via an interface and, though not illustrated, a printer, scanner, and database are also connected via interfaces. The data management computer 18 acquires various kinds of data sent from each of the device monitoring servers 15A to 15D to the data relay servers 17A/17B from the data relay servers 17A/17B to manage the data. The data management computer 18 sends various commands for the device monitoring servers 15A to 15D to the data relay servers 17A/17B. Based on control by the operating system, the data management computer 18 activates a management application stored in the instruction file of the memory to execute each means below according to the activated application.

(Unregistered Computer Connection History Management)

The data management computer 18 fetches unregistered computer connection data and network identification data sent from the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the unregistered computer connection data and network identification data acquired from the data relay servers 17A/17B (means for decrypting unregistered computer connection data). The data management computer 18 divides the decrypted unregistered computer connection data for each of the networks 16A to 16D based on network identification data and stores the unregistered computer connection data in a state of being divided for each of the networks 16A to 16D (means for storing unregistered computer connection data (means for storing unregistered device connection data)). The data management computer 18 can output the decrypted unregistered computer connection data via an output device such as the display 23 and a printer. The data management computer 18 can output the unregistered computer connection data after being divided for each of the networks 16A to 16D (means for outputting unregistered computer connection data (means for outputting unregistered device connection data)) and also can output the unregistered computer connection data after being divided for each of predetermined periods such as days, weeks, or months.

(Specific Device Exclusion Management)

The data management computer 18 can exclude, among the unregistered computers 21 on which no operation data management application is installed, the specific computer 22 from the unregistered computers 21 (means for excluding a specific device). The data management computer 18 can carry out exclusion of the specific computer 22 from the unregistered computers 21 for each of the networks 16A to 16D. The data management computer 18 encrypts specific computer identification data (such as the computer name, workgroup/domain, MAC address, IP address, and specific computer identification number) to identify the specific computer 22 to be excluded (means for encrypting specific device data) and also attaches network identification data (such as the network name and network identification number) to identify the specific computer identification data by dividing the data for each of the networks 16A to 16D to the specific computer identification data before sending the encrypted specific computer identification data and network identification data to the data relay servers 17A/17B (means for sending specific device data).

The device monitoring servers 15A to 15D, which access the data relay servers 17A/17B at predetermined intervals (in hours such as 6-hour or 12-hour intervals or in days such as 1-day or 2-day intervals), identify the networks 16A to 16D from network identification data attached to the specific computer identification data. If the device monitoring servers 15A to 15D judge that the network identified based on the network identification data is the network to which the device monitoring servers 15A to 15D belong, the device monitoring servers 15A to 15D acquire specific computer identification data to which the network identification data is attached from the data relay servers 17A/17B and decrypt the acquired specific computer identification data (means for decrypting specific device data). The device monitoring servers 15A to 15D store the decrypted specific computer identification data and network identification data in the memory. Even if the specific computer 22 sent from the data management computer 18 logs in to the networks 16A to 16D, the device monitoring servers 15A to 15D will not detect the computer as the unregistered computer 21.

The data management computer 18 can change the excluded specific computer 22 back to the unregistered computer 21 again (means for changing a specific device). The data management computer 18 can make a change from the specific computer 22 to the unregistered computer 21 for each of the networks 16A to 16D. When a change from the specific computer 22 to the unregistered computer 21 is made, the data management computer 18 encrypts unregistered computer identification data (such as the computer name, workgroup/domain, MAC address, IP address, and unregistered computer identification number) to identify the unregistered computer 21 (means for encrypting unregistered device data) and also attaches network identification data to identify the unregistered computer identification data by dividing the data for each of the networks 16A to 16D to the unregistered computer identification data before sending the encrypted unregistered computer identification data and network identification data to the data relay servers 17A/17B (means for sending unregistered device data).

The device monitoring servers 15A to 15D, which access the data relay servers 17A/17B at predetermined intervals, identify the networks 16A to 16D from network identification data attached to the unregistered computer identification data. If the device monitoring servers 15A to 15D judge that the network identified based on the network identification data is the network to which the device monitoring servers 15A to 15D belong, the device monitoring servers 15A to 15D acquire unregistered computer identification data to which the network identification data is attached from the data relay servers 17A/17B and decrypt the acquired unregistered computer identification data (means for decrypting unregistered device data). The device monitoring servers 15A to 15D store the decrypted unregistered computer identification data and network identification data in the memory and delete the specific computer identification data of the specific computer 22 changed to the unregistered computer 21. If the unregistered computer 21 sent from the data management computer 18 logs in to the networks 16A to 16D, the device monitoring servers 15A to 15D will detect the computer as the unregistered computer 21.

(Unregistered Computer Connection Data Transmission Interval Management)

The data management computer 18 can freely set or change the transmission interval of unregistered computer connection data sent from the device monitoring servers 15A to 15D to the data relay servers 17A/17B (first means for changing the transmission interval). The data management computer 18 can set the transmission interval of unregistered computer connection data for each of the networks 16A to 16D. After the transmission interval of unregistered computer connection data being set or changed, the data management computer 18 encrypts transmission interval data (the unregistered computer connection data transmission interval and setting change command) thereof (means for encrypting transmission interval data) and also attaches network identification data to identify the transmission interval data by dividing the data for each of the networks 16A to 16D to the transmission interval data before sending the encrypted transmission interval data and network identification data to the data relay servers 17A/17B (means for sending transmission interval data).

The device monitoring servers 15A to 15D, which access the data relay servers 17A/17B at predetermined intervals, identify the networks 16A to 16D from network identification data attached to the transmission interval data. If the device monitoring servers 15A to 15D judge that the network identified based on the network identification data is the network to which the device monitoring servers 15A to 15D belong, the device monitoring servers 15A to 15D acquire transmission interval data to which the network identification data is attached from the data relay servers 17A/17B and decrypt the acquired transmission interval data (means for decrypting transmission interval data). The device monitoring servers 15A to 15D store the decrypted transmission interval data and network identification data in the memory and also sends unregistered computer connection data to the data relay servers 17A/17B according to the transmission interval.

(Operation Data Transmission Interval Management)

The data management computer 18 can freely set or change the transmission interval of various kinds of operation data (permitted operation data and refused operation data) of the user computers 11A to 11C, 12A to 12C, 13A to 130, and 14A to 14C sent from the device monitoring servers 15A to 15D to the data relay servers 17A/17B (second means for changing the transmission interval). The data management computer 18 can set the transmission interval of various kinds of operation data for each of the networks 16A to 16D. After the transmission interval being set or changed, the data management computer 18 encrypts transmission interval data (the various connection data transmission interval and setting change command) thereof (means for encrypting transmission interval data) and also attaches network identification data to identify the transmission interval data by dividing the data for each of the networks 16A to 16D to the transmission interval data before sending the encrypted transmission interval data and network identification data to the data relay servers 17A/17B (means for sending transmission interval data).

The device monitoring servers 15A to 15D, which access the data relay servers 17A/17B at predetermined intervals, identify the networks 16A to 16D from network identification data attached to the transmission interval data. If the device monitoring servers 15A to 15D judge that the network identified based on the network identification data is the network to which the device monitoring servers 15A to 15D belong, the device monitoring servers 15A to 15D acquire transmission interval data to which the network identification data is attached from the data relay servers 17A/17B and decrypt the acquired transmission interval data (means for decrypting transmission interval data). The device monitoring servers 15A to 15D store the decrypted transmission interval data and network identification data in the hard disk and also send the transmission interval and data name to each of the user computers 11A to 11C, 12A to 12C, 13A to 13C, and 14A to 14C. The device monitoring servers 15A to 15D send various kinds of operation data to the data relay servers 17A/17B according to the transmission interval acquired from the data relay servers 17A/17B. The user computers 11A to 11C, 12A to 12C, 13A to 13C, and 14A to 14C send various kinds of operation data to the device monitoring servers 15A to 15D at transmission intervals according to the transmission interval sent from the servers 15A to 15D. Only specified data is sent to the device monitoring servers 15A to 15D at transmission intervals thereof.

(Data Transmission Destination Change Management)

The data management computer 18 can change the transmission destination of unregistered connection data sent from the device monitoring servers 15A to 15D or various kinds of operation data (permitted operation data and refused operation data) of the user computers 11A to 11C, 12A to 12C, 13A to 13C, and 14A to 14C from a predetermined data relay server to another data relay server (means for changing the data transmission destination). The data management computer 18 sends transmission destination change data after the transmission destination being changed (such as the server name of the data relay server, IP address, URL, and data relay server identification number before the change, the server name of the device monitoring server, IP address, URL, and device monitoring server identification number before the change, the server name of the data relay server, IP address, URL, and data relay server identification number after the change, and the server name of the device monitoring server, IP address, URL, and device monitoring server identification number after the change) to each of the data relay servers 17A/17B to be changed (means for sending transmission destination change data). The data relay servers 17A/17B that receive the transmission destination change data overwrite transmission destination change data of the device monitoring servers 15A to 15D before the change with transmission destination change data of the device monitoring servers 15A to 15D after the change to receive unregistered computer connection data and various kinds of operation data of the user computers 11A to 11C, 12A to 12C, 13A to 13C, and 14A to 14C from the device monitoring servers 15A to 15D after the change.

(Storage Capacity Management)

The data management computer 18 monitors the storage capacity of each of the data relay servers 17A/17B endlessly in chronological order (means for monitoring the storage capacity). The memory of the data management computer 18 has the storage capacity and permissible range of each of the data relay servers 17A/17B stored therein. Each of the data relay servers 17A/17B periodically sends the currently used storage capacity to the data management computer 18 at predetermined intervals (in hours such as 6-hour or 12-hour intervals, in days such as 1-day or 2-day intervals, and in the present embodiment, for each day (every 24 hours)) together with data relay server identification data (such as the server name, IP address, URL, and the data relay server identification number). The data management computer 18 identifies the data relay server 17A/17B based on the data relay server identification data sent from the data relay server 17A/17B and compares the currently used storage capacity with the permissible range stored in the memory. If the storage capacity of the data relay servers 17A/17B exceeds the permissible range, the data management computer 18 outputs excessive storage capacity data (such as the server name of the data relay server, IP address, URL, data relay server identification number, permissible storage capacity, measured storage capacity, and excessive capacity) notifying that the storage capacity of the data relay server 17A/17B has been exceeded (means for outputting excessive storage capacity data).

(Log Data Management)

The data management computer 18 decrypts log data (such as connection between the device monitoring servers 15A to 15D and the data relay servers 17A/17B, disconnection of the device monitoring servers 15A to 15D from the data relay servers 17A/17B, failures of the user computers 11A to 11C, 12A to 12C, 13A to 13C, and 14A to 14C or the device monitoring servers 15A to 15D, data restoration, illegal operation traces, and illegal intrusion traces), network identification data, and firewall identification data (such as the firewall name, IP address, URL, and firewall identification number) sent from the firewall 19 (means for decrypting log data), divides the decrypted log data for each of the networks 16A to 16D based on the network identification data, and stores the log data in a state of being divided for each of the networks 16A to 16D (means for storing log data). The data management computer 18 also divides the decrypted log data for each firewall based on the firewall identification data and stores the log data in a state of being divided for each firewall (means for storing log data). The data management computer 18 can output the decrypted log data via an output device such as a display and printer (means for outputting log data). The data management computer 18 can output log data after being divided for each firewall and also output log data after being divided for each of the networks 16A to 16D. Further, the data management computer 18 can output log data after being divided for each of predetermined periods such as days, weeks, or months.

(Usage History Management)

The data management computer 18 fetches usage history data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the usage history data, network identification data, and user computer identification data acquired from the data relay servers 17A/17B (means for decrypting usage history data). The data management computer 18 divides the decrypted usage history data for each of the networks 16A to 16D based on the network identification data and also divides the usage history data for each of the user computers 11A to 11C, 12A to 12C, 13A to 13C, and 14A to 14C based on the user computer identification data.

The data management computer 18 stores the usage history data in a database in a state of being divided for each of the networks 16A to 16D (first means for storing usage history data (first means for storing permitted operation data)) and also stores the usage history data in the database in a state of being divided for each of the user computers 11A to 11C, 12A to 12C, 13A to 13C, and 14A to 14C (second means for storing usage history data (second means for storing permitted operation data)). The data management computer 18 can output the decrypted usage history data via an output device such as the display 23 or a printer. The data management computer 18 can output the usage history data after being divided for each of the networks 16A to 16D (first means for outputting usage history data (first means for outputting permitted operation data)) and also output the usage history data after being divided for each of the user computers 11A to 11C, 12A to 12C, 13A to 13C, and 14A to 14C (second means for outputting usage history data (second means for outputting permitted operation data)). Further, the data management computer 18 can output the usage history data after being divided for each of predetermined periods such as days, weeks, or months.

(Access History Management)

The data management computer 18 fetches access history data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the access history data, network identification data, and user computer identification data acquired from the data relay servers 17A/17B (means for decrypting access history data). The data management computer 18 divides the decrypted access history data for each of the networks 16A to 16D based on the network identification data and also divides the access history data for each of the user computers 11A to 11C, 12A to 12C, 13A to 13C, and 14A to 14C based on the user computer identification data.

The data management computer 18 stores the access history data in a database in a state of being divided for each of the networks 16A to 16D (first means for storing access history data (first means for storing permitted operation data)) and also stores the access history data in the database in a state of being divided for each of the user computers 11A to 11C, 12A to 12C, 13A to 13C, and 14A to 14C (second means for storing access history data (second means for storing permitted operation data)). The data management computer 18 can output the access history data via an output device such as the display 23 or a printer. The data management computer 18 can output the access history data after being divided for each of the networks 16A to 16D (first means for outputting access history data (first means for outputting permitted operation data)) and also output the access history data after being divided for each of the user computers 11A to 11C, 12A to 12C, 13A to 13C, and 14A to 14C (second means for outputting access history data (second means for outputting permitted operation data)). Further, the data management computer 18 can output the access history data after being divided for each of predetermined periods such as days, weeks, or months.

(Permitted Application Addition/Change/Deletion Management)

The data management computer 18 can add, change, or delete a permitted application the user computers 11A to 11C, 12A to 12C, 13A to 13C, and 14A to 14C are caused to use for each of the networks 16A to 16D (means for altering a permitted application). The data management computer 18 encrypts first application usage rule data after the application is altered (means for encrypting first application usage rule data) and also attaches network identification data to identify the first application usage rule data by dividing the data for each of the networks 16A to 16D to the first application usage rule data before sending the encrypted first application usage rule data and network identification data to the data relay servers 17A/17B (means for sending first application usage rule data).

The device monitoring servers 15A to 15D, which access the data relay servers 17A/17B at predetermined intervals, identify the networks 16A to 16D based on network identification data by acquiring the network identification data attached to first application usage rule data from the data relay servers 17A/17B. If the device monitoring servers 15A to 15D judge that the network identified based on the network identification data is the network to which the device monitoring servers 15A to 15D belong, the device monitoring servers 15A to 15D acquire the first application usage rule data to which the network identification data is attached from the data relay servers 17A/17B and decrypt the acquired first application usage rule data (means for decrypting first application usage rule data). The device monitoring servers 15A to 15D output the decrypted first application usage rule data to each of the user computers 11A to 11C, 12A to 12C, 13A to 13C, and 14A to 14C. The user computers 11A to 11C, 12A to 12C, 13A to 13C, and 14A to 14C follow first application usage rules output from the device monitoring servers 15A to 15D. The data management computer 18 can set different first application usage rules for each of the networks 16A to 16D.

(Permitted Application Addition/Change/Deletion Management)

The data management computer 18 can add, change, or delete a refused application whose use in the user computers 11A to 11C, 12A to 12C, 13A to 13C, and 14A to 14C is prohibited for each of the networks 16A to 16D (means for altering a refused application). The data management computer 18 encrypts second application usage rule data after the refused application is altered (means for encrypting second application usage rule data) and also attaches network identification data to identify the second application usage rule data by dividing the data for each of the networks 16A to 16D to the second application usage rule data before sending the encrypted second application usage rule data and network identification data to the data relay servers 17A/17B (means for sending second application usage rule data).

The device monitoring servers 15A to 15D, which access the data relay servers 17A/17B at predetermined intervals, identify the networks 16A to 16D based on network identification data by acquiring the network identification data attached to second application usage rule data from the data relay servers 17A/17B. If the device monitoring servers 15A to 15D judge that the network identified based on the network identification data is the network to which the device monitoring servers 15A to 15D belong, the device monitoring servers 15A to 15D acquire the second application usage rule data to which the network identification data is attached from the data relay servers 17A/17B and decrypt the acquired second application usage rule data (means for decrypting second application usage rule data). The device monitoring servers 15A to 15D output the decrypted second application usage rule data to each of the user computers 11A to 11C, 12A to 12C, 13A to 13C, and 14A to 14C. The user computers 11A to 11C, 12A to 12C, 13A to 13C, and 14A to 14C follow second application usage rules output from the device monitoring servers 15A to 15D. The data management computer 18 can set different second application usage rules for each of the networks 16A to 16D.

(Installation Management)

The data management computer 18 fetches installation data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the installation data, network identification data, and user computer identification data acquired from the data relay servers 17A/17B (means for decrypting installation data). The data management computer 18 divides the decrypted installation data for each of the networks 16A to 16D based on the network identification data and also divides the installation data for each of the user computers 11A to 11C, 12A to 12C, 13A to 13C, and 14A to 14C based on the user computer identification data.

The data management computer 18 stores the installation data in a database in a state of being divided for each of the networks 16A to 16D (first means for storing installation data (first means for storing permitted operation data)) and also stores the installation data in the database in a state of being divided for each of the user computers 11A to 11C, 12A to 12C, 13A to 13C, and 14A to 14C (second means for storing installation data (second means for storing permitted operation data)). The data management computer 18 can output the installation data via an output device such as the display 23 or a printer. The data management computer 18 can output the installation data after being divided for each of the networks 16A to 16D (first means for outputting installation data (first means for outputting permitted operation data)) and also output the installation data after being divided for each of the user computers 11A to 11C, 12A to 12C, 13A to 13C, and 14A to 14C (second means for outputting installation data (second means for outputting permitted operation data)). Further, the data management computer 18 can output the installation data after being divided for each of predetermined periods such as days, weeks, or months.

(Uninstallation Management)

The data management computer 18 fetches uninstallation data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the uninstallation data, network identification data, and user computer identification data acquired from the data relay servers 17A/17B (means for decrypting uninstallation data). The data management computer 18 divides the decrypted uninstallation data for each of the networks 16A to 16D based on the network identification data and also divides the uninstallation data for each of the user computers 11A to 11C, 12A to 12C, 13A to 13C, and 14A to 14C based on the user computer identification data.

The data management computer 18 stores the uninstallation data in a database in a state of being divided for each of the networks 16A to 16D (first means for storing uninstallation data (first means for storing permitted operation data)) and also stores the uninstallation data in the database in a state of being divided for each of the user computers 11A to 11C, 12A to 12C, 13A to 13C, and 14A to 14C (second means for storing uninstallation data (second means for storing permitted operation data)). The data management computer 18 can output the uninstallation data via an output device such as the display 23 or a printer. The data management computer 18 can output the uninstallation data after being divided for each of the networks 16A to 16D (first means for outputting uninstallation data (first means for outputting permitted operation data)) and also output the uninstallation data after being divided for each of the user computers 11A to 11C, 12A to 12C, 13A to 13C, and 14A to 14C (second means for outputting uninstallation data (second means for outputting permitted operation data)). Further, the data management computer 18 can output the uninstallation data after being divided for each of predetermined periods such as days, weeks, or months.

(Printing History Management)

The data management computer 18 fetches printing history data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the printing history data, network identification data, and user computer identification data acquired from the data relay servers 17A/17B (means for decrypting printing history data). The data management computer 18 divides the decrypted printing history data for each of the networks 16A to 16D based on the network identification data and also divides the printing history data for each of the user computers 11A to 11C, 12A to 12C, 13A to 13C, and 14A to 14C based on the user computer identification data.

The data management computer 18 stores the printing history data in a database in a state of being divided for each of the networks 16A to 16D (first means for storing printing history data (first means for storing permitted operation data)) and also stores the printing history data in the database in a state of being divided for each of the user computers 11A to 11C, 12A to 12C, 13A to 13C, and 14A to 14C (second means for storing printing history data (second means for storing permitted operation data)). The data management computer 18 can output the printing history data via an output device such as the display 23 or a printer. The data management computer 18 can output the printing history data after being divided for each of the networks 16A to 16D (first means for outputting printing history data (first means for outputting permitted operation data)) and also output the printing history data after being divided for each of the user computers 11A to 11C, 12A to 12C, 13A to 13C, and 14A to 14C (second means for outputting printing history data (second means for outputting permitted operation data)). Further, the data management computer 18 can output the printing history data after being divided for each of predetermined periods such as days, weeks, or months.

(File Access History Management)

The data management computer 18 fetches file access data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the file access data, network identification data, and user computer identification data acquired from the data relay servers 17A/17B (means for decrypting file access data). The data management computer 18 divides the decrypted file access data for each of the networks 16A to 16D based on the network identification data and also divides the file access data for each of the user computers 11A to 11C, 12A to 12C, 13A to 13C, and 14A to 14C based on the user computer identification data.

The data management computer 18 stores the file access data in a database in a state of being divided for each of the networks 16A to 16D (first means for storing file access data (first means for storing permitted operation data)) and also stores the file access data in the database in a state of being divided for each of the user computers 11A to 11C, 12A to 12C, 13A to 13C, and 14A to 14C (second means for storing file access data (second means for storing permitted operation data)). The data management computer 18 can output the file access data via an output device such as the display 23 or a printer. The data management computer 18 can output the file access data after being divided for each of the networks 16A to 16D (first means for outputting file access data (first means for outputting permitted operation data)) and also output the file access data after being divided for each of the user computers 11A to 11C, 12A to 12C, 13A to 13C, and 14A to 14C (second means for outputting file access data (second means for outputting permitted operation data)). Further, the data management computer 18 can output the file access data after being divided for each of predetermined periods such as days, weeks, or months.

(External Usage History Management)

The data management computer 18 fetches external usage history data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the external usage history data, network identification data, and user computer identification data acquired from the data relay servers 17A/17B (means for decrypting external usage history data). The data management computer 18 divides the decrypted external usage history data for each of the networks 16A to 16D based on the network identification data and also divides the external usage history data for each of the user computers 11A to 11C, 12A to 12C, 13A to 13C, and 14A to 14C based on the user computer identification data.

The data management computer 18 stores the external usage history data in a database in a state of being divided for each of the networks 16A to 16D (first means for storing external usage history data (first means for storing permitted operation data)) and also stores the external usage history data in the database in a state of being divided for each of the user computers 11A to 11C, 12A to 12C, 13A to 13C, and 14A to 14C (second means for storing external usage history data (second means for storing permitted operation data)). The data management computer 18 can output the external usage history data via an output device such as the display 23 or a printer. The data management computer 18 can output the external usage history data after being divided for each of the networks 16A to 16D (first means for outputting external usage history data (first means for outputting permitted operation data)) and also output the external usage history data after being divided for each of the user computers 11A to 11C, 12A to 12C, 13A to 13C, and 14A to 14C (second means for outputting external usage history data (second means for outputting permitted operation data)). Further, the data management computer 18 can output the external usage history data after being divided for each of predetermined periods such as days, weeks, or months.

(Extra-Specified Time Usage History Management)

The data management computer 18 fetches extra-specified time usage history data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the extra-specified time usage history data, network identification data, and user computer identification data acquired from the data relay servers 17A/17B (means for decrypting extra-specified time usage history data). The data management computer 18 divides the decrypted extra-specified time usage history data for each of the networks 16A to 16D based on the network identification data and also divides the extra-specified time usage history data for each of the user computers 11A to 11C, 12A to 12C, 13A to 13C, and 14A to 14C based on the user computer identification data.

The data management computer 18 stores the extra-specified time usage history data in a database in a state of being divided for each of the networks 16A to 16D (first means for storing extra-specified time usage history data (first means for storing permitted operation data)) and also stores the extra-specified time usage history data in the database in a state of being divided for each of the user computers 11A to 11C, 12A to 12C, 13A to 13C, and 14A to 14C (second means for storing extra-specified time usage history data (second means for storing permitted operation data)). The data management computer 18 can output the extra-specified time usage history data via an output device such as the display 23 or a printer. The data management computer 18 can output the extra-specified time usage history data after being divided for each of the networks 16A to 16D (first means for outputting extra-specified time usage history data (first means for outputting permitted operation data)) and also output the extra-specified time usage history data after being divided for each of the user computers 11A to 11C, 12A to 12C, 13A to 13C, and 14A to 14C (second means for outputting extra-specified time usage history data (second means for outputting permitted operation data)). Further, the data management computer 18 can output the extra-specified time usage history data after being divided for each of predetermined periods such as days, weeks, or months.

(Taking-Out Act Management)

The data management computer 18 fetches taking-out act data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the taking-out act data, network identification data, and user computer identification data acquired from the data relay servers 17A/17B (means for decrypting taking-out act data). The data management computer 18 divides the decrypted taking-out act data for each of the networks 16A to 16D based on the network identification data and also divides the taking-out act data for each of the user computers 11A to 11C, 12A to 12C, 13A to 13C, and 14A to 14C based on the user computer identification data.

The data management computer 18 stores the taking-out act data in a database in a state of being divided for each of the networks 16A to 16D (first means for storing taking-out act data (first means for storing refused operation data)) and also stores the taking-out act data in the database in a state of being divided for each of the user computers 11A to 11C, 12A to 12C, 13A to 13C, and 14A to 14C (second means for storing taking-out act data (second means for storing refused operation data)). The data management computer 18 can output the taking-out act data via an output device such as the display 23 or a printer. The data management computer 18 can output the taking-out act data after being divided for each of the networks 16A to 16D (first means for outputting taking-out act data (first means for outputting refused operation data)) and also output the taking-out act data after being divided for each of the user computers 11A to 11C, 12A to 12C, 13A to 13C, and 14A to 14C (second means for outputting taking-out act data (second means for outputting refused operation data)). Further, the data management computer 18 can output the taking-out act data after being divided for each of predetermined periods such as days, weeks, or months.

(Printing Act Management)

The data management computer 18 fetches printing act data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the printing act data, network identification data, and user computer identification data acquired from the data relay servers 17A/17B (means for decrypting printing act data). The data management computer 18 divides the decrypted printing act data for each of the networks 16A to 16D based on the network identification data and also divides the printing act data for each of the user computers 11A to 11C, 12A to 12C, 13A to 13C, and 14A to 14C based on the user computer identification data.

The data management computer 18 stores the printing act data in a database in a state of being divided for each of the networks 16A to 16D (first means for storing printing act data (first means for storing refused operation data)) and also stores the printing act data in the database in a state of being divided for each of the user computers 11A to 11C, 12A to 12C, 13A to 13C, and 14A to 14C (second means for storing printing act data (second means for storing refused operation data)). The data management computer 18 can output the printing act data via an output device such as the display 23 or a printer. The data management computer 18 can output the printing act data after being divided for each of the networks 16A to 16D (first means for outputting printing act data (first means for outputting refused operation data)) and also output the printing act data after being divided for each of the user computers 11A to 11C, 12A to 12C, 13A to 13C, and 14A to 14C (second means for outputting printing act data (second means for outputting refused operation data)). Further, the data management computer 18 can output the printing act data after being divided for each of predetermined periods such as days, weeks, or months.

(E-Mail Transmission Management)

The data management computer 18 fetches e-mail transmission data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the e-mail transmission data, network identification data, and user computer identification data acquired from the data relay servers 17A/17B (means for decrypting e-mail transmission data). The data management computer 18 divides the decrypted e-mail transmission data for each of the networks 16A to 16D based on the network identification data and also divides the e-mail transmission data for each of the user computers 11A to 11C, 12A to 12C, 13A to 13C, and 14A to 14C based on the user computer identification data.

The data management computer 18 stores the e-mail transmission data in a database in a state of being divided for each of the networks 16A to 16D (first means for storing e-mail transmission data (first means for storing permitted operation data)) and also stores the e-mail transmission data in the database in a state of being divided for each of the user computers 11A to 11C, 12A to 12C, 13A to 13C, and 14A to 14C (second means for storing e-mail transmission data (second means for storing permitted operation data)). The data management computer 18 can output the e-mail transmission data via an output device such as the display 23 or a printer. The data management computer 18 can output the e-mail transmission data after being divided for each of the networks 16A to 16D (first means for outputting e-mail transmission data (first means for outputting permitted operation data)) and also output the e-mail transmission data after being divided for each of the user computers 11A to 11C, 12A to 12C, 13A to 13C, and 14A to 14C (second means for outputting e-mail transmission data (second means for outputting permitted operation data)). Further, the data management computer 18 can output the e-mail transmission data after being divided for each of predetermined periods such as days, weeks, or months.

(Web Site Access Management)

The data management computer 18 fetches Web site access data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the Web site access data, network identification data, and user computer identification data acquired from the data relay servers 17A/17B (means for decrypting Web site access data). The data management computer 18 divides the decrypted Web site access data for each of the networks 16A to 16D based on the network identification data and also divides the Web site access data for each of the user computers 11A to 11C, 12A to 12C, 13A to 13C, and 14A to 14C based on the user computer identification data.

The data management computer 18 stores the Web site access data in a database in a state of being divided for each of the networks 16A to 16D (first means for storing Web site access data (first means for storing permitted operation data)) and also stores the Web site access data in the database in a state of being divided for each of the user computers 11A to 11C, 12A to 12C, 13A to 13C, and 14A to 14C (second means for storing Web site access data (second means for storing permitted operation data)). The data management computer 18 can output the Web site access data via an output device such as the display 23 or a printer. The data management computer 18 can output the Web site access data after being divided for each of the networks 16A to 16D (first means for outputting Web site access data (first means for outputting permitted operation data)) and also output the Web site access data after being divided for each of the user computers 11A to 11C, 12A to 12C, 13A to 13C, and 14A to 14C (second means for outputting Web site access data (second means for outputting permitted operation data)). Further, the data management computer 18 can output the Web site access data after being divided for each of predetermined periods such as days, weeks, or months.

(External Network Access Management)

The data management computer 18 fetches external network access data, network identification data, and user computer identification data sent from each of the device monitoring servers 15A to 15D at predetermined intervals (in hours such as 6-hour or 12-hour intervals, in days such as 1-day or 2-day intervals, and in the present embodiment, for each day (every 24 hours)) from the data relay servers 17A/17B and decrypts the external network access data, network identification data, and user computer identification data acquired from the data relay servers 17A/17B (means for decrypting external network access data). The data management computer 18 divides the decrypted external network access data for each of the networks 16A to 16D based on the network identification data and also divides the external network access data for each of the user computers 11A to 11C, 12A to 12C, 13A to 13C, and 14A to 14C based on the user computer identification data.

The data management computer 18 stores the external network access data in a database in a state of being divided for each of the networks 16A to 16D (first means for storing external network access data (first means for storing permitted operation data)) and also stores the external network access data in the database in a state of being divided for each of the user computers 11A to 11C, 12A to 12C, 13A to 13C, and 14A to 14C (second means for storing external network access data (second means for storing permitted operation data)). The data management computer 18 can output the external network access data via an output device such as the display 23 or a printer. The data management computer 18 can output the external network access data after being divided for each of the networks 16A to 16D (first means for outputting external network access data (first means for outputting permitted operation data)) and also output the external network access data after being divided for each of the user computers 11A to 11C, 12A to 12C, 13A to 13C, and 14A to 14C (second means for outputting external network access data (second means for outputting permitted operation data)). Further, the data management computer 18 can output the external network access data after being divided for each of predetermined periods such as days, weeks, or months.

The encryption method used by the device monitoring servers 15A to 15D and the data management computer 18 to encrypt various kinds of data is not limited and existing encryption methods such as the public key encryption method and the common key encryption method can be used. As the public key encryption method, one of the RSA cryptosystem, EPOC cryptosystem, Rabin cryptosystem, Diffie-Hellman key delivery ElGamal cryptosystem, and elliptic Diffie-Hellman key delivery ElGamal cryptosystem can be used. As the common key encryption method, one of the DES cryptosystem, FEAL cryptosystem, IDEA cryptosystem, MISTY cryptosystem, MULTI cryptosystem, and RC2/4/5 cryptosystem can be used. As the key encryption method, moreover, the MIX encryption method that uses both the public key encryption method (RSA cryptosystem) and the common key encryption method (DES cryptosystem) can be used.

If various kinds of information are not sent from the device monitoring servers 15A to 15D to the data relay servers 17A/17B at predetermined intervals and instead, various kinds of information are sent from the device monitoring servers 15A to 15D to the data relay servers 17A/17B at irregular intervals or various kinds of information are not sent from the device monitoring servers 15A to 15D to the data relay servers 17A/17B, the data management computer 18 sends transmission incomplete information indicating a transmission incomplete state of such information to each of the device monitoring servers 15A to 15D by an e-mail. The administrator of the device monitoring servers 15A to 15D can know a failure of the device monitoring servers 15A to 15D or an incomplete network configuration from the transmission incomplete information sent from the data management computer 18 so that the administrator can swiftly take countermeasures against a failure or incomplete configuration. Since congestions of transmission of various kinds information can be prevented, various kinds information about the networks 16A to 16D can reliably be acquired and usage states and operation states of the user computers 11A to 11C, 12A to 12C, 13A to 13C, and 14A to 14C can reliably be grasped and monitored.

(Authentication Procedure)

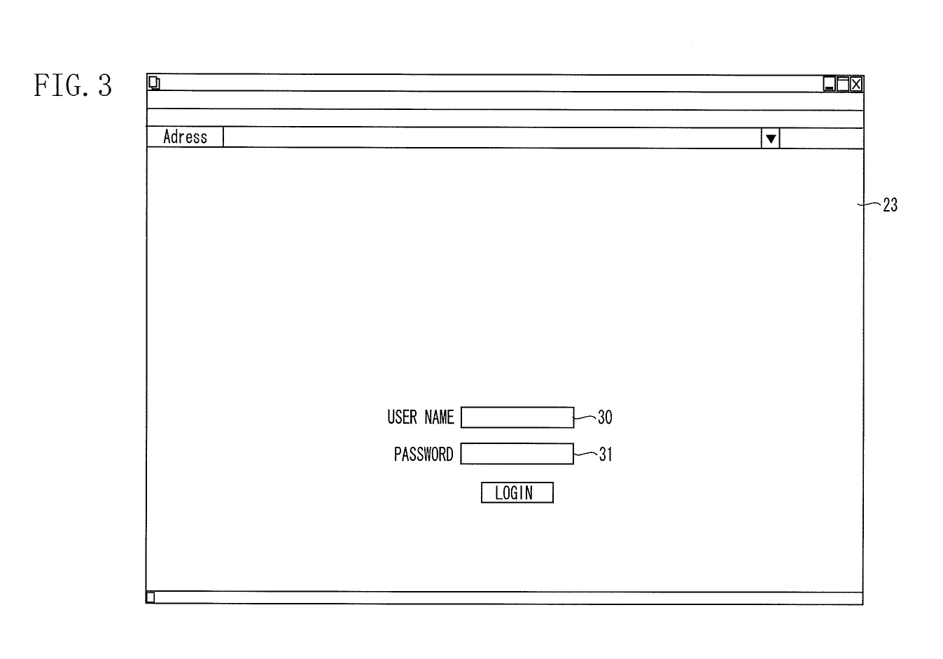

FIG. 3 is a diagram exemplifying a display screen of an authentication procedure displayed in the display of the device monitoring servers 15A to 15D or the data management computer 18. In FIG. 3, the display of concrete content of each item is omitted. The data management computer 18 performs authentication of the device monitoring servers 15A to 15D or the management computer when these computers are started up (means for performing authentication). A purpose of authentication is to judge whether a person who starts up the data management computer 18 is an authorized system administrator. Another purpose of authentication is to judge whether to allow the device monitoring servers 15A to 15D to log in to the data management computer 18. In other words, whether the device monitoring servers 15A to 15D attempting to log in to the data management computer 18 are servers in this system is checked. The authentication method executed by the data management computer 18 is password authentication, but in addition to the password authentication, fingerprint authentication, voice authentication, retinal authentication, and IC card authentication can also be performed. As the password authentication, a one-time password can be used.

When the device monitoring servers 15A to 15D or the data management computer 18 is started up, as shown in FIG. 3, an input area 30 of the user name and an input area 31 of the password are displayed in a display 23 thereof. The system administrator or the administrator of the device monitoring servers 15A to 15D inputs the user name and password into the input areas 30 and 31 respectively. The data management computer 18 compares the input user name and password with those stored in the memory to judge whether the user name and password are correct. If the user name and password are correct and the authentication result is successful, the data management computer 18 allows the use of the data management computer 18. The data management computer 18 also allows the device monitoring servers 15A to 15D to log in to the data management computer 18. If the user name or password is incorrect and the authentication result is unsuccessful, the data management computer 18 prohibits the use of the data management computer 18 and displays a message of usage prohibition in the display 23. The data management computer 18 also prohibits the device monitoring servers 15A to 15D from logging in to the data management computer 18 and causes the display thereof to display a message of disabled login. If authentication is performed during startup of the data management computer 18 or during login to the data management computer 18 and authentication information is incorrect, the use of the data management computer 18 is disabled and login to the data management computer 18 is disabled and thus, illegal use of the device monitoring servers 15A to 15D and the data management computer 18 can be prevented and also illegal browsing of various kinds of information stored in a database or hard disk, falsification of information, and misappropriation of information can be prevented.

(Network Configuration Data)

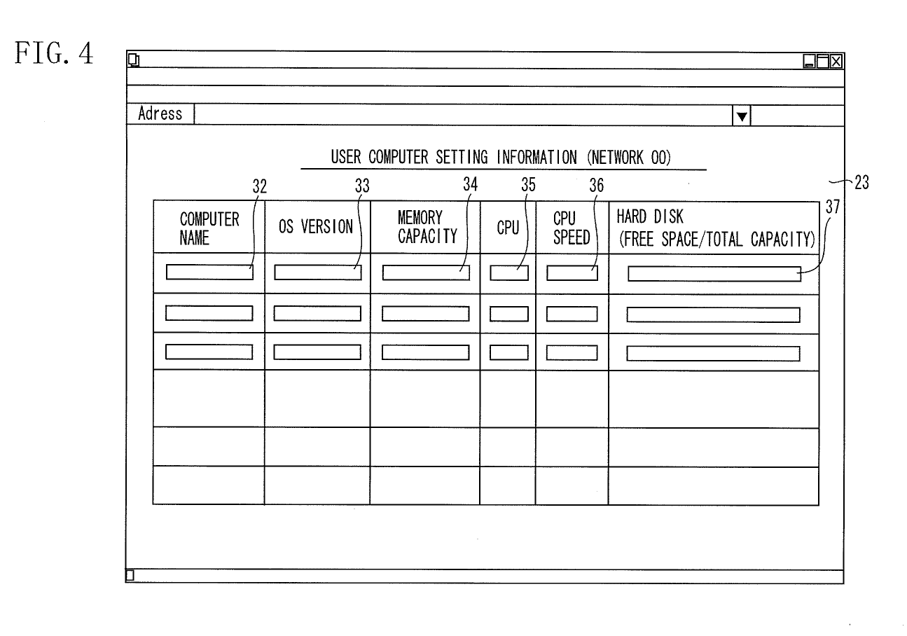

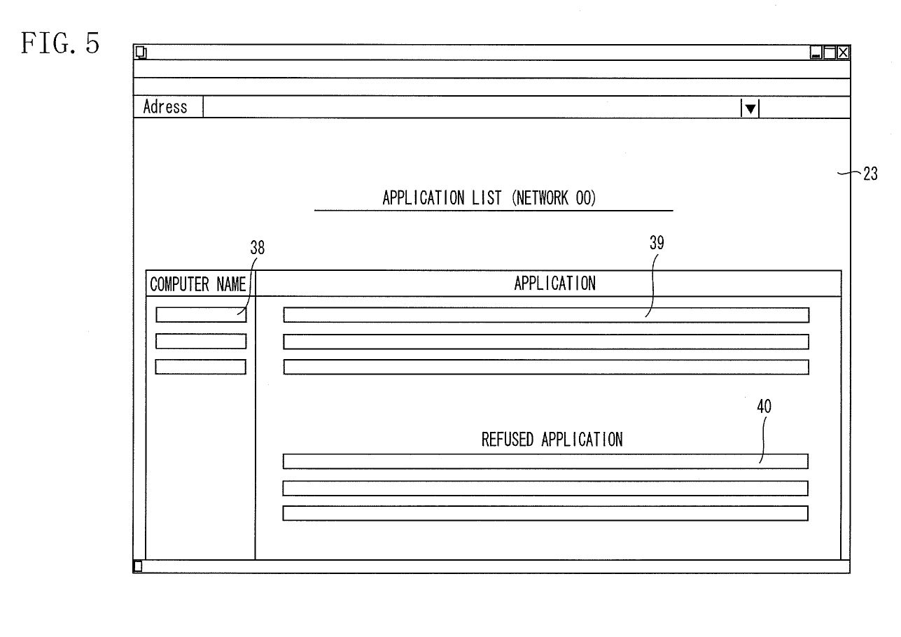

FIG. 4 is a diagram exemplifying user computer facility information and FIG. 5 is a diagram exemplifying a list of applications. In FIGS. 4 and 5, the display of concrete content of each item is omitted. The data management computer 18 displays facility information of the user computers 11A to 11C, 12A to 12C, 13A to 13C, and 14A to 14C acquired from the data relay servers 17A/17B, application data installed on the user computers 11A to 11C, 12A to 12C, 13A to 13C, and 14A to 14C, and refused application data by dividing the information/data for each of the network 16A to 16D and outputs the information/data from a printer (means for outputting network configuration data).

After making the data management computer 18 available by performing an authentication procedure, the system administrator selects Computer facility information from report items in a report display screen (not shown) displayed in the display 23 of the computer 18 and specifies the network 16A to 16D. After Computer facility information being selected and the network 16A to 16D being specified, the data management computer 18 identifies network identification data corresponding to the specified network 16A to 16D and user computer identification data and extracts network configuration data corresponding to the network identification data and the user computer 11A to 11C, 12A to 12C, 13A to 13C, and 14A to 14C corresponding to the user computer identification data from a database. Next, as shown in FIG. 4, the data management computer 18 displays computer facility information of each of the user computers 11A to 11C, 12A to 12C, 13A to 13C, and 14A to 14C present in the specified network 16A to 16D in the display 23 (means for outputting network configuration data). In FIG. 4, as the computer facility information, computer names are displayed in a computer name display area 32, OS versions in an OS version display area 33, memory capacities in a memory capacity display area 34, CPUs in a CPU display area 35, CPU speeds in a CPU speed display area 36, and hard disks (free space/total capacity) in a hard disk display area 37.

If an application list is selected from report items displayed in the display 23 and the network 16A to 16D is specified, the data management computer 18 identifies network identification data corresponding to the specified network 16A to 16D and user computer identification data and extracts network configuration data corresponding to the network identification data and the user computer 11A to 11C, 12A to 12C, 13A to 13C, and 14A to 14C corresponding to the user computer identification data from the database. Next, as shown in FIG. 5, the data management computer 18 displays a list of applications installed on each of the user computer 11A to 11C, 12A to 12C, 13A to 13C, and 14A to 14C in the network 16A to 16D in the display 23 and also displays refused applications held by the device monitoring servers 15A to 15D in the display 23 (means for outputting network configuration data).

In FIG. 5, computer names are displayed in a computer name display area 38, applications in an application display area 39, refused applications in a refused application display area 40. The system administrator can output each piece of data in FIGS. 4 and 5. The system administrator can grasp the hardware configuration of the user computers 11A to 11C, 12A to 12C, 13A to 13C, and 14A to 14C forming the networks 16A to 16D, applications installed on the user computers 11A to 11C, 12A to 12C, 13A to 13C, and 14A to 14C, and refused applications by using the computer facility information, application data, and refused application data so that the user computers 11A to 11C, 12A to 12C, 13A to 13C, and 14A to 14C and each application can be managed for each of the networks 16A to 16D.

(Unregistered Computer Connection Data)

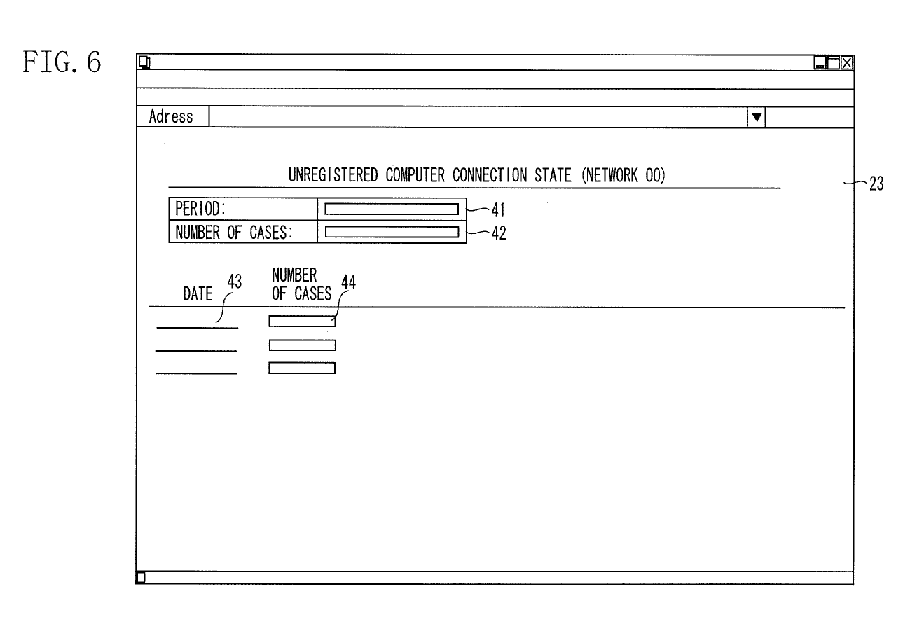

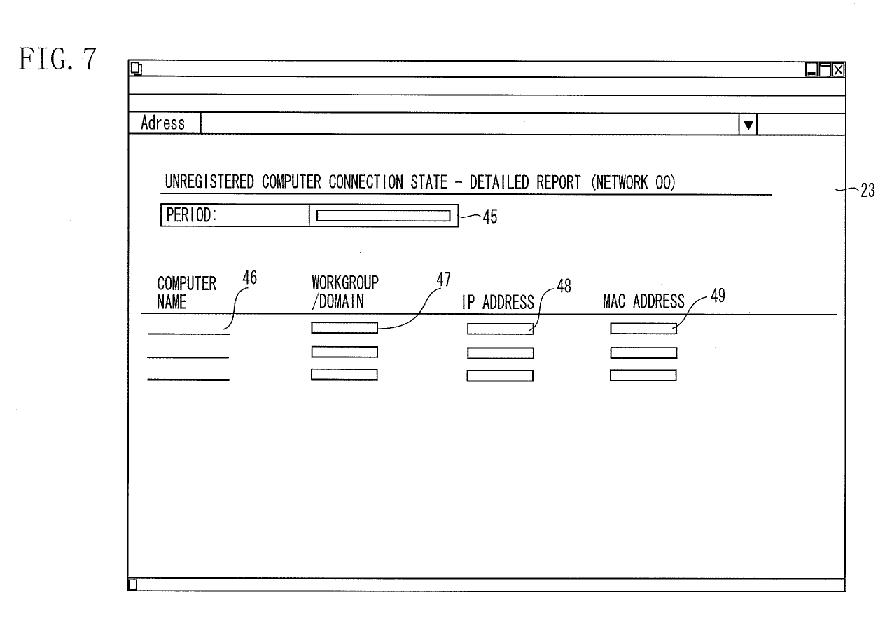

FIGS. 6 and 7 are diagrams exemplifying network connection data of unregistered computers and show a network connection history in days of the unregistered computers. In FIGS. 6 and 7, the display of concrete content of each item is omitted. The data management computer 18 displays unregistered computer connection data acquired from the data relay servers 17A/17B in the display 23 by dividing the data for each of the networks 16A to 16D and outputs the data from a printer (means for outputting unregistered computer connection data).

After making the data management computer 18 available by performing an authentication procedure, the system administrator selects (clicks) Unregistered computer connection data from report items in the report display screen (not shown) displayed in the display 23 of the computer 18, specifies the network 16A to 16D, and also specifies a period. After Unregistered computer connection data being selected and the network 16A to 16D and period being specified, the data management computer 18 identifies network identification data corresponding to the specified network 16A to 16D and extracts unregistered computer connection data corresponding to the network identification data from a database. Next, as shown in FIG. 6, the data management computer 18 displays unregistered computer connection data in the specified network 16A to 16D and period in the display 23 (means for outputting unregistered computer connection data). In FIG. 6, as the unregistered computer connection data, specified dates are displayed in a period display area 41, the total number of connections in the specified dates of the unregistered computer 21 in a number of cases display area 42, dates when the unregistered computer 21 is connected in a date display area 43, and the number of connections of the unregistered computer 21 in days in a number of cases display area 44.

If a date displayed in the date display area 43 in the screen of FIG. 6 is selected (clicked), as shown in FIG. 7, details of unregistered computer connection states on the selected date are displayed in the display 23. In FIG. 7, as details of unregistered computer connection states, the specified year/month/day is displayed in a period display area 45, unregistered computer names in a computer name display area 46, workgroups/domains of the unregistered computers 21 in a workgroup/domain display area 47, IP addresses of the unregistered computers 21 in an IP address display area 48, and MAC addresses of the unregistered computers 21 in a MAC address display area 49. The administrator can output unregistered computer connection states in FIGS. 6 and 7 from a printer.

In the system 10, unregistered computer connection data is sent from the device monitoring servers 15A to 15D to the data relay servers 17A/17B and the data management computer 18 manages the unregistered computer connection data acquired from the data relay servers 17A/17B by dividing the data for each of the networks 16A to 16D and therefore, connection of the unregistered computers 21 to the networks 16A to 16D can be grasped and monitored collectively for each of the networks 16A to 16D. Even if the unregistered computer 21 other than the user computers 11A to 11C, 12A to 12C, 13A to 13C, and 14A to 14C forming the networks 16A to 16D is brought in from outside and connected to the networks 16A to 16D, the system 10 can detect such a connection for each of the networks 16A to 16D and therefore, unlimited connections of the unregistered computer 21 to the networks 16A to 16D can be controlled collectively for each of the networks 16A to 16D. The system 10 can prevent connection of the unregistered computer 21 whose connection to the networks 16A to 16D is not qualified for each of the networks 16A to 16D and also prevent an illegal taking-out act of taking out various kinds of data in the networks 16A to 16D by storing such data in the unregistered computer 21.

(Specific Device Exclusion)

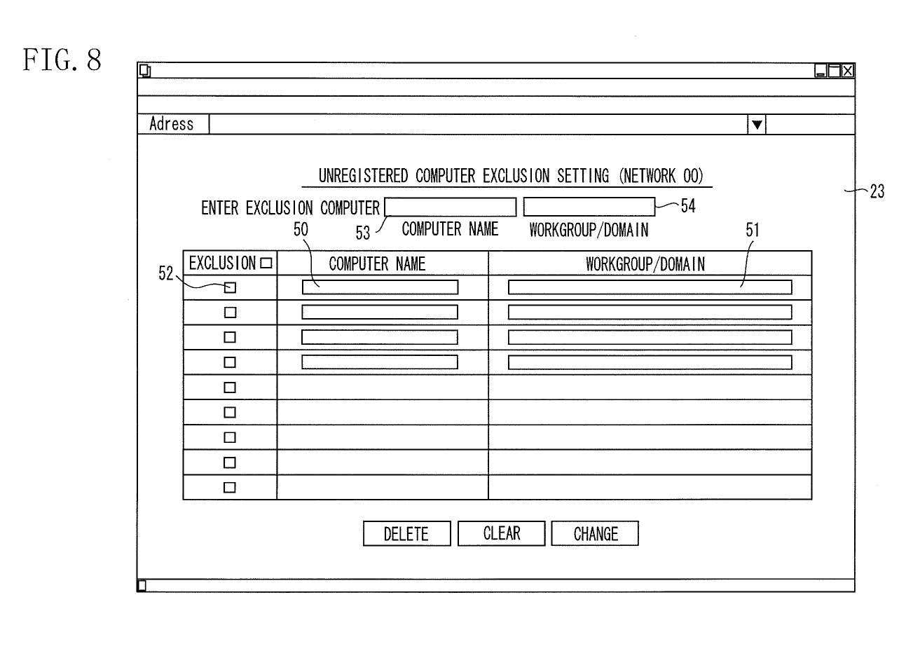

FIG. 8 is a diagram exemplifying an unregistered computer exclusion setting screen. In FIG. 8, the display of concrete content of each item is omitted. In the system 10, the data management computer 18 can exclude, among the unregistered computers 21 on which no operation data management application is installed, the specific computer 22 from the unregistered computers 21 (means for excluding a specific device). The data management computer 18 can also change the excluded specific computer 22 to the unregistered computer 21 again (means for changing a specific device). A description of an example of unregistered computer exclusion settings looks like the following.

After making the data management computer 18 available by performing an authentication procedure, the system administrator selects (clicks) Unregistered computer exclusion settings from report items in the report display screen (not shown) displayed in the display 23 of the computer 18 and specifies the network 16A to 16D. After Unregistered computer exclusion settings being selected and the network 16A to 16D being specified, an unregistered computer exclusion settings screen shown in FIG. 8 is displayed in the display 23. In the unregistered computer exclusion settings screen, a plurality of the unregistered computers 21 detected by the device monitoring server 15A to 15D in the specified network 16A to 16D is displayed. Computer names of the unregistered computers 21 are displayed in a computer name display area 50 of the unregistered computer exclusion settings screen and workgroups/domains of the unregistered computers 21 are displayed in a workgroup/domain display area 51.

The system administrator specifies the unregistered computer 21 by checking an exclusion designation checkbox 52 corresponding to the unregistered computer 21 to be changed so that the unregistered computer 21 to be changed from the unregistered computer 21 to the specific computer 22 is determined. If the system administrator clicks on a Change button of the screen after the exclusion designation checkbox 52 being checked, encrypted specific computer identification data of the computer identified by the checkmark is sent from the data management computer 18 to the data relay servers 17A/17B (means for sending specific device data). The system administrator can also change the unregistered computer 21 to the specific computer 22 by clicking on the Change button after inputting a computer name into a computer name input area 53 and a workgroup/domain into a workgroup/domain input area 54 determine the unregistered computer 21.

Conversely, the system administrator can change the specific computer 22 to the unregistered computer 21 by unchecking the exclusion designation checkbox 52 corresponding to the specific computer 22 to be changed so that the specific computer 22 to be changed from the specific computer 22 to the unregistered computer 21 is determined. If the system administrator clicks on the Change button of the screen after the exclusion designation checkbox 52 being unchecked, encrypted unregistered computer identification data of the unchecked computer is sent from the data management computer 18 to the data relay servers 17A/17B (means for sending unregistered device data).

If it becomes necessary for the specific computer 22 among the unregistered computers 21 to connect to the networks 16A to 16D, the system 10 can allow the specific computer 22 to connect to the networks 16A to 16D via the data management computer 18 for each of the networks 16A to 16D so that necessity of connection of the specific computer 22 to the networks 16A to 16D can be handled easily and swiftly. While it is necessary to distinguish the specific computer 22 from the unregistered computer 21 when the specific computer 22 is detected as the unregistered computers 21, if the specific computer 22 is connected to the networks 16A to 16D, the system 10 does not detect the specific computer 22 as the unregistered computer 21 and therefore, inconvenience of distinguishing the specific computer 22 from the unregistered computer 21 can be avoided. Further, when it becomes inappropriate to connect the specific computer 22 to the networks 16A to 16D, the system 10 can change the specific computer 22 to the unregistered computer 21 via the data management computer 18 so that connection of the specific computer 22 whose connection becomes inappropriate to the networks 16A to 16D can be controlled.

(Unregistered Computer Connection Data Transmission Interval)

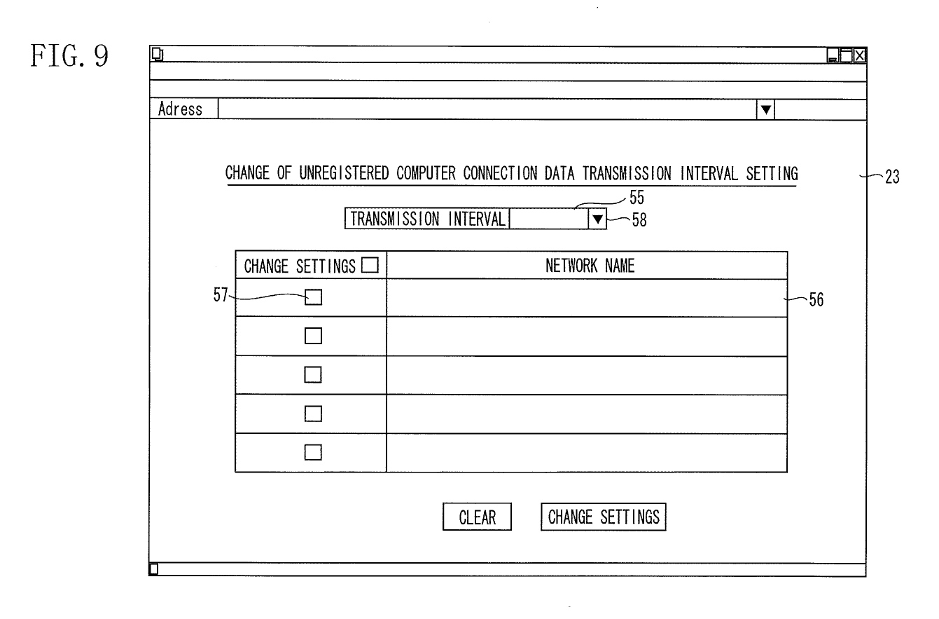

FIG. 9 is a diagram exemplifying a change screen of unregistered computer connection data transmission interval settings. In FIG. 9, the display of concrete content of each item is omitted. In the system 10, the data management computer 18 can set and change the transmission interval of unregistered computer connection data sent from the device monitoring servers 15A to 15D to the data relay servers 17A/17B (first means for changing the transmission interval). A description of an example of transmission interval settings/changes looks like the following. After making the data management computer 18 available by performing an authentication procedure, the system administrator selects (clicks) Change unregistered computer connection data transmission interval settings from report items in the report display screen (not shown) displayed in the display 23 of the computer 18. After Change unregistered computer connection data transmission interval settings being selected, the change screen of unregistered computer connection data transmission interval settings shown in FIG. 9 is displayed in the display 23. The transmission interval already set is displayed in a transmission interval display area 55 of the change screen of unregistered computer connection data transmission interval settings and the network name of each of the networks 16A to 16D is displayed in a network name display area 56.

The system administrator checks a setting change checkbox 57 corresponding to the network 16A to 16D whose transmission interval should be changed to specify the network 16A to 16D so that the network 16A to 16D whose transmission interval should be changed is determined. Further, the system administrator selects the transmission interval displayed in the transmission interval display area 55 from a drop-down list 58. When the system administrator clicks on a Change settings button after the setting change checkbox 57 being checked and the transmission interval being selected, encrypted transmission interval data of the network 16A to 16D identified by checking is sent from the data management computer 18 to the data relay servers 17A/17B (means for sending transmission interval data). The system 10 can freely set and change the transmission interval of unregistered computer connection data in the device monitoring servers 15A to 15D via the data management computer 18 and therefore, the transmission interval can be set differently for each of the networks 16A to 16D in accordance with network configuration conditions such as the device configuration and the number of devices so that the optimal transmission interval can be set for each of the networks 16A to 16D.

(Operation Data Transmission Interval)

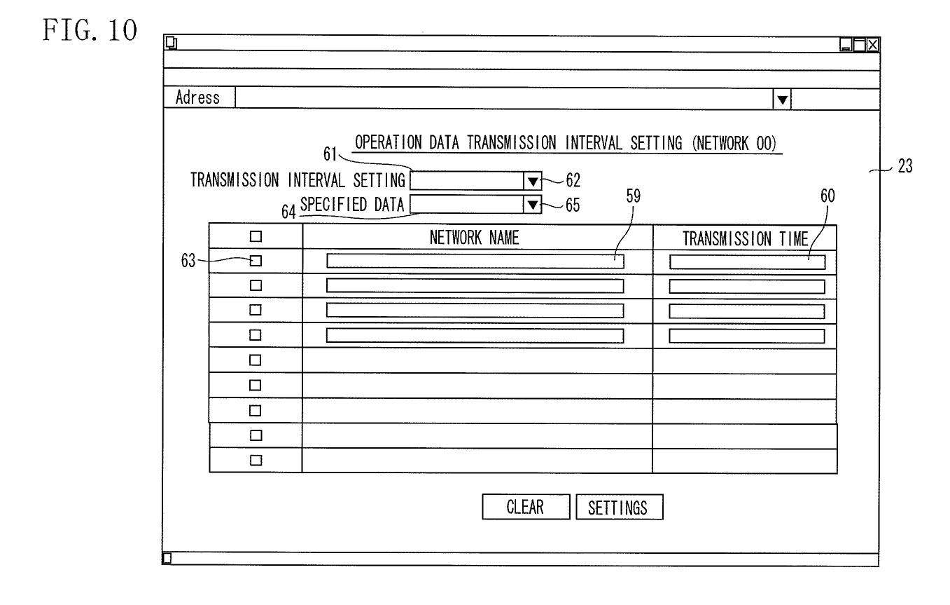

FIG. 10 is a diagram exemplifying a transmission interval setting change screen of various kinds of operation data. In FIG. 10, the display of concrete content of each item is omitted. In the system 10, the data management computer 18 can freely set and change the transmission interval (various operation data transmission interval) of various kinds of operation data (permitted operation data and refused operation data) of the user computers 11A to 11C, 12A to 12C, 13A to 13C, and 14A to 14C sent from the device monitoring servers 15A to 15D to the data relay servers 17A/17B (second means for changing the transmission interval). The data management computer 18 can also freely set and change the transmission interval (output interval) of various kinds of data sent (output) from the user computers 11A to 11C, 12A to 12C, 13A to 13C, and 14A to 14C to the device monitoring servers 15A to 15D for each of the networks 16A to 16D (means for changing the user computer transmission interval). An example of transmission interval settings/changes is as follows.

After making the data management computer 18 available by performing an authentication procedure, the system administrator selects (clicks) Operation data transmission interval settings from report items in the report display screen (not shown) displayed in the display 23 of the computer 18 and specifies the network 16A to 16D. After Operation data transmission interval settings being selected and the network 16A to 16D being specified, an operation data transmission interval setting screen is displayed. Network names are displayed in a network name display area 59 of the operation data transmission interval setting screen and transmission intervals already set are displayed in a transmission interval display area 60.

The system administrator selects the transmission interval displayed in a transmission interval setting area 61 from a drop-down list 62 to determine the transmission interval. If, after the transmission interval being determined, the transmission interval should be applied to all the networks 16A to 16D, a Settings button is selected (clicked) after all checkboxes 63 being checked. If the transmission interval should be applied to the specific network 16A to 16D, the Settings button is selected (clicked) after the checkbox 63 of the target network 16A to 16D to which the transmission interval is to be applied being checked. If the transmission interval should be applied to specific data of various kinds of operation data, data displayed in a specified data input area 64 is selected from a drop-down list 65. Data names displayed in the drop-down list 65 include the network configuration, usage history data, access history data, printing history data, file access history data, external access history data, extra-specified time usage history data, taking-out act data, printing act data, e-mail transmission data, Web site access data, and external network access data.

If the system administrator selects (clicks) the Settings button after the checkbox 63 being checked, encrypted transmission interval data of the network 16A to 16D identified by checking is sent from the data management computer 18 to the data relay servers 17A/17B (means for sending transmission interval data). If the system administrator selects (clicks) the Settings button after the checkbox 63 being checked and data displayed in the specified data input area 64 being selected from the drop-down list 65, encrypted transmission interval data of the network 16A to 16D identified by checking is sent from the data management computer 18 to the data relay servers 17A/17B (means for sending transmission interval data). The encrypted transmission interval data and network identification data ate held on the data relay servers 17A/17B.

In the system 10, the transmission interval of permitted operation data and refused operation data in the device monitoring servers 15A to 15D and the user computers 11A to 11C, 12A to 12C, 13A to 13C, and 14A to 14C can freely be set and changed via the data management computer 18 and therefore, the proper transmission interval can be set for each of the networks 16A to 16D and also the proper transmission interval can be set in accordance with various kinds of data. Moreover, the transmission interval can be set differently for each of the networks 16A to 16D in accordance with network configuration conditions such as the device configuration and the number of devices so that the optimal transmission interval can be set for each of the networks 16A to 16D.

(Data Transmission Destination Change)

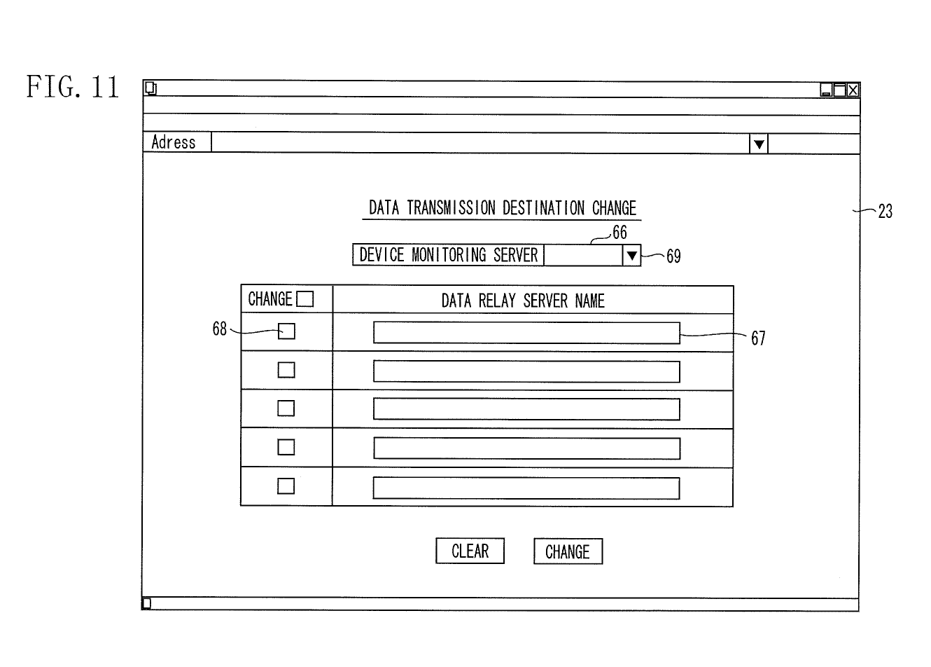

FIG. 11 is a diagram exemplifying a transmission destination change screen of various kinds of data. In FIG. 11, the display of concrete content of each item is omitted. In the system 10, the data management computer 18 can change the transmission destination of unregistered computer connection data sent from the device monitoring servers 15A to 15D and various kinds of operation data (permitted operation data and refused operation data) of the user computers 11A to 11C, 12A to 12C, 13A to 13C, and 14A to 14C from the predetermined data relay server 17A/17B to the other data relay server 17A/17B (means for changing the data transmission destination). An example of transmission interval settings/changes is as follows.

After making the data management computer 18 available by performing an authentication procedure, the system administrator selects (clicks) Change transmission destination from report items in the report display screen (not shown) displayed in the display 23 of the computer 18. After Change transmission destination being selected, a transmission destination change screen shown in FIG. 11 is displayed in the display 23. Server names are displayed in a device management server display area 66 of the transmission destination change screen and data relay server names are displayed in a data relay server name display area 67. A checkbox 68 of the data relay server 17A/17B that is the data transmission destination of the server 15A to 15D displayed in the device management server display area 66 is checked.

The system administrator selects the device monitoring server 15A to 15D displayed in the device management server display area 66 from a drop-down list 69. After the device monitoring server 15A to 15D being selected, the checkbox 68 of the data relay server 17A/17B that is the data transmission destination of the server 15A to 15D is checked. The system administrator changes the relay server by unchecking the checkbox 68 and checking the checkbox 68 of the other relay server. If the system administrator clicks on the Change button in the screen after the checkbox 68 of the other relay server being checked, transmission destination change data is sent from the data management computer 18 to each of the data relay servers 17A/17B to be changed (means for sending transmission destination data). The system 10 can freely select the proper data relay server 17A/17B in accordance with the storage capacity of each of the data relay servers 17A/17B and network configuration conditions such as the device configuration and the number of devices of the networks 16A to 16D taken charge of by the data relay servers 17A/17B and therefore, the storage capacity of the data relay servers 17A/17B can be prevented from being exceeded so that rejection of acceptance of various kinds of data by the data relay servers 17A/17B caused by the storage capacity thereof being exceeded can be prevented.

(Storage Capacity Management)

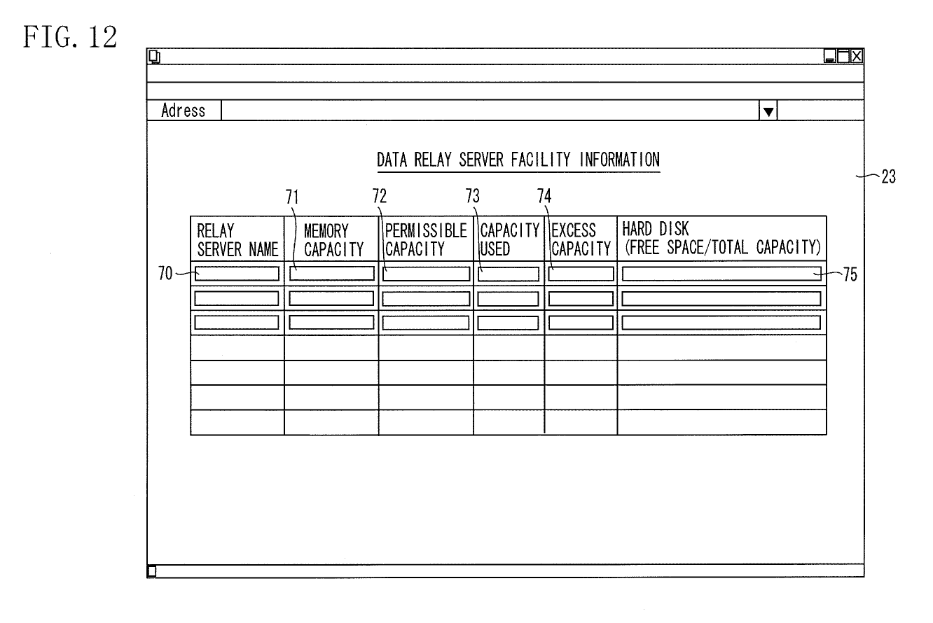

FIG. 12 is a diagram exemplifying data relay server facility information. In FIG. 12, the display of concrete content of each item is omitted. The data management computer 18 monitors the storage capacity of each of the data relay servers 17A/17B endlessly in chronological order (means for monitoring the storage capacity). The data management computer 18 displays facility information including exceeded storage capacity data of the data relay servers 17A/17B in the display 23 and also outputs the information from a printer (means for outputting exceeded storage capacity data).

After making the data management computer 18 available by performing an authentication procedure, the system administrator selects Data relay server facility information from report items in the report display screen (not shown) displayed in the display 23 of the computer 18 and specifies the data relay server 17A/17B. After Data relay server facility information being selected and the data relay server 17A/17B being specified, the data management computer 18 displays, as shown in FIG. 12, facility information of the data relay server 17A/17B in the display 23. In FIG. 12, as the data relay server facility information, data relay server names are displayed in a data relay server name display area 70, memory capacities in a memory capacity display area 71, permissible storage capacities in a permissible capacity display area 72, measured storage capacities in a used capacity display area 73, exceeded capacities in an exceeded capacity display area 74, and hard disks (free space/total capacity) in a hard disk display area 75. The system 10 can prevent the storage capacity of the data relay server 17A/17B from being exceeded via the data management computer 18 so that rejection of acceptance of each piece of data by the data relay servers 17A/17B caused by the storage capacity thereof being exceeded can be prevented.

(Log Data)

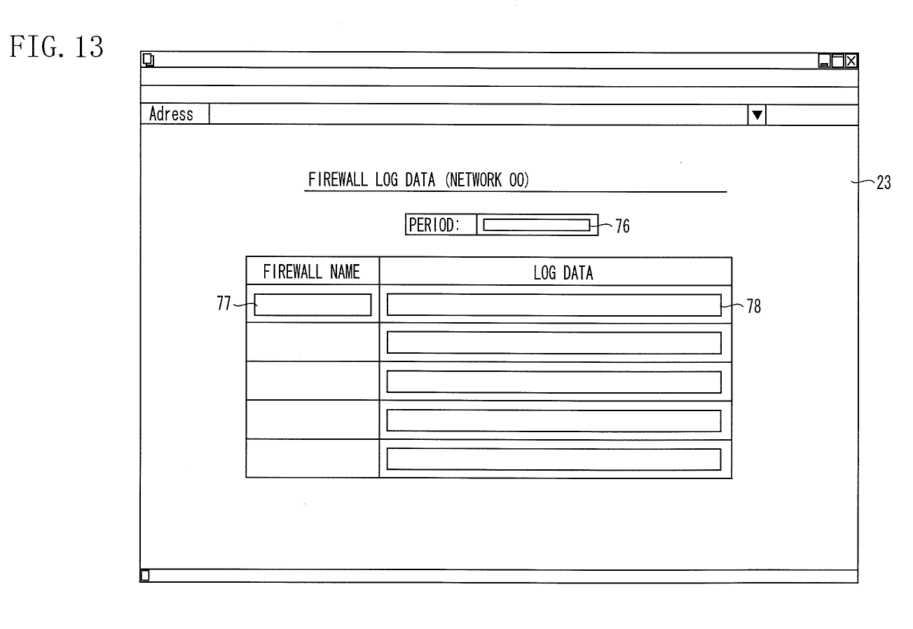

FIG. 13 is a diagram exemplifying log data of the firewall 19. In FIG. 13, the display of concrete content of each item is omitted. The data management computer 18 displays log data received from each of the firewalls 19 in the display 23 and also outputs the log data from a printer (means for outputting log data). After making the data management computer 18 available by performing an authentication procedure, the system administrator selects (clicks) Log data from report items in the report display screen (not shown) displayed in the display 23 of the computer 18 and specifies the network 16A to 16D and a firewall and also specifies a period. After Log data being selected and the network 16A to 16D, firewall, and period being specified, the data management computer 18 extracts log data corresponding to the specified network 16A to 16D from a database. Next, as shown in FIG. 13, the data management computer 18 displays log data corresponding to the specified network 16A to 16D, firewall, and period in the display 23. In FIG. 13, as the log data, the specified date is displayed in a period display area 76, firewall names in a firewall name display area 77, and content of log data in a log data display area 78. The system can grasp and monitor distribution of inappropriate data in the system 10 for each of the networks 16A to 16D by managing log data of inappropriate data sent from the user computers 11A to 11C, 12A to 12C, 13A to 13C, and 14A to 14C for each of the networks 16A to 16D so that diffusion of inappropriate data in the system 10 can be controlled.

(Usage History Data)

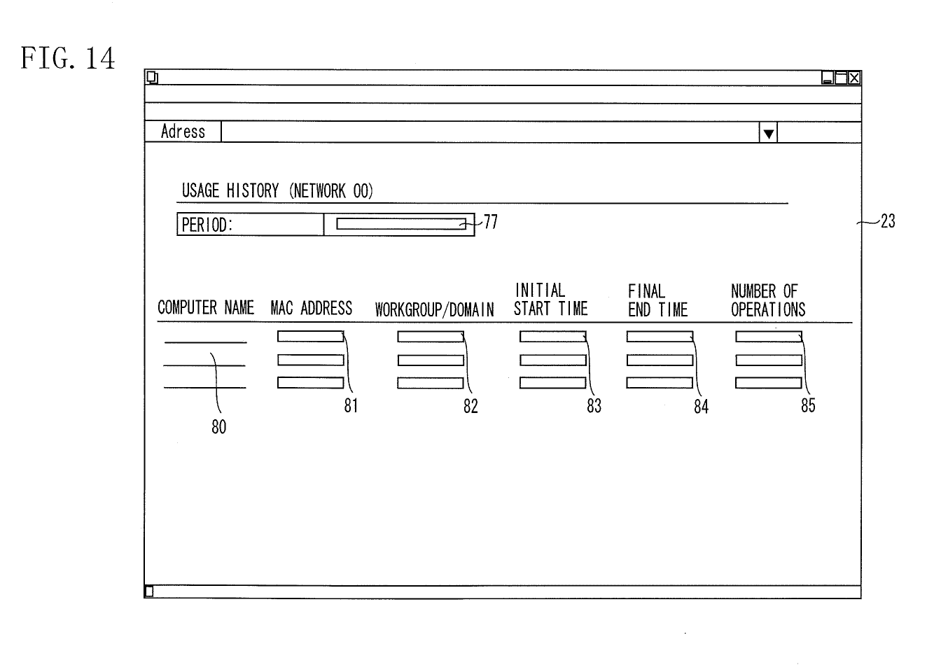

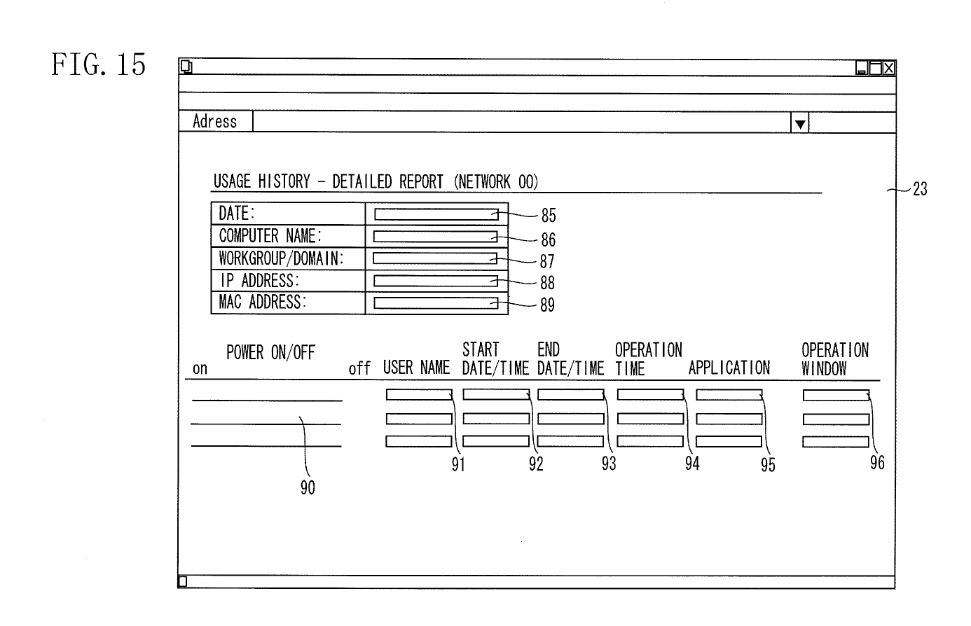

FIGS. 14 and 15 are diagrams exemplifying usage history data of applications and show a usage history of applications of the user computers 11A to 11C, 12A to 12C, 13A to 13C, and 14A to 14C. In FIGS. 14 and 15, the display of concrete content of each item is omitted. The data management computer 18 displays usage history data of applications in the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting usage history data). The data management computer 18 also displays usage history data of applications in the display 23 by dividing the data for each of the user computers 11A to 11C, 12A to 12C, 13A to 13C, and 14A to 14C and also outputs the data from a printer (second means for outputting usage history data).

After making the data management computer 18 available by performing an authentication procedure, the system administrator selects (clicks) Usage history data from report items in the report display screen (not shown) displayed in the display 23 of the computer 18, specifies the network 16A to 16D, and also specifies a period. After Usage history data being selected and the network 16A to 16D and period being specified, the data management computer 18 determines network identification data and user computer identification data corresponding to the specified network 16A to 16D and extracts usage history data corresponding to the network identification data and usage history data corresponding to the user computer identification data from a database. Next, as shown in FIG. 14, the data management computer 18 displays an application usage history of the user computers 11A to 11C, 12A to 12C, 13A to 13C, and 14A to 14C in the specified network 16A to 16D and period in the display 23 (first means for outputting usage history data). In FIG. 14, as an example of the usage history information, the specified period is displayed in a period display area 79, computer names (computer names that used applications) in a computer name display area 80, MAC addresses in a MAC address display area 81, workgroups/domains in a workgroup/domain display area 82, initial start times in an initial start time display area 83, final end times in a final end time display area 84, and operation counts of applications in an operation count display area 84.

If a computer name displayed in an underlined portion of the screen in FIG. 14 is selected (clicked), as shown in FIG. 15, the data management computer 18 displays details of application usage history of the selected user computer 11A to 11C, 12A to 12C, 13A to 13C, or 14A to 14C in the display 23 (second means for outputting usage history data). In FIG. 15, as an example of details of the usage history data, a date is displayed in a date display area 85, a computer name in a computer name display area 86, a workgroup/domain in a workgroup/domain display area 87, an IP address in an IP address display area 88, and a MAC address in a MAC address display area 89. Further, power-on/off records are displayed in a power-on/off record display area 90, user names (user names of the user computers 11A to 11C, 12A to 12C, 13A to 13C, and 14A to 14C that used applications) in a user name display area 91, start dates/times (start dates/times of using applications) in a start date/time display area 92, end dates/times (end dates/times of using applications) in an end date/time display area 93, operation times (times of using applications) in an operating time display area 94, application names (application names used) in an application name display area 95, and operation window names (operation window names of applications used) in an operation window name display area 96. The system administrator can output the usage history data of applications in FIGS. 14 and 15 from a printer.

In the system 10, the data management computer 18 manages usage history data of applications by the user computers 11A to 11C, 12A to 12C, 13A to 13C, and 14A to 14C for each of the networks 16A to 16D or for each of the user computers 11A to 11C, 12A to 12C, 13A to 13C, and 14A to 14C and therefore, the system administrator can grasp application usage states of the user computers 11A to 11C, 12A to 12C, 13A to 13C, and 14A to 14C in each of the networks 16A to 16D via the data management computer 18 so that usage of applications by the user computers 11A to 11C, 12A to 12C, 13A to 13C, and 14A to 14C can be monitored for each of the networks 16A to 16D or for each of the user computers 11A to 11C, 12A to 12C, 13A to 13C, and 14A to 14C and also unrestricted use of applications can be controlled.

(Access History Data)

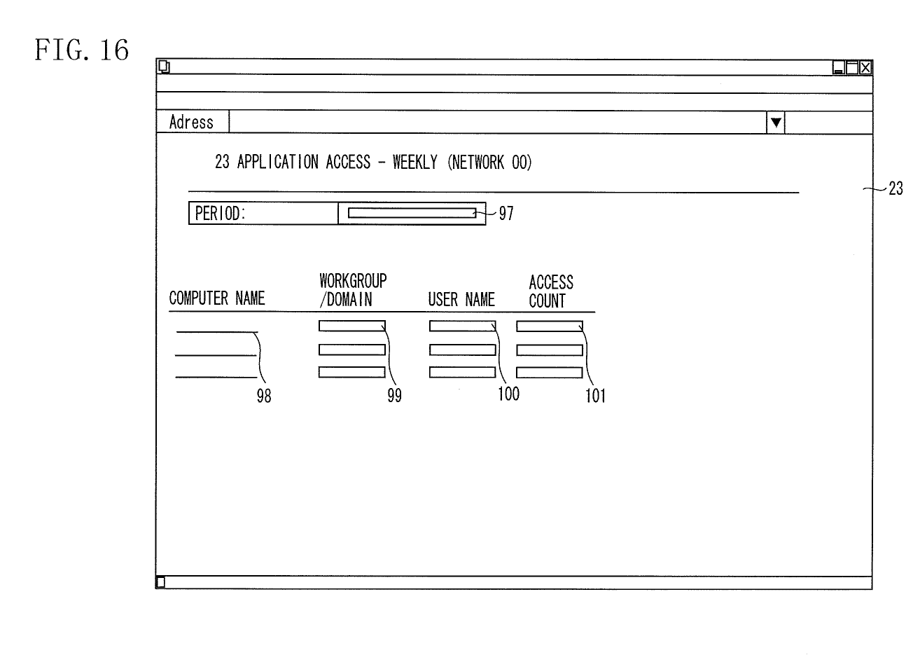

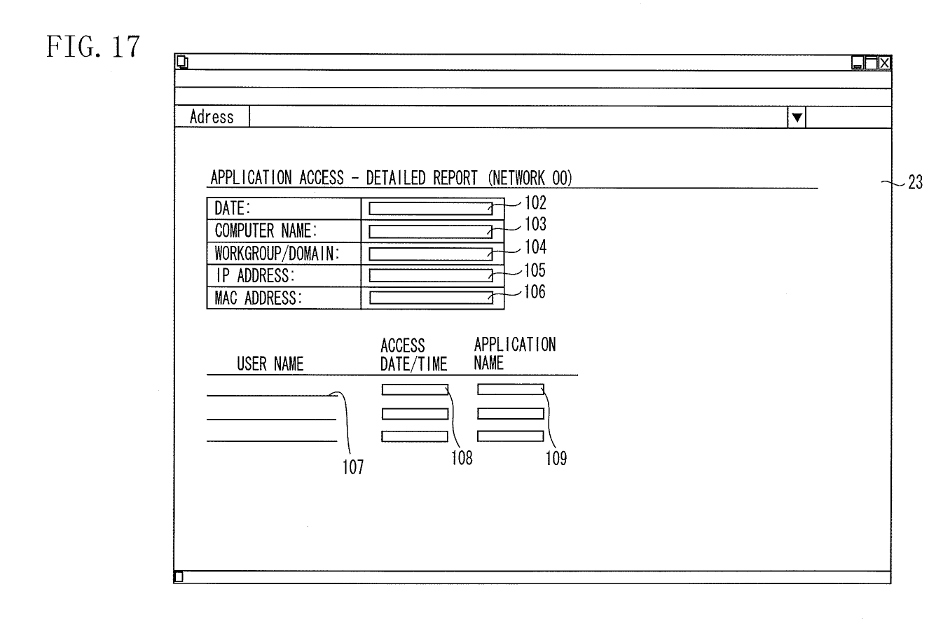

FIGS. 16 and 17 are diagrams exemplifying access history data and show a weekly access history of the user computers 11A to 11C, 12A to 12C, 13A to 13C, and 14A to 14C. In FIGS. 16 and 17, the display of concrete content of each item is omitted. The data management computer 18 displays access history data to refused applications in the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting access history data). The data management computer 18 also displays access history data to refused applications in the display 23 by dividing the data for each of the user computers 11A to 11C, 12A to 12C, 13A to 13C, and 14A to 14C and also outputs the data from a printer (second means for outputting access history data).

After making the data management computer 18 available by performing an authentication procedure, the system administrator selects (clicks) Access history data from report items in the report display screen (not shown) displayed in the display 23 of the computer 18, specifies the network 16A to 16D, and also specifies a period. After Access history data being selected and the network 16A to 16D and period being specified, the data management computer 18 determines network identification data and user computer identification data corresponding to the specified network 16A to 16D and extracts access history data corresponding to the network identification data and access history data corresponding to the user computer identification data from a database. Next, as shown in FIG. 16, the data management computer 18 displays access history data of refused applications of the user computers 11A to 11C, 12A to 12C, 13A to 13C, and 14A to 14C in the specified network 16A to 16D and period in the display 23 (first means for outputting access history data). In FIG. 16, as an example of the access history information, the specified period is displayed in a period display area 97, computer names (names of computers that accessed refused applications) in a computer name display area 98, workgroups/domains in a workgroup/domain display area 99, user names (user names of computers that accessed refused applications) in a user name display area 100, and access counts (access counts to applications) in an access count display area 101.

If a computer name displayed in an underlined portion of the screen in FIG. 16 is selected (clicked), as shown in FIG. 17, the data management computer 18 displays details of access history of the selected user computer 11A to 11C, 12A to 12C, 13A to 13C, or 14A to 14C in the display 23 (second means for outputting access history data). In FIG. 17, as an example of details of the access history data, a date to a date (one week) are displayed in a date display area 102, a computer name in a computer name display area 103, a workgroup/domain in a workgroup/domain display area 104, an IP address in an IP address display area 105, and a MAC address in a MAC address display area 106. Further, user names are displayed in a user name display area 107, access dates/times (access dates/times to refused applications) in an access date/time display area 108, and application names (accessed refused applications) in an application name display area 109. The system administrator can output the access history data in FIGS. 16 and 17 from a printer.

In the system 10, the data management computer 18 manages access history data to refused applications of the user computers 11A to 11C, 12A to 12C, 13A to 13C, and 14A to 14C for each by the networks 16A to 16D or for each of the user computers 11A to 11C, 12A to 12C, 13A to 13C, and 14A to 14C and therefore, the system administrator can grasp access states to refused applications of the user computers 11A to 11C, 12A to 12C, 13A to 13C, and 14A to 14C in each of the networks 16A to 16D via the data management computer 18 so that access to refused applications by the user computers 11A to 11C, 12A to 12C, 13A to 13C, and 14A to 14C can be monitored for each of the networks 16A to 16D or for each of the user computers 11A to 11C, 12A to 12C, 13A to 13C, and 14A to 14C and also acts of access to refused applications can be controlled.

(Addition/Change/Deletion of Permitted Applications)

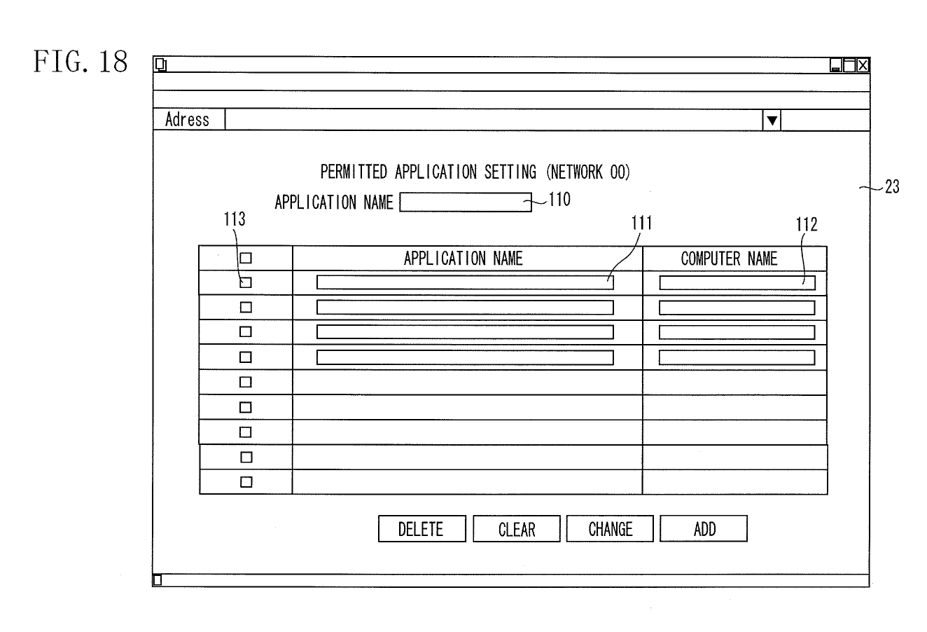

FIG. 18 is a diagram exemplifying a setting screen of adding, changing, or deleting applications. In FIG. 18, the display of concrete content of each item is omitted. The data management computer 18 can add, change, or delete an application the user computers 11A to 11C, 12A to 12C, 13A to 13C, and 14A to 14C forming each of the networks 16A to 16D are caused to use for each of the networks 16A to 16D (means for changing a permitted application). An example of adding an application is as follows. After making the data management computer 18 available by performing an authentication procedure, the system administrator selects (clicks) Application settings from report items in the report display screen (not shown) displayed in the display 23 of the computer 18 and also specifies the network 16A to 16D. After Application settings being selected and the network 16A to 16D being specified, an application setting screen is displayed.

The system administrator inputs an application name into an application name input area 110 to determine the application user computers 11A to 11C, 12A to 12C, 13A to 13C, and 14A to 14C are caused to use. Application software corresponding to the application name is stored in the hard disk of the data management computer 18. If the system administrator selects (clicks) an Add button after the application name being input, as shown in FIG. 18, the application name is displayed in an application name display area 111 and user computer names forming the specified network 16A to 16D are displayed in a computer name display area 112. If the application to be added should be applied to all the user computers 11A to 11C, 12A to 12C, 13A to 13C, and 14A to 14C, the Add button is selected (clicked) after all checkboxes 113 being checked. If the application to be added should be applied only to the specific user computer 11A to 11C, 12A to 12C, 13A to 13C, or 14A to 14C, the Add button is selected (clicked) after the checkbox 113 of the computer to which the application should be applied being checked.

If the system administrator selects (clicks) the Add button after the checkbox 113 being checked, the data management computer 18 encrypts the input application name, application software, and add commands and attaches network identification data and user computer identification data to the encrypted application name before sending these to the data relay servers 17A/17B. The encrypted application name, application software, and add commands and the network identification data and user computer identification data are held on the data relay servers 17A/17B. If the application should be applied to all the user computers 11A to 11C, 12A to 12C, 13A to 13C, and 14A to 14C, only network identification data is attached to the encrypted application name and the encrypted application name, application software, and add commands and the network identification data are held on the data relay servers 17A/17B.

The device monitoring servers 15A to 15D decrypt the new application name, application software, and add commands acquired from the data relay servers 17A/17B and then store these in a hard disk and also store user computer identification data of the user computers 11A to 11C, 12A to 12C, 13A to 13C, and 14A to 14C caused to use the application in the hard disk. If the application should be added to all the user computers 11A to 110, 12A to 12C, 13A to 13C, and 14A to 14C, new application software is downloaded (installed) from the device monitoring servers 15A to 15D to all the user computers 11A to 11C, 12A to 12C, 13A to 13C, and 14A to 14C. If the application should be added only to the specified user computer 11A to 11C, 12A to 12C, 13A to 13C, or 14A to 14C, new application software is downloaded (installed) from the device monitoring servers 15A to 15D only to the computer identified by the user computer identification data.

In the system 10, even if it becomes necessary to cause all the user computers 11A to 11C, 12A to 12C, 13A to 13C, and 14A to 14C forming the networks 16A to 16D or the specific user computer 11A to 11C, 12A to 12C, 13A to 13C, or 14A to 14C to use a new application, the application can freely be added via the data management computer 18 and therefore, a request to use an application in the networks 16A to 16D can easily and swiftly be met. The system administrator can decide whether an application that newly becomes available can be used in each of the networks 16A to 16D and on each of the user computers 11A to 11C, 12A to 12C, 13A to 13C, and 14A to 14C and therefore, whether an application can be used can be managed for each of the networks 16A to 16D and each of the user computers 11A to 11C, 12A to 12C, 13A to 13C, and 14A to 14C so that unrestricted use of applications can be controlled.

An example of changing an application is as follows. After making the data management computer 18 available by performing an authentication procedure, the system administrator selects (clicks) Application settings from report items in the report display screen displayed in the display 23 of the computer 18 and also specifies the network 16A to 16D. After Application settings being selected and the network 16A to 16D being specified, the application setting screen is displayed. Next, the Change button in the application setting screen is selected (clicked). After the Change button being selected, application names are displayed in the application name display area 111 of the application setting screen and user computer names of the specified network 16A to 16D are displayed in the computer name display area 112 (FIG. 18 quoted).

The system administrator checks the checkbox 113 in the application setting screen to specify the application to be changed before determining the application that should be changed from a permitted application to a refused application. If the change of the application should be applied to all the user computers 11A to 11C, 12A to 12C, 13A to 13C, and 14A to 14C, all the checkboxes 113 are checked. If the change of the application should be applied to the specific user computer 11A to 11C, 12A to 12C, 13A to 13C, or 14A to 14C, the checkbox 113 of the computer to be applied is checked.

If the system administrator selects (clicks) the Change button after the checkbox 113 being checked, the data management computer 18 encrypts the application name identified by checking and change commands and attaches network identification data and user computer identification data to the encrypted application name before sending these to the data relay servers 17A/17B. The encrypted application name and change commands and the network identification data and user computer identification data are held on the data relay servers 17A/17B. If the application should be changed for all the user computers 11A to 11C, 12A to 12C, 13A to 13C, and 14A to 14C, only network identification data is attached to the encrypted application name and the encrypted application name and change commands and the network identification data are held on the data relay servers 17A/17B.

The device monitoring servers 15A to 15D decrypt the application name and change commands acquired from the data relay servers 17A/17B and then store these in a hard disk and also store user computer identification data of the user computers 11A to 11C, 12A to 12C, 13A to 13C, and 14A to 14C for which the application should be changed in the hard disk. If the application should be changed for all the user computers 11A to 11C, 12A to 12C, 13A to 13C, and 14A to 14C, the specified application is uninstalled from all the user computers 11A to 11C, 12A to 12C, 13A to 13C, and 14A to 14C and the uninstalled application is stored in the hard disk of the device monitoring servers 15A to 15D as a refused application. If the application should be changed only for the specified user computer 11A to 11C, 12A to 12C, 13A to 13C, or 14A to 14C, the application is uninstalled from the computer identified by the user computer identification data and the uninstalled application is stored in the hard disk of the device monitoring servers 15A to 15D as a refused application.

In the system 10, even if it becomes necessary to change an application from a permitted application to a refused application in the user computers 11A to 110, 12A to 12C, 13A to 13C, and 14A to 14C forming the networks 16A to 16D or the specific user computer 11A to 11C, 12A to 12C, 13A to 13C, or 14A to 14C, the application can freely be changed via the data management computer 18 and therefore, a request to change an application to a refused application in the networks 16A to 16D can easily and swiftly be met. The system administrator can cause each of the networks 16A to 16D and each of the user computers 11A to 11C, 12A to 12C, 13A to 13C, and 14A to 14C to stop using the refused application and therefore, the stop of using the application can be managed for each of the networks 16A to 16D and each of the user computers 11A to 11C, 12A to 12C, 13A to 13C, and 14A to 14C so that unrestricted use of applications can be controlled.

An example of deleting an application is as follows. After making the data management computer 18 available by performing an authentication procedure, the system administrator selects (clicks) Application settings from report items in the report display screen displayed in the display 23 of the computer 18 and also specifies the network 16A to 16D. After Application settings being selected and the network 16A to 16D being specified, the application setting screen is displayed. Next, the Delete button in the application setting screen is selected (clicked). After the Delete button being selected, application names are displayed in the application name display area 111 of the application setting screen and user computer names of the specified network 16A to 16D are displayed in the computer name display area 112 (FIG. 18 quoted).

The system administrator checks the checkbox 113 in the application setting screen to specify the application to be deleted before determining the application that should be deleted. If the application should be deleted from all the user computers 11A to 11C, 12A to 12C, 13A to 13C, and 14A to 14C, all the checkboxes 113 are checked. If the application should be deleted from the specific user computer 11A to 11C, 12A to 12C, 13A to 13C, or 14A to 14C, the checkbox 113 of the target computer is checked. If the system administrator selects (clicks) the Delete button after the checkbox 113 being checked, the data management computer 18 encrypts the application name identified by checking and delete commands and attaches network identification data and user computer identification data to the encrypted application name before sending these to the data relay servers 17A/17B. The encrypted application name and delete commands and the network identification data and user computer identification data are held on the data relay servers 17A/17B. If the application should be deleted from all the user computers 11A to 11C, 12A to 12C, 13A to 13C, and 14A to 14C, only network identification data is attached to the encrypted application name and the encrypted application name and delete commands and the network identification data are held on the data relay servers 17A/17B.

The device monitoring servers 15A to 15D decrypt the application name and delete commands acquired from the data relay servers 17A/17B and then store these in a hard disk and also store user computer identification data of the user computers 11A to 11C, 12A to 12C, 13A to 13C, and 14A to 14C from which the application should be deleted in the hard disk. If the application should be deleted from all the user computers 11A to 11C, 12A to 12C, 13A to 13C, and 14A to 14C, the specified application is uninstalled from all the user computers 11A to 11C, 12A to 12C, 13A to 13C, and 14A to 14C. If the application should be deleted only from the specified user computer 11A to 11C, 12A to 12C, 13A to 13C, or 14A to 14C, the specified application is uninstalled from only the computer identified by the user computer identification data.

In the system 10, even if it becomes necessary to delete an application from all the user computers 11A to 11C, 12A to 12C, 13A to 13C, and 14A to 14C forming the networks 16A to 16D or the specific user computer 11A to 11C, 12A to 12C, 13A to 13C, or 14A to 14C, the application can freely be deleted via the data management computer 18 and therefore, a request to delete an application in the networks 16A to 16D can easily and swiftly be met. The system administrator can delete the application to be deleted from each of the networks 16A to 16D and each of the user computers 11A to 11C, 12A to 12C, 13A to 13C, and 14A to 14C and therefore, deletion of an application can be managed for each of the networks 16A to 16D and each of the user computers 11A to 11C, 12A to 12C, 13A to 13C, and 14A to 14C.

(Addition/Change/Deletion of Refused Applications)

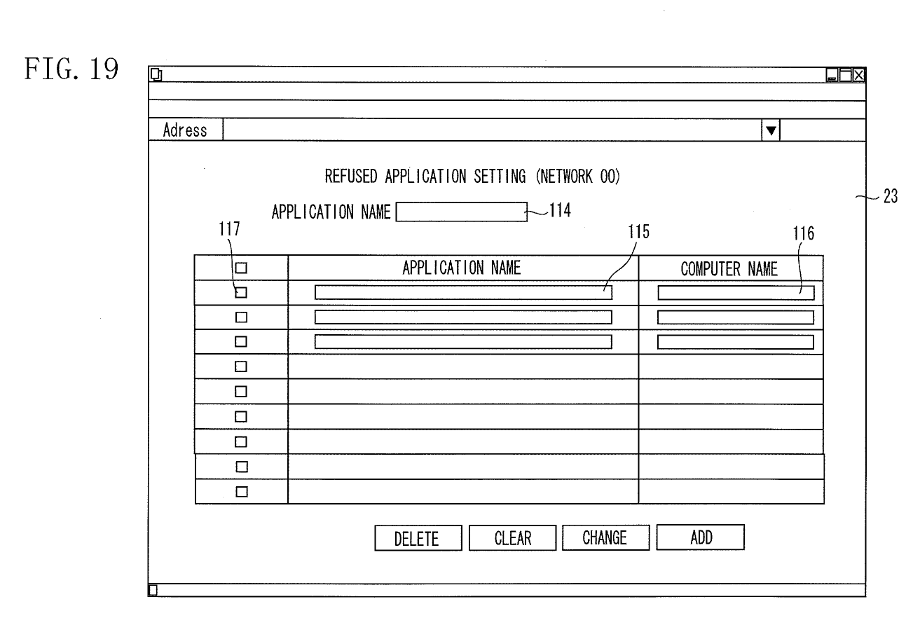

FIG. 19 is a diagram exemplifying a setting screen of adding, changing, or deleting refused applications. The data management computer 18 can add, change, or delete a refused application (means for changing a refused application). An example of adding a refused application is as follows. After making the data management computer 18 available by performing an authentication procedure, the system administrator selects (clicks) Refused application settings from report items in the report display screen (not shown) displayed in the display 23 of the computer 18 and also specifies the network 16A to 16D. After Refused application settings being selected and the network 16A to 16D being specified, a refused application setting screen is displayed.

The system administrator inputs a refused application name into an application name input area 114 to determine the refused application. Refused application software corresponding to the refused application name is stored in the hard disk of the data management computer 18. If the system administrator selects (clicks) the Add button after the refused application name being input, as shown in FIG. 19, the refused application name is displayed in an application name display area 115 and user computer names forming the specified network 16A to 16D are displayed in a computer name display area 116. If the refused application to be added should be applied to all the user computers 11A to 11C, 12A to 12C, 13A to 13C, and 14A to 14C, the Add button is selected (clicked) after all checkboxes 117 being checked. If the refused application to be added should be applied only to the specific user computer 11A to 11C, 12A to 12C, 13A to 13C, or 14A to 14C, the Add button is selected (clicked) after the checkbox 113 of the computer to which the refused application should be applied being checked.

If the system administrator selects (clicks) the Add button after the checkbox 117 being checked, the data management computer 18 encrypts the input refused application name, refused application software, and add commands and attaches network identification data and user computer identification data to the encrypted refused application name before sending these to the data relay servers 17A/17B. The encrypted refused application name, refused application software, and add commands and the network identification data and user computer identification data are held on the data relay servers 17A/17B. If the refused application should be applied to all the user computers 11A to 11C, 12A to 12C, 13A to 13C, and 14A to 14C, only network identification data is attached to the encrypted refused application name and the encrypted refused application name, refused application software, and add commands and the network identification data are held on the data relay servers 17A/17B.

The device monitoring servers 15A to 15D decrypt the refused application name, refused application software, and add commands acquired from the data relay servers 17A/17B and then store these in a hard disk and also store user computer identification data to which the refused application should be added in the hard disk. If the refused application should be applied to all the user computers 11A to 11C, 12A to 12C, 13A to 13C, and 14A to 14C, user computer identification data identifying all computers and the refused application software are stored in the hard disk of the device monitoring servers 15A to 15D. If the refused application should be applied only to the specified user computer 11A to 11C, 12A to 12C, 13A to 13C, or 14A to 14C, user computer identification data of only the computer identified by the user computer identification data and the refused application software are stored in the hard disk of the device monitoring servers 15A to 15D. In the system 10, an application that will not be used for the foreseeable future is installed (added) on the device monitoring servers 15A to 15D as a refused application in advance and when it becomes necessary to use the application, the application can be changed from a refused application to a permitted application so that use and non-use of the application can freely be selected when necessary.

An example of changing a refused application is as follows. After making the data management computer 18 available by performing an authentication procedure, the system administrator selects (clicks) Refused application settings from report items in the report display screen displayed in the display 23 of the computer 18 and also specifies the network 16A to 16D. After Refused application settings being selected and the network 16A to 16D being specified, the refused application setting screen is displayed. Next, the Change button in the refused application setting screen is selected (clicked). After the Change button being selected, refused application names are displayed in the application name display area 115 of the refused application setting screen and user computer names of the specified network 16A to 16D are displayed in the computer name display area 116 (FIG. 19 quoted).

The system administrator checks the checkbox 117 in the refused application setting screen to specify the refused application to be changed before determining the refused application that should be changed to a permitted application. If the refused application should be changed for all the user computers 11A to 11C, 12A to 12C, 13A to 13C, and 14A to 14C, all the checkboxes 117 are checked. If the refused application should be changed for the specific user computer 11A to 11C, 12A to 12C, 13A to 13C, or 14A to 14C, the checkbox 117 of the computer to be changed is checked.

If the system administrator selects (clicks) the Change button after the checkbox 117 being checked, the data management computer 18 encrypts the refused application name identified by checking and change commands and attaches network identification data and user computer identification data to the encrypted refused application name before sending these to the data relay servers 17A/17B. The encrypted refused application name and change commands and the network identification data and user computer identification data are held on the data relay servers 17A/17B. If the refused application should be changed for all the user computers 11A to 11C, 12A to 12C, 13A to 13C, and 14A to 14C, only network identification data is attached to the encrypted refused application name and the encrypted refused application name and change commands and the network identification data are held on the data relay servers 17A/17B.

The device monitoring servers 15A to 15D decrypt the refused application name and change commands acquired from the data relay servers 17A/17B and then store these in a hard disk and also store user computer identification data of the user computers 11A to 11C, 12A to 12C, 13A to 13C, and 14A to 14C for which the refused application should be changed in the hard disk. If the refused application should be changed for all the user computers 11A to 11C, 12A to 12C, 13A to 13C, and 14A to 14C, the specified refused application is changed from a refused application to a permitted application for all the user computers 11A to 11C, 12A to 12C, 13A to 13C, and 14A to 14C. The user computers 11A to 11C, 12A to 12C, 13A to 13C, and 14A to 14C can download (install) the application changed from a refused application to a permitted application from the device monitoring servers 15A to 15D.

In the system 10, even if it becomes necessary to cause all the user computers 11A to 11C, 12A to 12C, 13A to 13C, and 14A to 14C forming the networks 16A to 16D or the specific user computer 11A to 11C, 12A to 12C, 13A to 13C, or 14A to 14C to use a refused application, the refused application can freely be changed to a permitted application via the data management computer 18 and therefore, a request to use a refused application can easily and swiftly be met. In the system 10, the change from a refused application to a permitted application can be managed for each of the networks 16A to 16D or each of the user computers 11A to 11C, 12A to 12C, 13A to 13C, and 14A to 14C.

An example of deleting a refused application is as follows. After making the data management computer 18 available by performing an authentication procedure, the system administrator selects (clicks) Refused application settings from report items in the report display screen displayed in the display 23 of the computer 18 and also specifies the network 16A to 16D. After Refused application settings being selected and the network 16A to 16D being specified, the refused application setting screen is displayed. Next, the Delete button in the refused application setting screen is selected (clicked). After the Delete button being selected, refused application names are displayed in the application name display area 115 of the refused application setting screen and user computer names of the specified network 16A to 16D are displayed in the computer name display area 116 (FIG. 19 quoted).

The system administrator checks the checkbox 117 to determine the refused application that should be deleted. Refused application software corresponding to the refused application name is stored in the hard disk of the device monitoring servers 15A to 15D. If the system administrator selects (clicks) the Delete button after the checkbox 117 being checked, the data management computer 18 encrypts the refused application name identified by checking and delete commands and attaches network identification data to the encrypted refused application name before sending these to the data relay servers 17A/17B. The encrypted refused application name and delete commands and the network identification data are held on the data relay servers 17A/17B.

The device monitoring servers 15A to 15D decrypt the refused application name and delete commands acquired from the data relay servers 17A/17B and then store these in a hard disk. The device monitoring servers 15A to 15D uninstall the refused application stored in the hard disk thereof from the hard disk. In the system 10, deletion of refused application can be managed for each of the device monitoring servers 15A to 15D or each of the user computer 11A to 11C, 12A to 12C, 13A to 13C, or 14A to 14C. Even if it becomes necessary to delete a refused application, the system can freely delete the application and therefore, a request to delete a refused application can easily and swiftly be met so that refused applications can be tidied up easily.

(Installation Data)

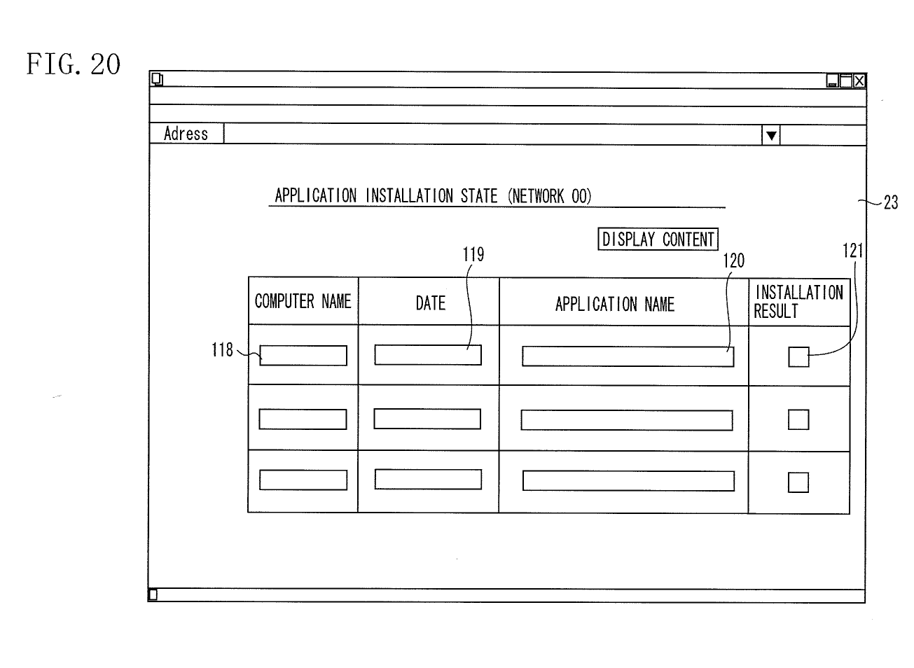

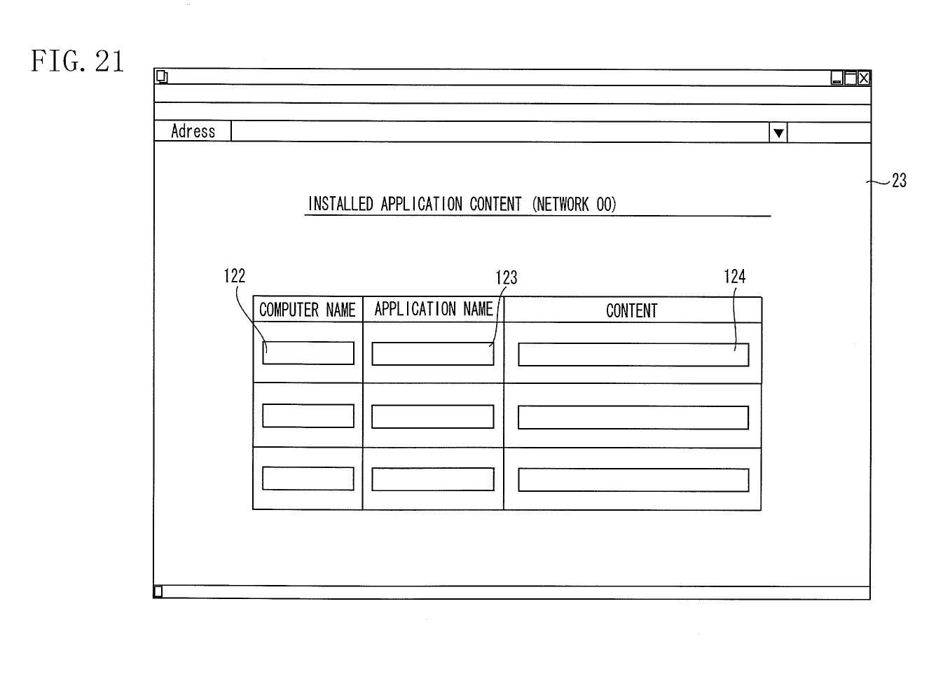

FIG. 20 is a diagram exemplifying application installation states and FIG. 21 is a diagram showing content of installed applications. In FIGS. 20 and 21, the display of concrete content of each item is omitted. The data management computer 18 displays installation data of permitted applications to the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting installation data). The data management computer 18 also displays installation data of permitted applications in the display 23 by dividing the data for each of the user computers 11A to 11C, 12A to 12C, 13A to 13C, and 14A to 14C and also outputs the data from a printer (second means for outputting installation data).

After making the data management computer 18 available by performing an authentication procedure, the system administrator selects (clicks) Installation data from report items in the report display screen (not shown) displayed in the display 23 of the computer 18 and specifies the network 16A to 16D. After Installation data being selected and the network 16A to 16D being specified, the data management computer 18 identifies network identification data corresponding to the specified network 16A to 16D and user computer identification data and extracts installation data corresponding to the network identification data and installation data corresponding to the user computer identification data from a database. Next, as shown in FIG. 20, the data management computer 18 displays installation data of permitted applications to the user computers 11A to 11C, 12A to 12C, 13A to 13C, and 14A to 14C in the specified network 16A to 16D (first means for outputting installation data). In FIG. 20, as the installation data, computer names (names of computers on which applications are installed) are displayed in a computer name display area 118, dates (installation dates) in a date display area 119, application names (names of installed applications) in an application name display area 120, and installation complete checking (not shown) in an installation result checkbox 121. If installation is not permitted, the checkbox 121 is blank.

If an application name is inverted in the screen in FIG. 20 and the display of content thereof is selected (clicked), as shown in FIG. 21, computer names are displayed in a computer name display area 122, application names in an application name display area 123, and content of installed applications in an application content display area 124. The system administrator can output installation data in FIGS. 20 and 21 from a printer. Content of installed application is an outline of applications such as document creation software, spreadsheet software, translation software, database construction software, communications software, and security software and when an application is installed on the data management software 18, the application is simultaneously input into the management computer 18 before being stored in the hard disk of the management computer 18.

In the system 10, the data management software 18 manages installation data of permitted applications on the user computers 11A to 11C, 12A to 12C, 13A to 13C, and 14A to 14C for each of the networks 16A to 16D or each of the user computers 11A to 11C, 12A to 12C, 13A to 13C, and 14A to 14C and therefore, the system administrator can reliably grasp installation states of permitted applications to the user computers 11A to 11C, 12A to 12C, 13A to 13C, and 14A to 14C in each of the networks 16A to 16D via the data management software 18 so that installation of applications on the user computers 11A to 11C, 12A to 12C, 13A to 13C, and 14A to 14C can be monitored for each of the networks 16A to 16D or each of the user computers 11A to 11C, 12A to 12C, 13A to 13C, and 14A to 14C.

(Uninstallation Information)

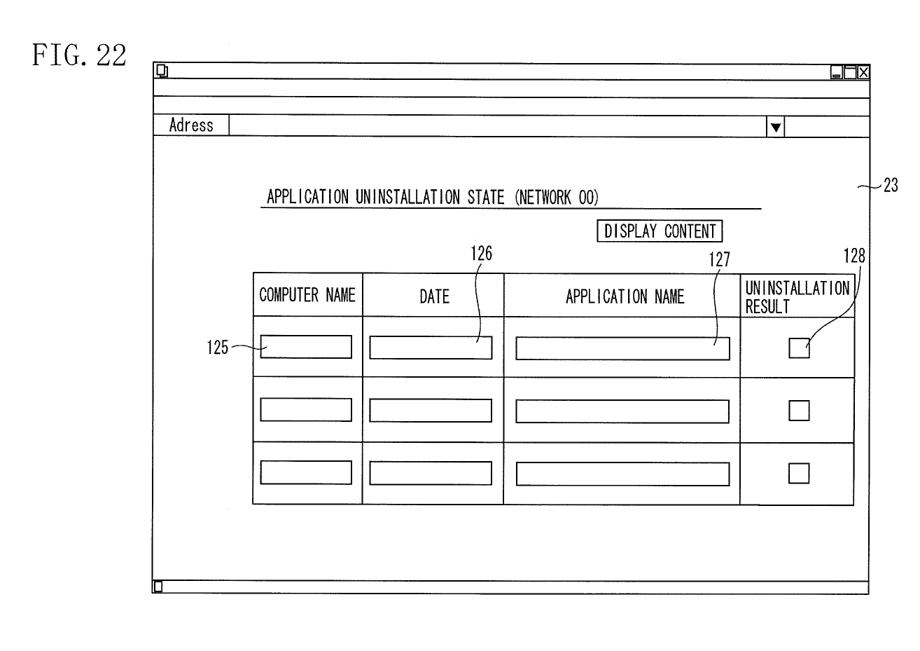

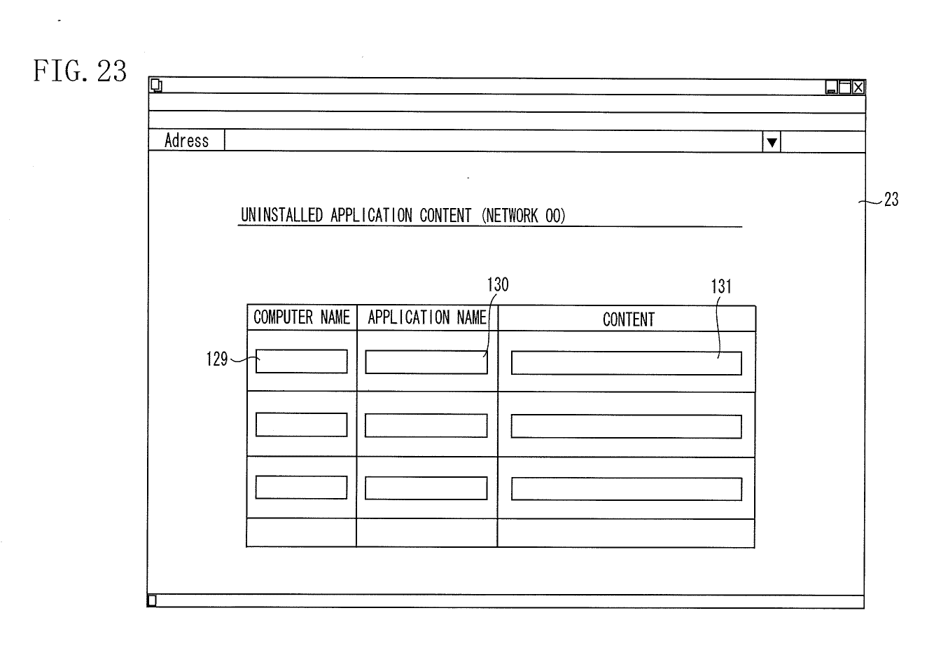

FIG. 22 is a diagram exemplifying application uninstallation states and FIG. 23 is a diagram showing content of uninstalled applications. In FIGS. 22 and 23, the display of concrete content of each item is omitted. The data management computer 18 displays uninstallation data of permitted applications from the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting uninstallation data). The data management computer 18 also displays uninstallation data of permitted applications in the display 23 by dividing the data for each of the user computers 11A to 11C, 12A to 12C, 13A to 13C, and 14A to 14C and also outputs the data from a printer (second means for outputting uninstallation data).

After making the data management computer 18 available by performing an authentication procedure, the system administrator selects (clicks) Uninstallation data from report items in the report display screen (not shown) displayed in the display 23 of the computer 18 and specifies the network 16A to 16D. After Uninstallation data being selected and the network 16A to 16D being specified, the data management computer 18 identifies network identification data corresponding to the specified network 16A to 16D and user computer identification data and extracts uninstallation data corresponding to the network identification data and uninstallation data corresponding to the user computer identification data from a database. Next, as shown in FIG. 22, the data management computer 18 displays uninstallation data of permitted applications from the user computers 11A to 11C, 12A to 12C, 13A to 13C, and 14A to 14C in the specified network 16A to 16D (first means for outputting uninstallation data). In FIG. 22, as the uninstallation data, computer names (names of computers from which applications are uninstalled) are displayed in a computer name display area 125, dates (uninstallation dates) in a date display area 126, application names (names of uninstalled applications) in an application name display area 127, and uninstallation complete checking (not shown) in an uninstallation result checkbox 128. If uninstallation is not permitted, the checkbox 128 is blank.

If an application name is inverted in the screen in FIG. 22 and the display of content thereof is selected (clicked), as shown in FIG. 23, computer names are displayed in a computer name display area 129, application names in an application name display area 139, and content of uninstalled applications in an application content display area 131. The system administrator can output uninstallation data in FIGS. 22 and 23 from a printer. Content of uninstalled application is an outline of applications such as document creation software, spreadsheet software, translation software, database construction software, communications software, and security software and when an application is installed on the data management software 18, the application is simultaneously input into the management computer 18 before being stored in the hard disk of the management computer 18.

In the system 10, the data management software 18 manages uninstallation data of permitted applications on the user computers 11A to 11C, 12A to 12C, 13A to 13C, and 14A to 14C for each of the networks 16A to 16D or each of the user computers 11A to 11C, 12A to 12C, 13A to 13C, and 14A to 14C and therefore, the system administrator can reliably grasp uninstallation states of permitted applications from the user computers 11A to 11C, 12A to 12C, 13A to 13C, and 14A to 14C in each of the networks 16A to 16D via the data management software 18 so that uninstallation of permitted applications on the user computers 11A to 11C, 12A to 12C, 13A to 13C, and 14A to 14C can be monitored for each of the networks 16A to 16D or each of the user computers 11A to 11C, 12A to 12C, 13A to 13C, and 14A to 14C. The system 10 can control unrestricted uninstallation of applications in each of the networks 16A to 16D.

(Printing History Data)

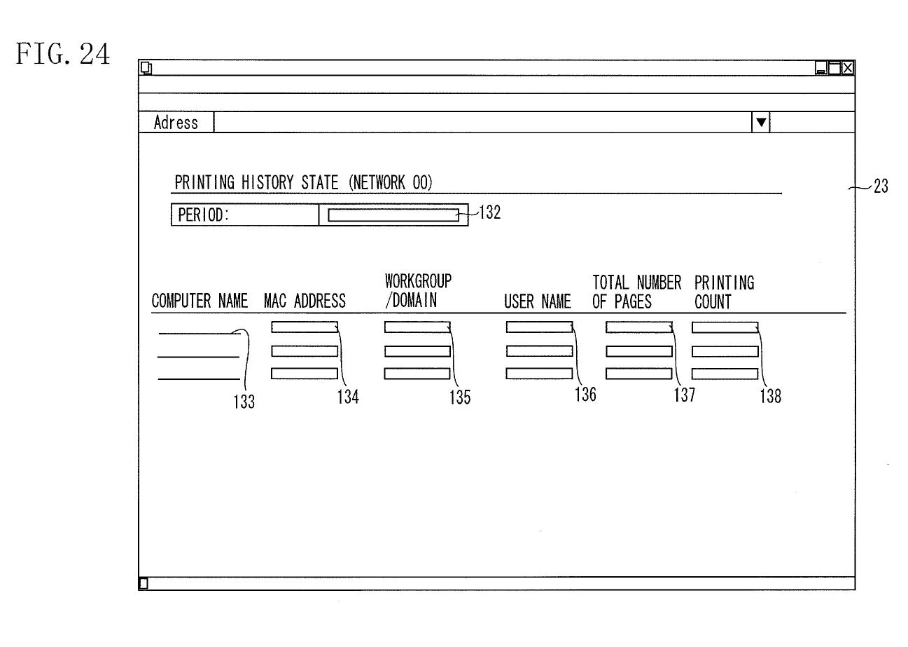

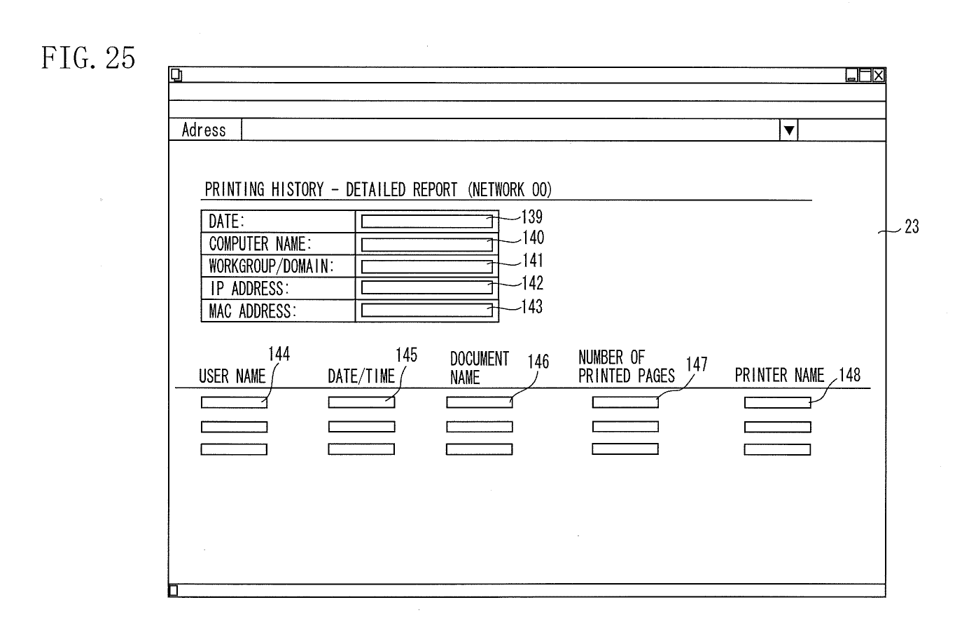

FIGS. 24 and 25 are diagrams exemplifying printing history data and show a weekly printing history of the user computers 11A to 11C, 12A to 12C, 13A to 13C, and 14A to 14C. In FIGS. 24 and 25, the display of concrete content of each item is omitted. The data management computer 18 displays printing history data of the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting printing history data). The data management computer 18 also displays printing history data in the display 23 by dividing the data for each of the user computers 11A to 11C, 12A to 12C, 13A to 13C, and 14A to 14C and also outputs the data from a printer (second means for outputting printing history data).

After making the data management computer 18 available by performing an authentication procedure, the system administrator selects (clicks) Printing history data from report items in the report display screen (not shown) displayed in the display 23 of the computer 18 and specifies the network 16A to 16D. After Printing history data being selected and the network 16A to 16D being specified, the data management computer 18 identifies network identification data corresponding to the specified network 16A to 16D and user computer identification data and extracts printing history data corresponding to the network identification data and printing history data corresponding to the user computer identification data from a database. Next, as shown in FIG. 24, the data management computer 18 displays printing history data of the user computers 11A to 11C, 12A to 12C, 13A to 13C, and 14A to 14C in the specified network 16A to 16D (first means for outputting printing history data). In FIG. 24, as the printing history data, a period is displayed in a period display area 132, computer names (names of computers that did printing) in a computer name display area 133, MAC addresses in a MAC address display area 134, workgroups/domains in a workgroup/domain display area 135, user names (user names of printers that did printing) in a user name display area 136, total numbers of print pages in a total print page number display area 137, and printing counts in a printing count display area 138.

If a computer name displayed in an underlined portion of the screen in FIG. 24 is selected (clicked), as shown in FIG. 25, the data management computer 18 displays details of printing history data of the selected user computer 11A to 11C, 12A to 12C, 13A to 13C, or 14A to 14C in the display 23 (second means for outputting printing history data). In FIG. 25, as details of the printing history, a date is displayed in a date display area 139, a computer name in a computer name display area 140, a workgroup/domain in a workgroup/domain display area 141, an IP address in an IP address display area 142, and a MAC address in a MAC address display area 143. Further, user names are displayed in a user name display area 144, printing dates/times in a printing date/time display area 145, document names in a document name display area 146, numbers of printing pages in a printing page number display area 147, and printer names in a printer name display area 148. The system administrator can output the printing history data in FIGS. 24 and 25 from a printer.

In the system 10, the data management software 18 manages printing history data of the user computers 11A to 11C, 12A to 12C, 13A to 13C, and 14A to 14C for each of the networks 16A to 16D or each of the user computers 11A to 11C, 12A to 12C, 13A to 13C, and 14A to 14C and therefore, the system administrator can reliably grasp printing states of the user computers 11A to 11C, 12A to 12C, 13A to 13C, and 14A to 14C in each of the networks 16A to 16D via the data management software 18 so that printing states in the user computers 11A to 11C, 12A to 12C, 13A to 13C, and 14A to 14C can be monitored for each of the networks 16A to 16D or each of the user computers 11A to 11C, 12A to 12C, 13A to 13C, and 14A to 14C and also unrestricted printing acts in the user computers 11A to 11C, 12A to 12C, 13A to 13C, and 14A to 14C can be controlled.

(File Access History Data)

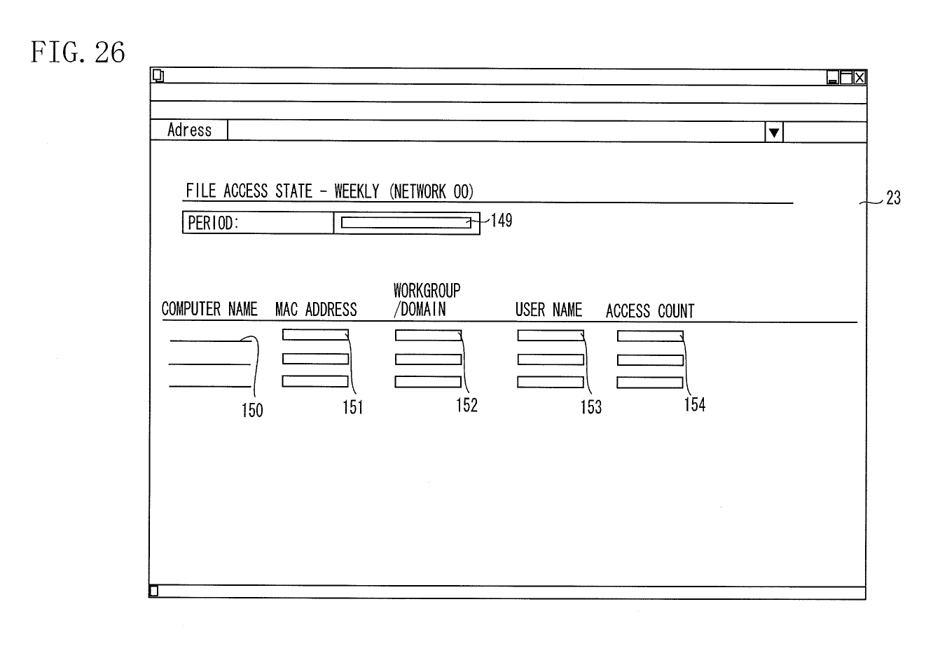

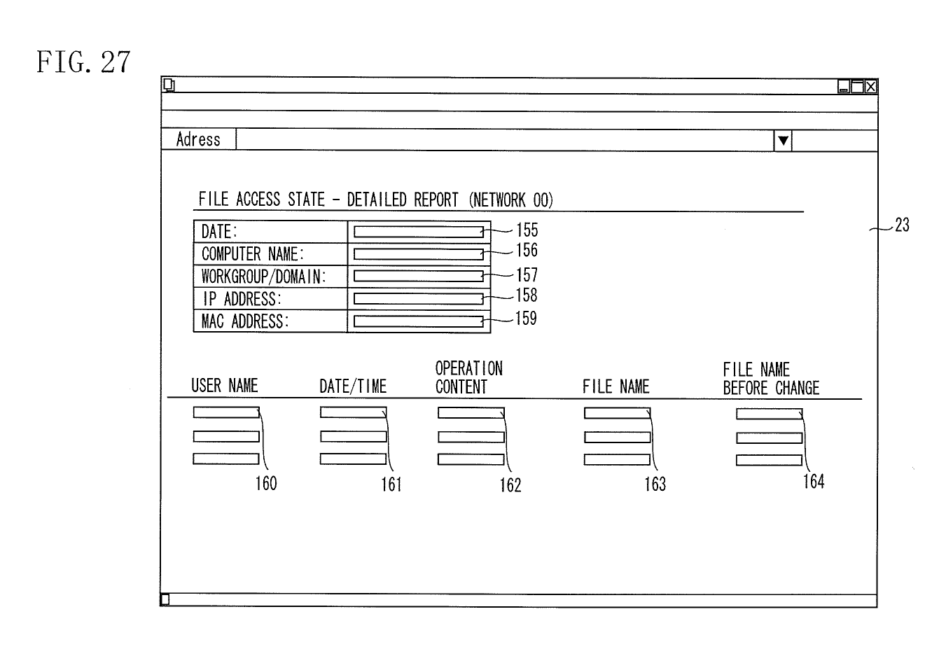

FIGS. 26 and 27 are diagrams exemplifying file access history data and show a weekly file access history of the user computers 11A to 11C, 12A to 12C, 13A to 13C, and 14A to 14C. In FIGS. 26 and 27, the display of concrete content of each item is omitted. The data management computer 18 displays file access history data of the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting file access history data). The data management computer 18 also displays file access history data in the display 23 by dividing the data for each of the user computers 11A to 11C, 12A to 12C, 13A to 13C, and 14A to 14C and also outputs the data from a printer (second means for outputting file access history data).

After making the data management computer 18 available by performing an authentication procedure, the system administrator selects (clicks) File access history data from report items in the report display screen (not shown) displayed in the display 23 of the computer 18 and specifies the network 16A to 16D. After File access history data being selected and the network 16A to 16D being specified, the data management computer 18 identifies network identification data corresponding to the specified network 16A to 16D and user computer identification data and extracts file access history data corresponding to the network identification data and file access history data corresponding to the user computer identification data from a database. Next, as shown in FIG. 26, the data management computer 18 displays file access history data of the user computers 11A to 11C, 12A to 12C, 13A to 13C, and 14A to 14C in the specified network 16A to 16D in the display 23 (first means for outputting file access history data). In FIG. 26, as the file access history data, the specified period is displayed in a period display area 149, computer names (names of computers that did access) in a computer name display area 150, MAC addresses in a MAC address display area 151, workgroups/domains in a workgroup/domain display area 152, user names (user names of computers that did printing) in a user name display area 153, and access counts in an access count display area 154.

If a computer name displayed in an underlined portion of the screen in FIG. 26 is selected (clicked), as shown in FIG. 27, the data management computer 18 displays details of file access history data of the selected user computer 11A to 11C, 12A to 12C, 13A to 13C, or 14A to 14C in the display 23 (second means for outputting file access history data). In FIG. 27, as details of the file access history data, a date is displayed in a date display area 155, a computer name in a computer name display area 156, a workgroup/domain in a workgroup/domain display area 157, an IP address in an IP address display area 158, and a MAC address in a MAC address display area 159. Further, user names are displayed in a user name display area 160, access dates/times in an access date/time display area 161, operation content (such as copying, cutting, write, deletion, holder creation, and name change) in a file access history display area 162, file names in a file name display area 163, and file names before change in a file name before change display area 164. The system administrator can output the file access history data in FIGS. 26 and 27 from a printer.

In the system 10, the data management software 18 manages file access data of the user computers 11A to 11C, 12A to 12C, 13A to 13C, and 14A to 14C for each of the networks 16A to 16D or each of the user computers 11A to 11C, 12A to 12C, 13A to 13C, and 14A to 14C and therefore, the system administrator can reliably grasp file access states of the user computers 11A to 11C, 12A to 12C, 13A to 13C, and 14A to 14C in each of the networks 16A to 16D via the data management software 18 so that file access states in the user computers 11A to 11C, 12A to 12C, 13A to 13C, and 14A to 14C can be monitored for each of the networks 16A to 16D or each of the user computers 11A to 11C, 12A to 12C, 13A to 13C, and 14A to 14C and also unrestricted file access acts in the user computers 11A to 11C, 12A to 12C, 13A to 13C, and 14A to 14C can be controlled.

(External Usage History Data)

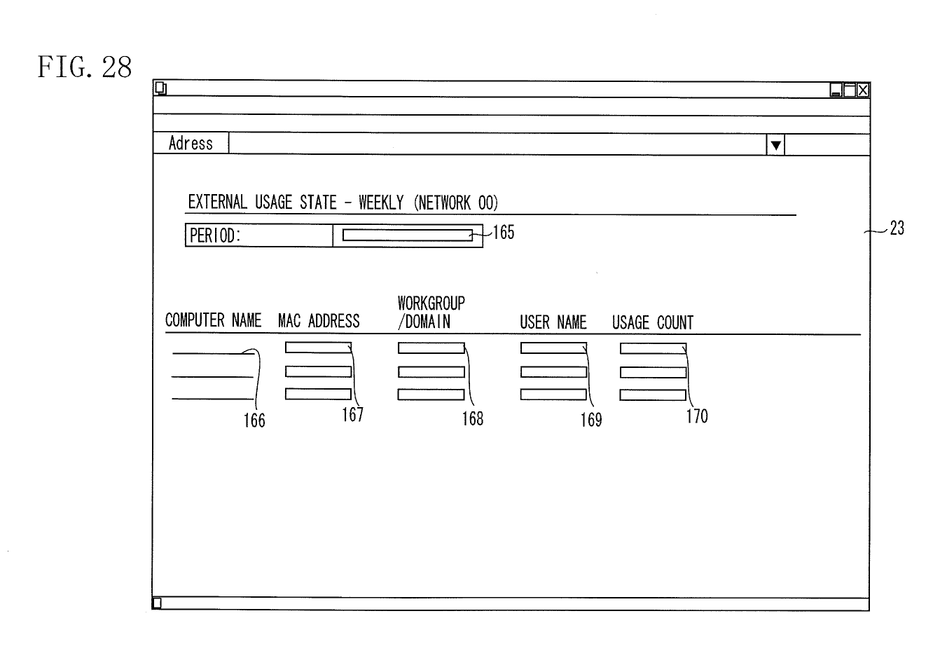

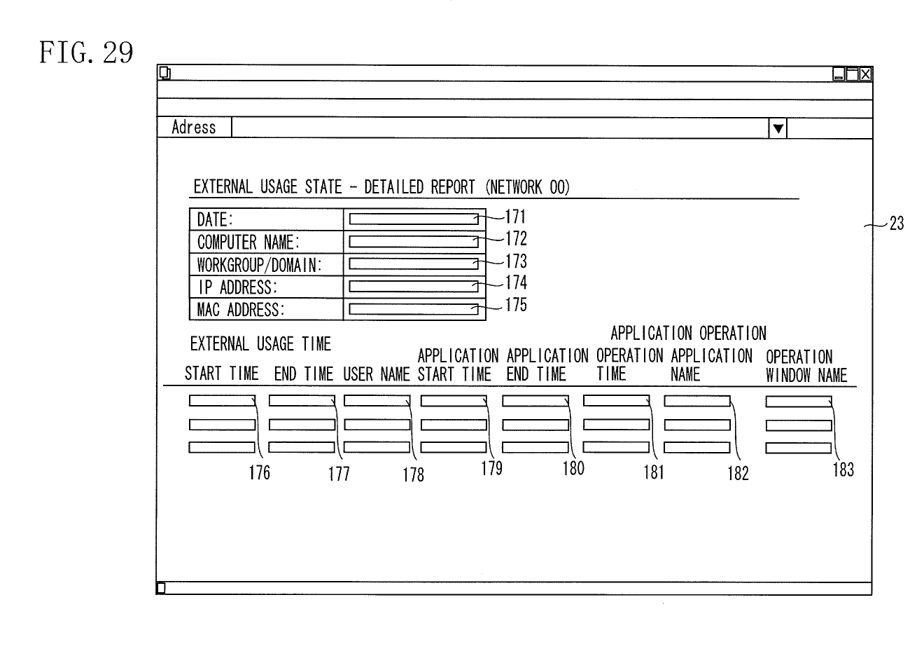

FIGS. 28 and 29 are diagrams exemplifying external usage history data and show a weekly external usage history of the user computers 11A to 11C, 12A to 12C, 13A to 13C, and 14A to 14C. In FIGS. 28 and 29, the display of concrete content of each item is omitted. The data management computer 18 displays external usage history data of the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting external usage history data). The data management computer 18 also displays external usage history data in the display 23 by dividing the data for each of the user computers 11A to 11C, 12A to 12C, 13A to 13C, and 14A to 14C and also outputs the data from a printer (second means for outputting external usage history data).

After making the data management computer 18 available by performing an authentication procedure, the system administrator selects (clicks) External usage history data from report items in the report display screen (not shown) displayed in the display 23 of the computer 18 and specifies the network 16A to 16D. After External usage history data being selected and the network 16A to 16D being specified, the data management computer 18 identifies network identification data corresponding to the specified network 16A to 16D and user computer identification data and extracts external usage history data corresponding to the network identification data and external usage history data corresponding to the user computer identification data from a database. Next, as shown in FIG. 28, the data management computer 18 displays external usage history data of the user computers 11A to 11C, 12A to 12C, 13A to 13C, and 14A to 14C in the specified network 16A to 16D in the display 23 (first means for outputting external usage history data). In FIG. 28, as the external usage history data, the specified period is displayed in a period display area 165, computer names (externally used computer names) in a computer name display area 166, MAC addresses in a MAC address display area 167, workgroups/domains in a workgroup/domain display area 168, user names (user names of externally used computers) in a user name display area 169, and external usage counts in an external usage count display area 170.

If a computer name displayed in an underlined portion of the screen in FIG. 28 is selected (clicked), as shown in FIG. 29, the data management computer 18 displays details of external usage history data of the selected user computer 11A to 11C, 12A to 12C, 13A to 13C, or 14A to 14C in the display 23 (second means for outputting external usage history data). In FIG. 29, as details of the external usage history data, a date is displayed in a date display area 171, a computer name in a computer name display area 172, a workgroup/domain in a workgroup/domain display area 173, an IP address in an IP address display area 174, and a MAC address in a MAC address display area 175. Further, external usage start times are displayed in an external usage start time display area 176, external usage end times in an external usage end time display area 177, user names in a user name display area 178, application usage start times in an application usage start time display area 179, application usage end times in an application usage end time display area 180, application operation times in an application operation time display area 181, application names (names of applications used for external usage) in an application name display area 182, and operation window names (operation window names of applications used for external usage) in an operation window name display area 183. The system administrator can output the external usage history data in FIGS. 28 and 29 from a printer.

In the system 10, the data management software 18 manages external usage history data of the user computers 11A to 11C, 12A to 12C, 13A to 13C, and 14A to 14C for each of the networks 16A to 16D or each of the user computers 11A to 11C, 12A to 12C, 13A to 13C, and 14A to 14C and therefore, the system administrator can reliably grasp external usage states of the user computers 11A to 11C, 12A to 120, 13A to 13C, and 14A to 14C in each of the networks 16A to 16D via the data management software 18 so that external usage states in the user computers 11A to 11C, 12A to 12C, 13A to 13C, and 14A to 14C can be monitored for each of the networks 16A to 16D or each of the user computers 11A to 11C, 12A to 12C, 13A to 13C, and 14A to 14C and also unrestricted external usage acts of the user computers 11A to 11C, 12A to 12C, 13A to 13C, and 14A to 14C can be controlled.

(Extra-Specified Time Usage History Data)

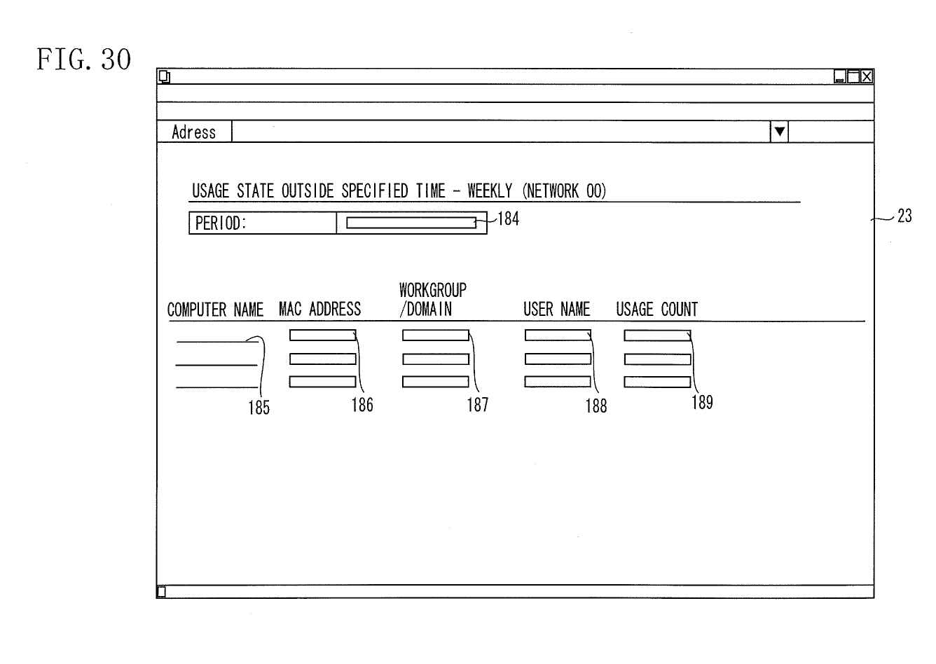

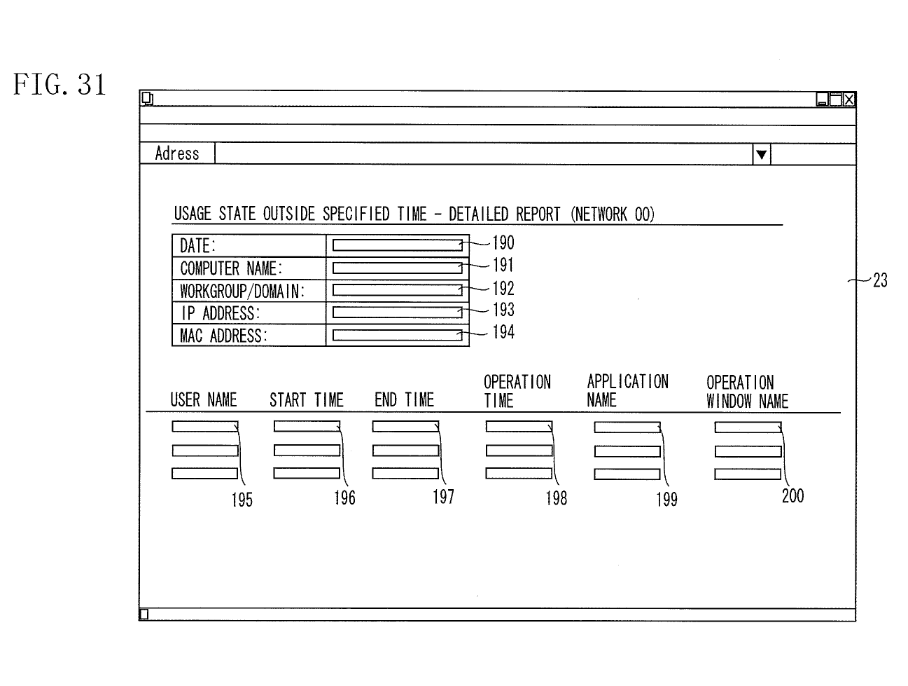

FIGS. 30 and 31 are diagrams exemplifying extra-specified time usage history data and show a weekly extra-specified time usage history of the user computers 11A to 11C, 12A to 12C, 13A to 13C, and 14A to 14C. In FIGS. 30 and 31, the display of concrete content of each item is omitted. The data management computer 18 displays extra-specified time usage history data of the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting extra-specified time usage history data). The data management computer 18 also displays extra-specified time usage history data in the display 23 by dividing the data for each of the user computers 11A to 11C, 12A to 12C, 13A to 13C, and 14A to 14C and also outputs the data from a printer (second means for outputting extra-specified time usage history data).

After making the data management computer 18 available by performing an authentication procedure, the system administrator selects (clicks) Extra-specified time usage history data from report items in the report display screen (not shown) displayed in the display 23 of the computer 18 and specifies the network 16A to 16D. After Extra-specified time usage history data being selected and the network 16A to 16D being specified, the data management computer 18 identifies network identification data corresponding to the specified network 16A to 16D and user computer identification data and extracts extra-specified time usage history data corresponding to the network identification data and extra-specified time usage history data corresponding to the user computer identification data from a database. Next, as shown in FIG. 30, the data management computer 18 displays extra-specified time usage history data of the user computers 11A to 11C, 12A to 12C, 13A to 13C, and 14A to 14C in the specified network 16A to 16D in the display 23 (first means for outputting extra-specified time usage history data). In FIG. 30, as the extra-specified time usage history data, the specified period is displayed in a period display area 184, computer names in a computer name display area 185, MAC addresses in a MAC address display area 186, workgroups/domains in a workgroup/domain display area 187, user names in a user name display area 188, and extra-specified time usage counts in an extra-specified time usage count display area 189.

If a computer name displayed in an underlined portion of the screen in FIG. 30 is selected (clicked), as shown in FIG. 31, the data management computer 18 displays details of extra-specified time usage history data of the selected user computer 11A to 11C, 12A to 12C, 13A to 13C, or 14A to 14C in the display 23 (second means for outputting extra-specified time usage history data). In FIG. 31, as details of the extra-specified time usage history data, a date is displayed in a date display area 190, a computer name (computer name used in an extra-specified time) in a computer name display area 191, a workgroup/domain in a workgroup/domain display area 192, an IP address in an IP address display area 193, and a MAC address in a MAC address display area 194. Further, user names (user names of computers used in an extra-specified time) are displayed in a user name display area 195, extra-time usage start times in an extra-time usage start time display area 196, extra-time usage end times in an extra-time usage end time display area 197, operation times (extra-time usage times) in an operation time display area 198, application names (names of applications used for extra-time usage) in an application name display area 199, and operation window names (operation window names of applications used for extra-time usage) in an operation window name display area 200. The system administrator can output the extra-specified time usage history data in FIGS. 30 and 31 from a printer.

In this system, the data management software 18 manages extra-specified time usage history data of the user computers 11A to 11C, 12A to 12C, 13A to 13C, and 14A to 14C for each of the networks 16A to 16D or each of the user computers 11A to 11C, 12A to 12C, 13A to 13C, and 14A to 14C and therefore, the system administrator can reliably grasp extra-specified time usage states of the user computers 11A to 11C, 12A to 12C, 13A to 13C, and 14A to 14C in each of the networks 16A to 16D via the data management software 18 so that extra-specified time usage states in the user computers 11A to 11C, 12A to 12C, 13A to 13C, and 14A to 14C can be monitored for each of the networks 16A to 16D or each of the user computers 11A to 11C, 12A to 12C, 13A to 13C, and 14A to 14C and also unrestricted extra-specified time usage acts of the user computers 11A to 11C, 12A to 12C, 13A to 13C, and 14A to 14C can be controlled.

(Taking-Out Act Data)

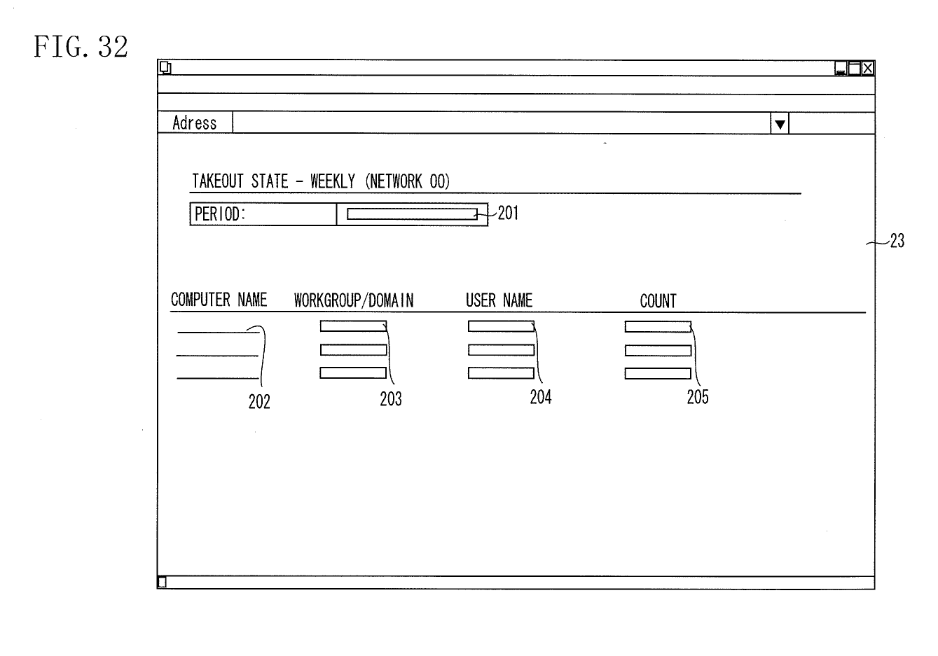

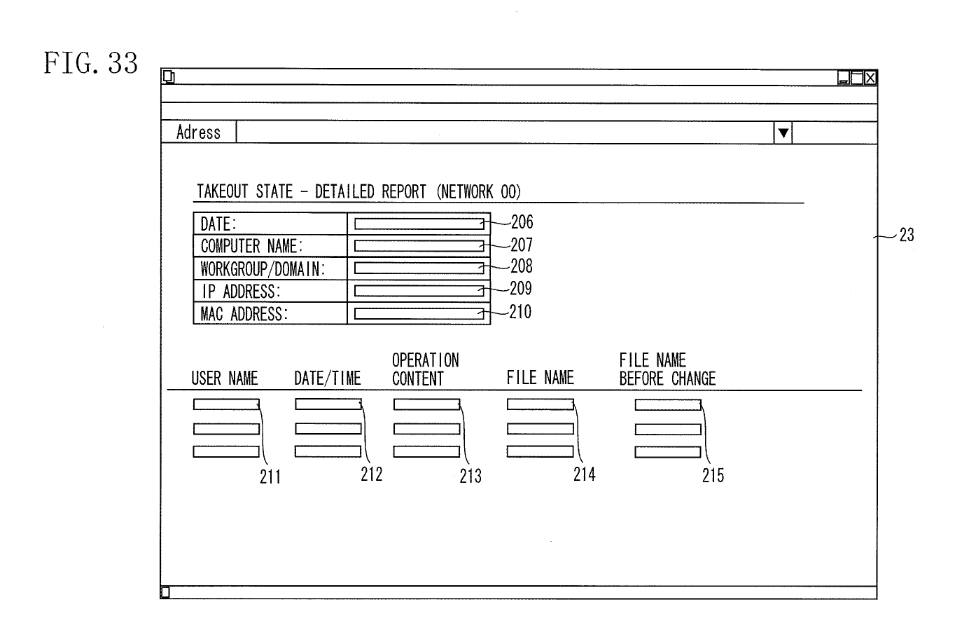

FIGS. 32 and 33 are diagrams exemplifying taking-out act data and show weekly taking-out acts of the user computers 11A to 11C, 12A to 12C, 13A to 13C, and 14A to 14C. In FIGS. 32 and 33, the display of concrete content of each item is omitted. The data management computer 18 displays taking-out act data of the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting taking-out act data). The data management computer 18 also displays taking-out act data in the display 23 by dividing the data for each of the user computers 11A to 11C, 12A to 12C, 13A to 13C, and 14A to 14C and also outputs the data from a printer (second means for outputting taking-out act data).

After making the data management computer 18 available by performing an authentication procedure, the system administrator selects (clicks) Taking-out act data from report items in the report display screen (not shown) displayed in the display 23 of the computer 18 and specifies the network 16A to 16D. After Taking-out act data being selected and the network 16A to 16D being specified, the data management computer 18 identifies network identification data corresponding to the specified network 16A to 16D and user computer identification data and extracts taking-out act data corresponding to the network identification data and taking-out act data corresponding to the user computer identification data from a database. Next, as shown in FIG. 32, the data management computer 18 displays taking-out act data of the user computers 11A to 11C, 12A to 12C, 13A to 13C, and 14A to 14C in the specified network 16A to 16D in the display 23 (first means for outputting taking-out act data). In FIG. 32, as the taking-out act data, the specified period is displayed in a period display area 201, computer names (names of computers that were taken out) in a computer name display area 202, workgroups/domains in a workgroup/domain display area 203, user names (user names of computers that were taken out) in a user name display area 204, and taking-out act counts in a taking-out act count display area 205.

If a computer name displayed in an underlined portion of the screen in FIG. 32 is selected (clicked), as shown in FIG. 33, the data management computer 18 displays details of taking-out act data of the selected user computer 11A to 11C, 12A to 12C, 13A to 13C, or 14A to 14C in the display 23 (second means for outputting taking-out act data). In FIG. 33, as details of the taking-out act data, a date is displayed in a date display area 206, a computer name in a computer name display area 207, a workgroup/domain in a workgroup/domain display area 208, an IP address in an IP address display area 209, and a MAC address in a MAC address display area 210. Further, user names are displayed in a user name display area 211, taking-out act dates/times in a taking-out act date/time display area 212, taking-out operation content (such as copying, cutting, and file search) in a taking-out operation content display area 213, file names in a file name display area 214, and file names before change (data name attempted to take out) in a file name before change display area 215. The system administrator can output the taking-out act data in FIGS. 32 and 33 from a printer.

In the system 10, the data management software 18 manages taking-out act data of the user computers 11A to 11C, 12A to 12C, 13A to 13C, and 14A to 14C for each of the networks 16A to 16D or each of the user computers 11A to 11C, 12A to 12C, 13A to 13C, and 14A to 14C and therefore, the system administrator can reliably grasp taking-out acts of the user computers 11A to 11C, 12A to 12C, 13A to 13C, and 14A to 14C in each of the networks 16A to 16D via the data management software 18 so that taking-out acts in the user computers 11A to 11C, 12A to 12C, 13A to 13C, and 14A to 14C can be monitored for each of the networks 16A to 16D or each of the user computers 11A to 11C, 12A to 12C, 13A to 13C, and 14A to 14C and also unrestricted taking-out acts of the user computers 11A to 11C, 12A to 12C, 13A to 13C, and 14A to 14C can be controlled.

(Printing Act Data)

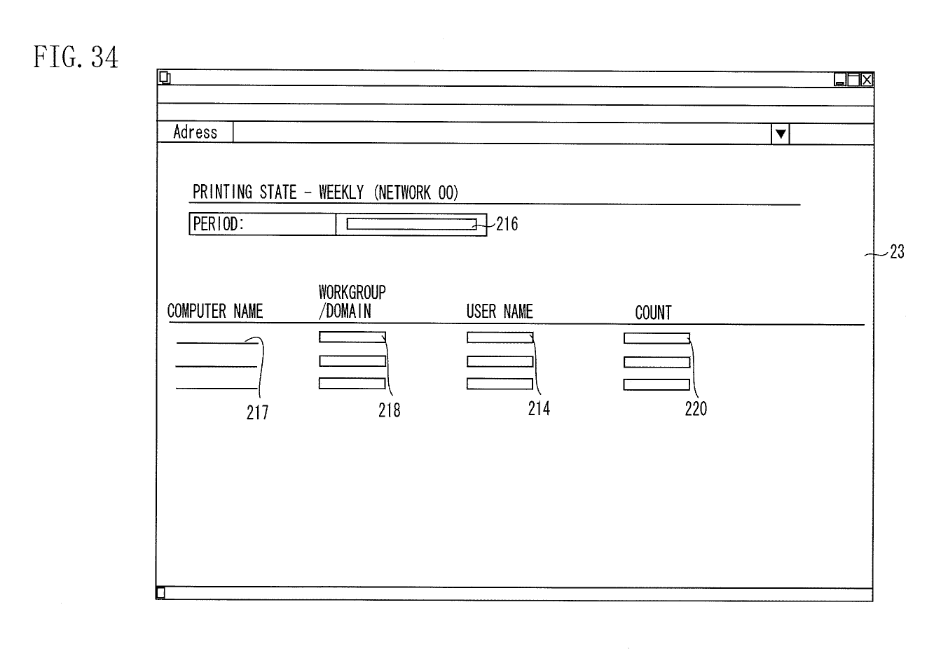

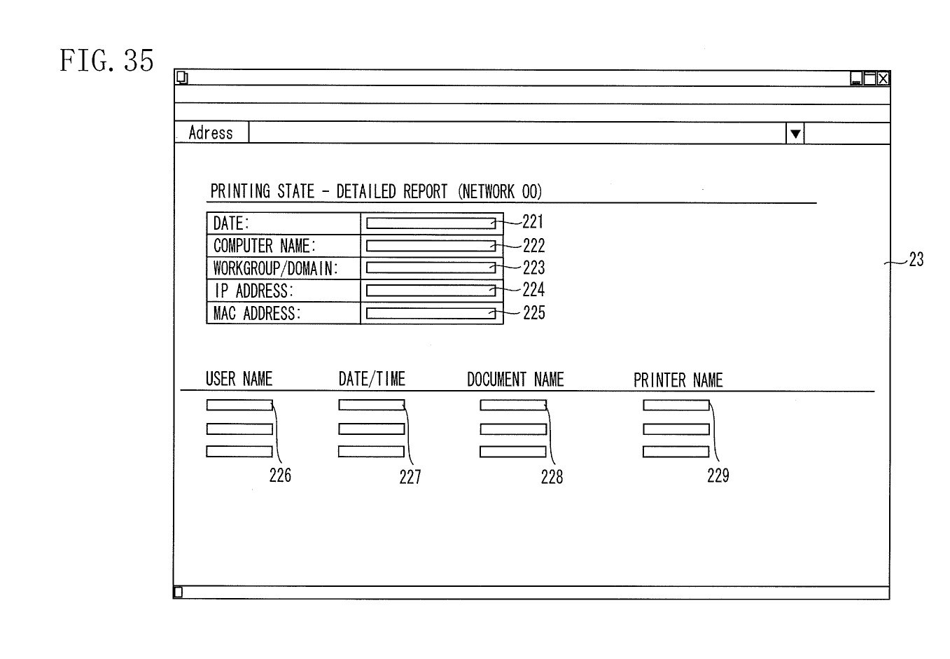

FIGS. 34 and 35 are diagrams exemplifying printing act data and show weekly printing acts by the user computers 11A to 11C, 12A to 12C, 13A to 13C, and 14A to 14C. In FIGS. 34 and 35, the display of concrete content of each item is omitted. The data management computer 18 displays printing act data of print prohibited data by the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting printing act data). The data management computer 18 also displays printing act data of print prohibited data in the display 23 by dividing the data for each of the user computers 11A to 11C, 12A to 12C, 13A to 13C, and 14A to 14C and also outputs the data from a printer (second means for outputting printing act data).

After making the data management computer 18 available by performing an authentication procedure, the system administrator selects (clicks) Printing act data from report items in the report display screen (not shown) displayed in the display 23 of the computer 18 and specifies the network 16A to 16D. After Printing act data being selected and the network 16A to 16D being specified, the data management computer 18 identifies network identification data corresponding to the specified network 16A to 16D and user computer identification data and extracts printing act data corresponding to the network identification data and printing act data corresponding to the user computer identification data from a database. Next, as shown in FIG. 34, the data management computer 18 displays printing act data of the user computers 11A to 11C, 12A to 12C, 13A to 13C, and 14A to 14C in the specified network 16A to 16D in the display 23 (first means for outputting printing act data). In FIG. 34, as the printing act data, the specified period is displayed in a period display area 216, computer names (names of computers used for printing act) in a computer name display area 217, workgroups/domains in a workgroup/domain display area 218, user names (user names of computers used for printing act) in a user name display area 219, and printing act counts in a printing act count display area 220.

If a computer name displayed in an underlined portion of the screen in FIG. 34 is selected (clicked), as shown in FIG. 35, the data management computer 18 displays details of printing act data of the selected user computer 11A to 11C, 12A to 12C, 13A to 13C, or 14A to 14C in the display (second means for outputting printing act data). In FIG. 35, as details of the printing act data, a date is displayed in a date display area 221, a computer name in a computer name display area 222, a workgroup/domain in a workgroup/domain display area 223, an IP address in an IP address display area 224, and a MAC address in a MAC address display area 225. Further, user names are displayed in a user name display area 226, printing act dates/times in a printing act date/time display area 227, document names (names of documents attempted to print) in a document name display area 228, and printer names (names of printers used for printing act) in an printer name display area 229. The system administrator can output the printing act data in FIGS. 34 and 35 from a printer.

In the system 10, the data management software 18 manages printing act data of the user computers 11A to 11C, 12A to 12C, 13A to 13C, and 14A to 14C for each of the networks 16A to 16D or each of the user computers 11A to 11C, 12A to 12C, 13A to 13C, and 14A to 14C and therefore, the system administrator can reliably grasp printing acts of the user computers 11A to 11C, 12A to 12C, 13A to 13C, and 14A to 14C in each of the networks 16A to 16D via the data management software 18 so that printing acts in the user computers 11A to 11C, 12A to 12C, 13A to 13C, and 14A to 14C can be monitored for each of the networks 16A to 16D or each of the user computers 11A to 11C, 12A to 12C, 13A to 13C, and 14A to 14C and also unrestricted printing acts of print prohibited data by the user computers 11A to 11C, 12A to 12C, 13A to 13C, and 14A to 14C can be controlled.

(E-Mail Transmission Data)

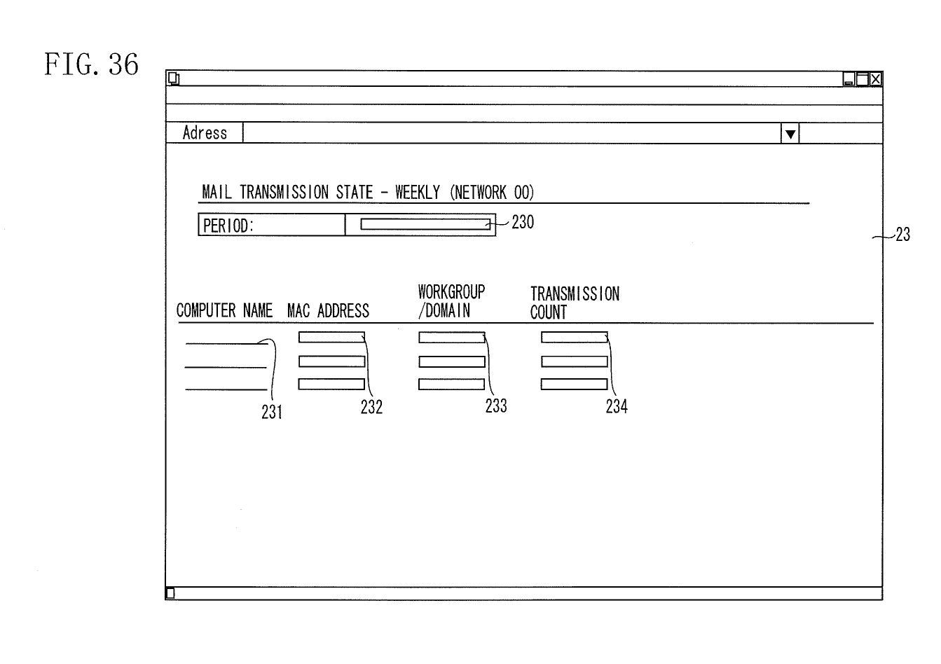

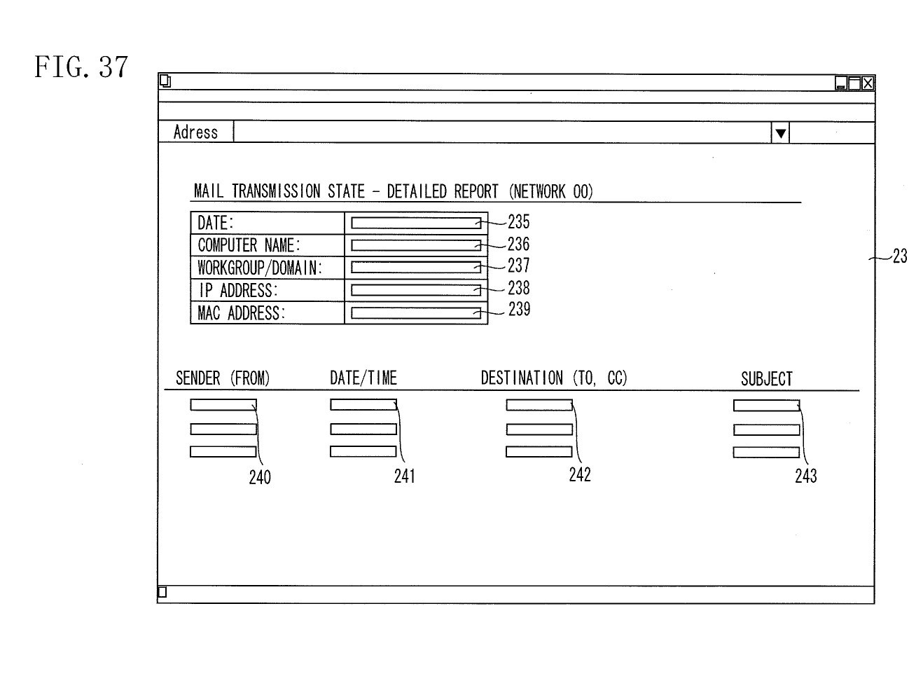

FIGS. 36 and 37 are diagrams exemplifying e-mail transmission data and show weekly e-mail transmission by the user computers 11A to 11C, 12A to 12C, 13A to 13C, and 14A to 14C. In FIGS. 36 and 37, the display of concrete content of each item is omitted. The data management computer 18 displays e-mail transmission data of the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting e-mail transmission data). The data management computer 18 also displays e-mail transmission data in the display 23 by dividing the data for each of the user computers 11A to 11C, 12A to 12C, 13A to 13C, and 14A to 14C and also outputs the data from a printer (second means for outputting e-mail transmission data).

After making the data management computer 18 available by performing an authentication procedure, the system administrator selects (clicks) E-mail transmission data from report items in the report display screen (not shown) displayed in the display 23 of the computer 18 and specifies the network 16A to 16D. After E-mail transmission data being selected and the network 16A to 16D being specified, the data management computer 18 identifies network identification data corresponding to the specified network 16A to 16D and user computer identification data and extracts e-mail transmission data corresponding to the network identification data and e-mail transmission data corresponding to the user computer identification data from a database. Next, as shown in FIG. 36, the data management computer 18 displays e-mail transmission data of the user computers 11A to 11C, 12A to 12C, 13A to 13C, and 14A to 14C in the specified network 16A to 16D in the display 23 (first means for outputting e-mail transmission data). In FIG. 36, as the e-mail transmission data, the specified period is displayed in a period display area 230, computer names in a computer name display area 231, MAC addresses in a MAC address display area 232, workgroups/domains in a workgroup/domain display area 233, and e-mail transmission counts in an e-mail transmission count display area 234.

If a computer name displayed in an underlined portion of the screen in FIG. 36 is selected (clicked), as shown in FIG. 37, the data management computer 18 displays details of e-mail transmission data of the selected user computer 11A to 11C, 12A to 12C, 13A to 13C, or 14A to 14C in the display 23 (second means for outputting e-mail transmission data). In FIG. 37, as details of the e-mail transmission data, a date (e-mail transmission date/time) is displayed in a date display area 235, a computer name (name of a computer that transmitted an e-mail) in a computer name display area 236, a workgroup/domain in a workgroup/domain display area 237, an IP address in an IP address display area 238, and a MAC address in a MAC address display area 239. Further, senders (From) (user names of computers that transmitted an e-mail) are displayed in a sender display area 240, e-mail transmission dates/times in an e-mail transmission date/time display area 241, destinations (e-mail transmission destination addresses) in a destination display area 242, and subjects (subjects of transmitted e-mails) in a subject display area 243. The system administrator can output the e-mail transmission data in FIGS. 36 and 37 from a printer.

In the system 10, the data management software 18 manages e-mail transmission data of the user computers 11A to 11C, 12A to 12C, 13A to 13C, and 14A to 14C for each of the networks 16A to 16D or each of the user computers 11A to 11C, 12A to 12C, 13A to 13C, and 14A to 14C and therefore, the system administrator can reliably grasp e-mail transmission of the user computers 11A to 11C, 12A to 12C, 13A to 13C, and 14A to 14C in each of the networks 16A to 16D via the data management software 18 so that e-mail transmission acts of the user computers 11A to 11C, 12A to 12C, 13A to 13C, and 14A to 14C can be monitored for each of the networks 16A to 16D or each of the user computers 11A to 11C, 12A to 12C, 13A to 13C, and 14A to 14C and also unrestricted e-mail transmission acts by the user computers 11A to 11C, 12A to 12C, 13A to 13C, and 14A to 14C can be controlled.

(Web Site Access Information)

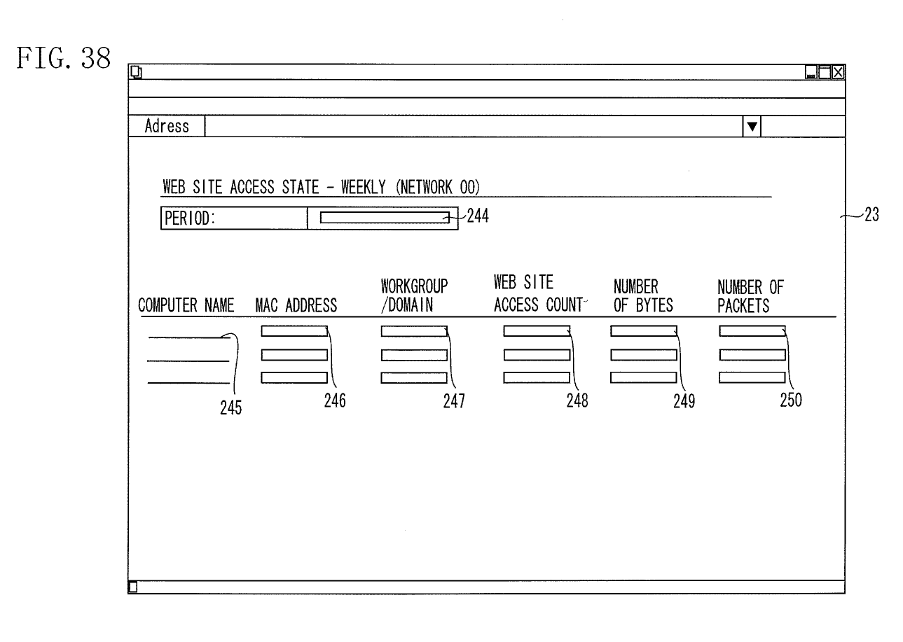

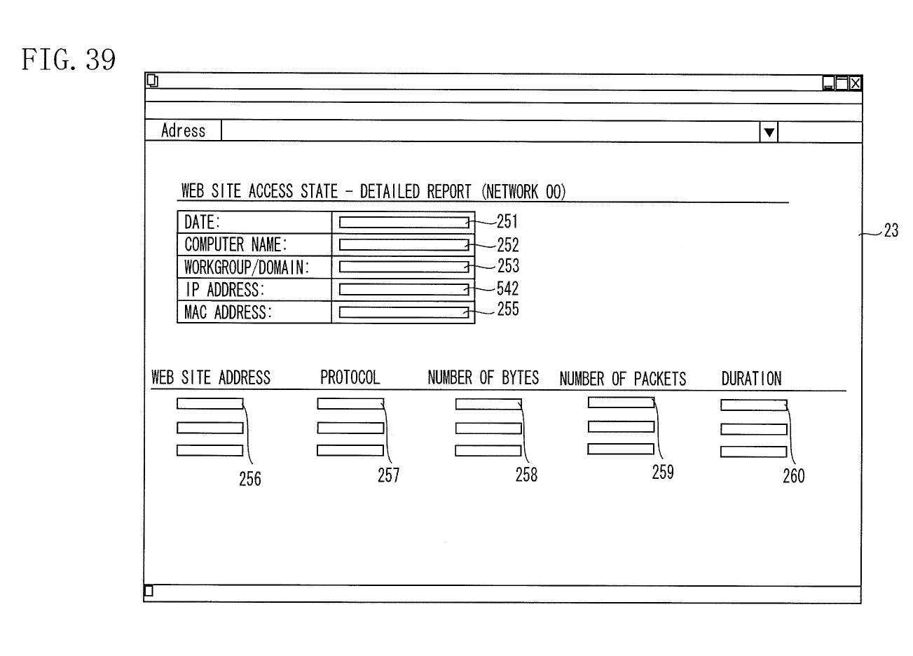

FIGS. 38 and 39 are diagrams exemplifying Web site access data and show weekly Web site access by the user computers 11A to 11C, 12A to 12C, 13A to 13C, and 14A to 14C. In FIGS. 38 and 39, the display of concrete content of each item is omitted. The data management computer 18 displays Web site access data of the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting Web site access data). The data management computer 18 also displays Web site access data in the display 23 by dividing the data for each of the user computers 11A to 11C, 12A to 12C, 13A to 13C, and 14A to 14C and also outputs the data from a printer (second means for outputting Web site access data).

After making the data management computer 18 available by performing an authentication procedure, the system administrator selects (clicks) Web site access data from report items in the report display screen (not shown) displayed in the display 23 of the computer 18 and specifies the network 16A to 16D. After Web site access data being selected and the network 16A to 16D being specified, the data management computer 18 identifies network identification data corresponding to the specified network 16A to 16D and user computer identification data and extracts Web site access data corresponding to the network identification data and Web site access data corresponding to the user computer identification data from a database. Next, as shown in FIG. 38, the data management computer 18 displays Web site access data of the user computers 11A to 11C, 12A to 12C, 13A to 13C, and 14A to 14C in the specified network 16A to 16D in the display 23 (first means for outputting Web site access data). In FIG. 38, as the Web site access data, the specified period is displayed in a period display area 244, computer names (names of computers that accessed a Web site) in a computer name display area 245, MAC addresses in a MAC address display area 246, workgroups/domains in a workgroup/domain display area 247, access counts in a Web site access count display area 248, numbers of bytes in a byte number display area 249, and numbers of packets in a packet number display area 250.

If a computer name displayed in an underlined portion of the screen in FIG. 38 is selected (clicked), as shown in FIG. 39, the data management computer 18 displays details of Web site access data of the selected user computer 11A to 11C, 12A to 12C, 13A to 13C, or 14A to 14C in the display 23 (second means for outputting Web site access data). In FIG. 39, as details of the Web site access data, a date (Web site access date/time) is displayed in a date display area 251, a computer name in a computer name display area 252, a workgroup/domain in a workgroup/domain display area 253, an IP address in an IP address display area 254, and a MAC address in a MAC address display area 255. Further, Web site addresses are displayed in a Web site address display area 256, protocols in a protocol display area 257, numbers of bytes in a byte number display area 258, numbers of packets in a packet number display area 259, and connection times in a connection time display area 260. The system administrator can output the Web site access data in FIGS. 38 and 39 from a printer.

In the system 10, the data management software 18 manages Web site access data of the user computers 11A to 11C, 12A to 12C, 13A to 13C, and 14A to 14C for each of the networks 16A to 16D or each of the user computers 11A to 11C, 12A to 12C, 13A to 13C, and 14A to 14C and therefore, the system administrator can reliably grasp Web site access of the user computers 11A to 11C, 12A to 12C, 13A to 13C, and 14A to 14C in each of the networks 16A to 16D via the data management software 18 so that Web site access acts of the user computers 11A to 11C, 12A to 12C, 13A to 13C, and 14A to 14C can be monitored for each of the networks 16A to 16D or each of the user computers 11A to 11C, 12A to 12C, 13A to 13C, and 14A to 14C and also unrestricted Web site access acts by the user computers 11A to 11C, 12A to 12C, 13A to 13C, and 14A to 14C can be controlled.

(External Network Access Data)

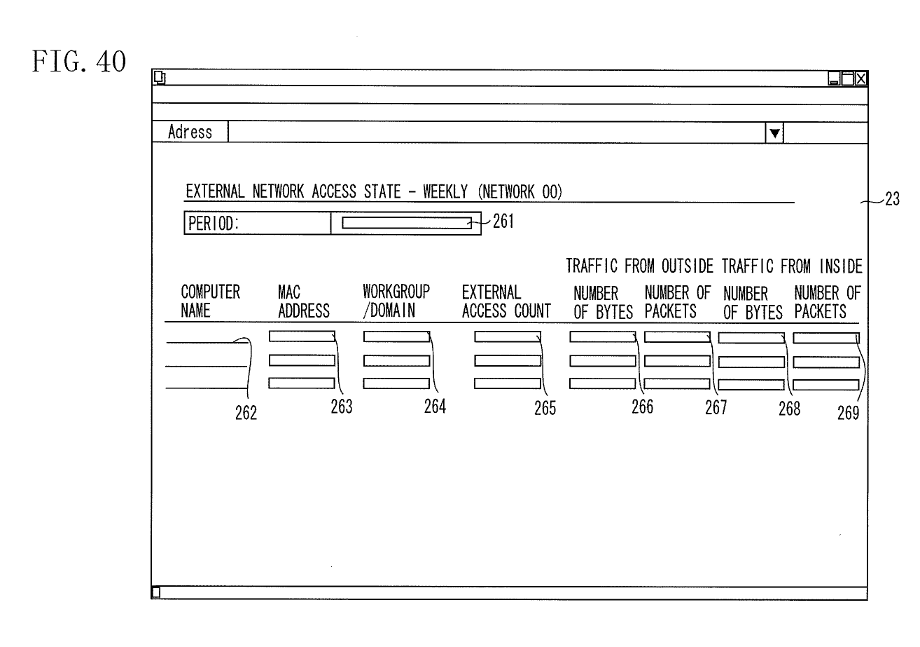

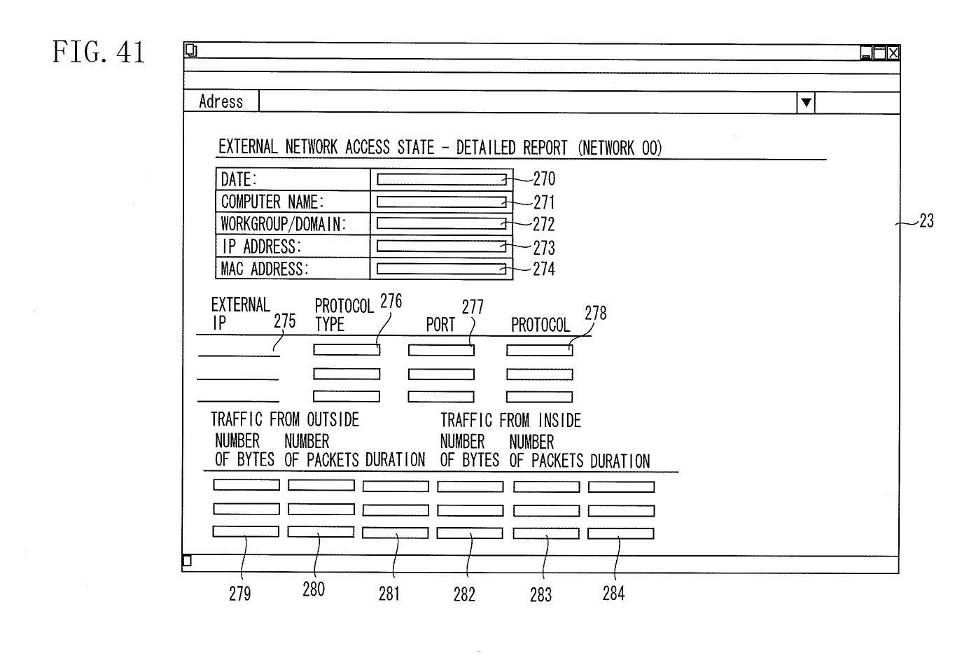

FIGS. 40 and 41 are diagrams exemplifying external network access data and show weekly external network access by the user computers 11A to 11C, 12A to 12C, 13A to 13C, and 14A to 14C. In FIGS. 40 and 41, the display of concrete content of each item is omitted. The data management computer 18 displays external network access data of the user computers 11A to 11C, 12A to 12C, 13A to 13C, and 14A to 14C acquired from the data relay servers 17A/17B in the display 23 by dividing the data for each of the networks 16A to 16D and also outputs the data from a printer (first means for outputting external network access data). The data management computer 18 also displays external network access data in the display 23 by dividing the data for each of the user computers 11A to 11C, 12A to 12C, 13A to 13C, and 14A to 14C and also outputs the data from a printer (second means for outputting external network access data).

After making the data management computer 18 available by performing an authentication procedure, the system administrator selects (clicks) External network access data from report items in the report display screen (not shown) displayed in the display 23 of the computer 18 and specifies the network 16A to 16D. After External network access data being selected and the network 16A to 16D being specified, the data management computer 18 identifies network identification data corresponding to the specified network 16A to 16D and user computer identification data and extracts external network access data corresponding to the network identification data and external network access data corresponding to the user computer identification data from a database. Next, as shown in FIG. 40, the data management computer 18 displays external network access data of the user computers 11A to 11C, 12A to 12C, 13A to 13C, and 14A to 14C in the specified network 16A to 16D in the display 23 (first means for outputting external network access data). In FIG. 40, as the external network access data, the specified period is displayed in a period display area 261, computer names (names of computers that accessed an external network) in a computer name display area 262, MAC addresses in a MAC address display area 263, workgroups/domains in a workgroup/domain display area 264, external network access counts in an external network access count display area 265, numbers of bytes of traffic from outside in a byte number display area 266, numbers of packets of traffic from outside in a packet number display area 267, numbers of bytes of traffic from inside in a byte number display area 268, numbers of packets of traffic from inside in a packet number display area 269.

If a computer name displayed in an underlined portion of the screen in FIG. 40 is selected (clicked), as shown in FIG. 41, the data management computer 18 displays details of external network access data of the selected user computer 11A to 11C, 12A to 12C, 13A to 13C, or 14A to 14C in the display 23 (second means for outputting external network access data). In FIG. 41, as details of the external network access data, a date (external network access date/time) is displayed in a date display area 270, a computer name in a computer name display area 271, a workgroup/domain in a workgroup/domain display area 272, an IP address in an IP address display area 273, and a MAC address in a MAC address display area 274. Further, external IPs (external network addresses) are displayed in an external IP display area 275, protocols in a protocol display area 276, ports in a port display area 277, protocols in a protocol display area 278, numbers of bytes of traffic from outside in a byte number display area 279, numbers of packets of traffic from outside in a packet number display area 280, connection times in a connection time display area 281, numbers of bytes of traffic from inside in a byte number display area 282, numbers of packets of traffic from inside in a packet number display area 283, and connection times in a connection time display area 284. The system administrator can output the external network access data in FIGS. 40 and 41 from a printer.

In the system 10, the data management software 18 manages external network 16A to 16D access of the user computers 11A to 11C, 12A to 12C, 13A to 13C, and 14A to 14C for each of the networks 16A to 16D or each of the user computers 11A to 11C, 12A to 12C, 13A to 13C, and 14A to 14C and therefore, the system administrator can reliably grasp external network 16A to 16D access of the user computers 11A to 11C, 12A to 12C, 13A to 13C, and 14A to 14C in each of the networks 16A to 16D via the data management software 18 so that external network 16A to 16D access acts of the user computers 11A to 11C, 12A to 12C, 13A to 13C, and 14A to 14C can be monitored for each of the networks 16A to 16D or each of the user computers 11A to 11C, 12A to 12C, 13A to 13C, and 14A to 14C and also unrestricted external network 16A to 16D access acts by the user computers 11A to 11C, 12A to 12C, 13A to 13C, and 14A to 14C can be controlled.

1. A device data management system having a plurality of networks formed from a plurality of network constituting devices and device monitoring apparatuses to monitor these network constituting devices in chronological order, data relay apparatuses that receive various kinds of data on each network constituting device from the device monitoring apparatuses, and a data management apparatus that acquires the various kinds of data from the data relay apparatuses, wherein
the network constituting device has an operation data management application that causes the network constituting device to send permitted operation data to the device monitoring apparatus when the network constituting device performs an operation permitted thereto and causes the network constituting device to send refused operation data to the device monitoring apparatus when the network constituting device attempts to perform a refused operation other than permitted operations installed thereon,
the device monitoring apparatus includes an unregistered device detection means for detecting a connection of an unregistered device to the network when the unregistered device on which the operation data management application is not installed is connected to the network and an unregistered device connection data transmission means for sending unregistered device connection data acquired of the unregistered device to the data relay apparatus, and
the data management apparatus includes an unregistered device connection data storage means for storing the unregistered device connection data acquired from the data relay apparatus by dividing the data for each network and an unregistered device connection data output means for outputting the unregistered device connection data by dividing the data for each network.

2. The device data management system according to claim 1, wherein the device monitoring apparatus includes a permitted operation data collection means for collecting the permitted operation data sent from the network constituting devices in the chronological order and a permitted operation data transmission means for sending the collected permitted operation data to the data relay apparatus, and
the data management apparatus includes a first permitted operation data storage means for storing the permitted operation data acquired from the data relay apparatus by dividing the data for each network and a first permitted operation data output means for outputting the permitted operation data by dividing the data for each network.

3. The device data management system according to claim 2, wherein the data management apparatus includes a second permitted operation data storage means for storing the permitted operation data acquired from the data relay apparatus by dividing the data for each network constituting device and a second permitted operation data output means for outputting the permitted operation data by dividing the data for each network constituting device.

4. The device data management system according to claim 1, wherein the device monitoring server includes a refused operation data collection means for collecting refused operation data sent from the network constituting devices in the chronological order and a refused operation data transmission means for sending the collected refused operation data to the data relay apparatus, and
the data management apparatus includes a first refused operation data storage means for storing the refused operation data acquired from the data relay apparatus by dividing the data for each network and a first refused operation data output means for outputting the refused operation data by dividing the data for each network.

5. The device data management system according to claim 4, wherein the data management apparatus includes a second refused operation data storage means for storing the refused operation data acquired from the data relay apparatus by dividing the data for each network constituting device and a second refused operation data output means for outputting the refused operation data by dividing the data for each network constituting device.

6. The device data management system according to claim 1, wherein the data management apparatus includes a specific device exclusion means for excluding a specific device from the unregistered devices and when the specific device excluded from the unregistered devices is connected to the network, the device monitoring apparatus does not detect the specific device as an unregistered device.

7. The device data management system according to claim 1, wherein the data management apparatus includes a first transmission interval change means for changing a transmission interval of the unregistered device connection data sent from the device monitoring apparatus to the data relay apparatus for each network.

8. The device data management system according to claim 4, wherein the data management apparatus includes a second transmission interval change means for changing the transmission interval of the permitted operation data and the refused operation data sent from the device monitoring apparatus to the data relay apparatus for each network.

9. The device data management system according to claim 4, wherein the data management apparatus includes a data transmission destination change means for changing a transmission destination of the unregistered device connection data, the permitted operation data, and the refused operation data sent from the device monitoring apparatus from one data relay apparatus to the other.

10. The device data management system according to claim 1, wherein the data management apparatus includes a storage capacity monitoring means for monitoring storage capacities of the data relay apparatuses in the chronological order and a storage capacity exceeded data output means for outputting storage capacity exceeded data notifying that the storage capacity of the data relay apparatus is exceeded when a permissible range of the storage capacity of the data relay apparatus is exceeded.

11. The device data management system according to claim 1, comprising a firewall set up between the network and the data management apparatus, wherein the data management apparatus includes a log data storage means for storing log data of the firewall sent from the firewall by dividing the data for each network and a log data output means for outputting the log data by dividing the data for each network.

12. The device data management system according to claim 1, wherein an operation permitted to the network constituting apparatus is permitted application usage in which the network constituting apparatus uses a permitted application whose use in the network constituting apparatus is permitted and the permitted operation data is usage history data of the permitted application in the network constituting apparatus.

13. The device data management system according to claim 1, wherein an operation permitted to the network constituting apparatus is external usage in which the network constituting apparatus is used in an external environment outside the network formed by the network constituting apparatuses and the permitted operation data is external usage history data when the network constituting apparatus is used in the external environment.

14. The device data management system according to claim 1, wherein an operation permitted to the network constituting apparatus is extra-specified time usage in which the network constituting apparatus is used outside specified times and the permitted operation data is extra-specified time usage history data when the network constituting apparatus is used outside the specified times.

15. The device data management system according to claim 1, wherein an operation permitted to the network constituting apparatus is e-mail transmission in which an e-mail is sent via the network constituting apparatus and the permitted operation data is e-mail transmission history data when an e-mail is sent from the network constituting apparatus.

16. The device data management system according to claim 1, wherein an operation permitted to the network constituting apparatus is Web site access in which a predetermined Web site is accessed via the network constituting apparatus and the permitted operation data is Web site access history data when the network constituting apparatus accesses the predetermined Web site.

17. The device data management system according to claim 1, wherein an operation permitted to the network constituting apparatus is external network access in which a predetermined external network is accessed via the network constituting apparatus and the permitted operation data is external network access history data when the network constituting apparatus accesses the predetermined external network.

18. The device data management system according to claim 1, wherein operations permitted to the network constituting apparatus are application installation in which the permitted application is installed on the network constituting apparatus and application uninstallation in which the permitted application is uninstalled from the network constituting apparatus and the permitted operation data is application installation data when the permitted application is installed on the network constituting apparatus and application uninstallation data when the permitted application is uninstalled from the network constituting apparatus.

19. The device data management system according to claim 1, wherein a refused operation to the network constituting apparatus is a data taking-out operation in which taking-out prohibited data is taken out from the network constituting apparatus and the refused operation data is taking-out act history data when an attempt is made to take out the taking-out prohibited data from the network constituting apparatus.

20. The device data management system according to claim 1, wherein a refused operation to the network constituting apparatus is a data printing operation in which print prohibited data is printed from the network constituting apparatus and the refused operation data is printing act history data when an attempt is made to print the print prohibited data from the network constituting apparatus.

21. The device data management system according to claim 1, wherein a refused operation to the network constituting apparatus is a refused application access operation in which a refused application whose use is prohibited is accessed and the refused operation data is refused application access history data when the network constituting apparatus accesses the refused application.

22. The device data management system according to claim 18, wherein the data management apparatus includes a permitted application alteration means for adding, changing, or deleting the permitted application and a refused application alteration means for adding, changing, or deleting the refused application.
